(19) United States
(12) Patent Application Publication
(10) Pub. No.: US 2024/0170993 A1
(43) Pub. Date: May 23, 2024

(54) METHOD FOR CHARGING SECONDARY BATTERY

(71) Applicant: SEMICONDUCTOR ENERGY LABORATORY CO., LTD., Atsugi-shi, Kanagawa-ken (JP)

(72) Inventors: Kazuki TANEMURA, Isehara, Kanagawa (JP); Mayumi MIKAMI, Atsugi, Kanagawa (JP); Takeshi OSADA, Isehara, Kanagawa (JP); Yohei MOMMA, Isehara, Kanagawa (JP); Tetsuji ISHITANI, Atsugi, Kanagawa (JP); Haruki KATAGIRI, Atsugi, Kanagawa (JP)

(21) Appl. No.: 18/548,353

(22) PCT Filed: Feb. 24, 2022
(86) PCT No.: PCT/IB2022/051616

§ 371 Date: Aug. 30, 2023

(30) Foreign Application Priority Data
Mar. 5, 2021 (JP) 2021-035447
Apr. 29, 2021 (JP) 2021-076909
May 7, 2021 (JP) 2021-079185
Jan. 12, 2022 (JP) 2022-003155

(51) Int. Cl. H02J 7/04; H01M 4/525; H01M 10/44; H02J 7/00

(52) U.S. Cl. CPC H02J 7/04; H01M 4/525; H01M 10/443; H02J 7/0047; H02J 7/007182

(57) ABSTRACT

A power storage system with a high energy density is provided. A power storage system with a high degree of safety is provided. A secondary battery with a high energy density is provided. A secondary battery with a high degree of safety is provided. A charging unit has a function of controlling start and stop of charge of a secondary battery and a function of controlling a charge current of the secondary battery. The secondary battery includes a positive electrode, the positive electrode includes a positive electrode active material particle, the positive electrode active material particle is lithium cobalt oxide to which magnesium is added. The charging unit has a function of controlling charge of the secondary battery by a first step of starting constant current charge of the secondary battery at a time t1; and a second step of stopping the charge at a time t2. A crystal structure of the lithium cobalt oxide at the time t2, which is determined by powder X-ray diffraction, is a crystal structure represented by a space group R-3m.

### TECHNICAL FIELD

One embodiment of the present invention relates to a power storage system, an operation method of the power storage system, a secondary battery, and an operation method of the secondary battery. One embodiment of the present invention relates to a charging method of a secondary battery. One embodiment of the present invention relates to a semiconductor device and an operation method of the semiconductor device. One embodiment of the present invention relates to a battery control circuit, a battery protection circuit, a power storage device, an electric device, and operation methods thereof.

Note that one embodiment of the present invention is not limited to the above technical field. The technical field of the invention disclosed in this specification and the like relates to an object or a method. Alternatively, one embodiment of the present invention relates to a process, a machine, manufacture, or a composition of matter. Thus, more specifically, examples of the technical field of one embodiment of the present invention disclosed in this specification include a display device, a light-emitting device, a power storage device, an imaging device, a memory device, a driving method thereof, and a manufacturing method thereof.

### BACKGROUND ART

Power storage devices (also referred to as batteries or secondary batteries) have been utilized in a wide range of areas from small electronic devices to automobiles. As the application range of batteries expands, there are more and more applications utilizing a multi-cell battery stack where a plurality of battery cells are connected in series.

The power storage device is provided with a circuit for detecting an abnormality in charging and discharging, such as overdischarge, overcharge, overcurrent, or a short circuit. In such a circuit, data of voltage, current, and the like is obtained, and stop of charge and discharge, cell balance, and the like are controlled on the basis of the obtained data. Thus, the battery can be protected and controlled.

Patent Document 1 discloses a protection IC that functions as a battery protection circuit. Specifically, Patent Document 1 discloses a protection IC that detects abnormality in charging and discharging by comparing, using a plurality of comparators provided inside, a reference voltage and a voltage of a terminal to which a battery is connected.

Patent Document 2 discloses a battery state detector that detects a micro-short circuit in a secondary battery and a battery pack incorporating the detector.

Patent Document 3 discloses a protection semiconductor device for protecting an assembled battery in which secondary battery cells are connected in series.

### REFERENCE

### Patent Document

[Patent Document 1] Specification of United States Patent Application Publication No. 2011-267726
[Patent Document 2] Japanese Published Patent Application No. 2010-66161
[Patent Document 3] Japanese Published Patent Application No. 2010-220389

### SUMMARY OF THE INVENTION

### Problems to be Solved by the Invention

One object of one embodiment of the present invention is to provide a power storage system with a high energy density. Another object of one embodiment of the present invention is to provide a power storage system with a high degree of safety. Another object of one embodiment of the present invention is to provide a charging method of a power storage system with a high energy density. Another object of one embodiment of the present invention is to provide a charging method of a power storage system with a high degree of safety. Another object of one embodiment of the present invention is to provide a secondary battery with a high energy density. Another object of one embodiment of the present invention is to provide a secondary battery with a high degree of safety. Another object of one embodiment of the present invention is to provide a novel charging method of a secondary battery. Another object of one embodiment of the present invention is to provide a power storage system using a highly reliable positive electrode active material. Another object of one embodiment of the present invention is to provide a highly reliable positive electrode active material. Another object of one embodiment of the present invention is to provide an excellent power storage system by applying a positive electrode active material of one embodiment of the present invention to the power storage system of one embodiment of the present invention. Another object of one embodiment of the present invention is to estimate a state of a secondary battery. Another object of one embodiment of the present invention is to estimate a charge depth of a secondary battery. Another object of one embodiment of the present invention is to estimate a full chargeable capacity of a secondary battery, and a deterioration state of the secondary battery. Another object of one embodiment of the present invention is to estimate a dischargeable capacity of a secondary battery.

Another object of one embodiment of the present invention is to provide a novel charging unit, a novel charge control circuit, a novel battery control circuit, a novel battery protection circuit, a novel power storage device, a novel semiconductor device, a novel vehicle, a novel electronic device, or the like. Another object of one embodiment of the present invention is to provide a charging unit, a charge control circuit, a battery control circuit, a battery protection circuit, a power storage device, a semiconductor device, a vehicle, an electronic device, or the like with low power consumption. Another object of one embodiment of the present invention is to provide a charging unit, a charge control circuit, a battery control circuit, a battery protection circuit, a power storage device, a semiconductor device, a vehicle, an electronic device, or the like with a high degree of integration.

Note that the objects of one embodiment of the present invention are not limited to the objects listed above. The objects listed above do not preclude the existence of other objects. Note that the other objects are objects that are not described in this section and will be described below. The objects that are not described in this section are derived from the description of the specification, the drawings, and the like and can be extracted as appropriate from the description by those skilled in the art. Note that one embodiment of the present invention is to solve at least one of the objects listed above and/or the other objects.

### Means for Solving the Problems

A charging unit of one embodiment of the present invention can be preferably used in combination with a secondary battery using a positive electrode active material of one embodiment of the present invention, in particular. The charging unit of one embodiment of the present invention has a function of detecting a change in a charge process of a crystal structure of the positive electrode active material of one embodiment of the present invention by measuring a charge voltage and a charge current of the secondary battery and analyzing the measured charge voltage and the measured charge current.

In the secondary battery, the charge voltage in repeated charge and discharge is increased to the utmost limit, which can increase the charge capacity. To provide a secondary battery with a long lifetime, it is preferable that a change of a crystal structure of a positive electrode active material be substantially reversible even at an increased charge voltage. In the charging method of one embodiment of the present invention, a change of the crystal structure of the positive electrode active material is substantially reversible, and thereby collapse of the crystal structure of the positive electrode active material in charging is inhibited; therefore, a high capacity and long life secondary battery can be provided.

In the positive electrode active material of one embodiment of the present invention, a change of the crystal structure of the positive electrode active material can be substantially reversible even at an increased charge voltage. The charging unit of one embodiment of the present invention preferably employs the positive electrode active material of one embodiment of the present invention in a secondary battery, and thereby has a function of detecting a change of a crystal structure of the positive electrode active material and controlling charge at a high charge voltage and in a range where the crystal structure is substantially reversible.

The positive electrode active material of one embodiment of the present invention changes from an O3 type crystal structure into an O3′ type crystal structure described later. In addition, the change of the crystal structure is caused in the state of the deep charge depth of the secondary battery. The charging unit of one embodiment of the present invention has a function detecting a change from the O3 type crystal structure into the O3′ type crystal structure and controlling charge.

One embodiment of the present invention is a charging method using a charging unit having a function of controlling start and stop of charge of a secondary battery and a function of controlling a charge current of the secondary battery. The secondary battery includes a positive electrode, the positive electrode includes a positive electrode active material particle, the positive electrode active material particle is lithium cobalt oxide to which magnesium is added. The charging method includes a first step of starting constant current charge of the secondary battery at a time t1; and a second step of stopping the charge at a time t2, and a crystal structure of the lithium cobalt oxide determined by powder X-ray diffraction at the time t2 is a crystal structure represented by a space group R-3m. Note that the “be determined by X-ray diffraction” may be expressed by “be identified by X-ray diffraction”.

In the above structure, when the positive electrode is analyzed at the time t2 by the powder X-ray diffraction using CuKα 1 radiation, the positive electrode preferably has a diffraction peak at 2θ=19.35±0.10° and has a diffraction peak at 2θ=45.55±0.20°. In addition, the charge depth of the lithium cobalt oxide at the time t2 is preferably greater than or equal to 70%.

Another embodiment of the present invention is a charging method of a secondary battery, using a charging unit including a control circuit and a voltage measurement circuit, the control circuit has a function of controlling start and stop of charge of the secondary battery and a function of controlling a charge current of the secondary battery, the control circuit has a function of calculating a voltage change over time of the secondary battery and has a function of detecting a local maximum of the voltage change over time of the secondary battery, the voltage measurement circuit has a function of measuring a charge voltage of the secondary battery, the control circuit starts charge of the secondary battery at a time t3, the voltage measurement circuit measures a voltage V(t) of the secondary battery at a time t and a voltage V(t−Δt1) of the secondary battery at a time (t−Δt1) obtained by substracting a time Δt1 from the time t, the control circuit analyzes a second curve in which a horizontal axis is the time t and a vertical axis is the voltage change over time [voltage V(t)−voltage V(t−Δt1)] of the secondary battery to detect a time tq at which the second curve has a first local minimum, the control circuit stops the charge at a time t4 at which a predetermined time is elapsed from the time tq, a constant current charge is performed on the secondary battery from the time t3 until the time t4, and a voltage V(tq) of the secondary battery at the time tq is higher than or equal to 4.25 V.

In the above structure, it is preferable that the control circuit include an analog-digital conversion circuit, the analog-digital conversion circuit have a function of converting an analog value of the measured charge voltage to a digital value, and a resolution of the analog-digital conversion circuit be less than or equal to 12 bits.

In the above structure, it is preferable that the secondary battery include a positive electrode, the positive electrode include lithium and cobalt, and a crystal structure determined by powder X-ray diffraction at the time tq be a crystal structure represented by a space group R-3m.

In the above structure, it is preferable that the charging unit include a memory circuit, data corresponding to an ambient temperature be stored in the memory circuit, and the time tq be detected with use of the data.

In the above structure, it is preferable that the charging unit include a memory circuit, data corresponding to a positive electrode active material of the secondary battery be stored in the memory circuit, and the time tq be detected with use of the data.

One embodiment of the present invention is a charging method of a secondary battery, using a charging unit including a control circuit, a voltage measurement circuit, and a current measurement circuit, the control circuit has a function of controlling start and stop of charge of the secondary battery and a function of controlling a charge current of the secondary battery, the control circuit has a function of calculating a derivative of quantity of electricity with respect to voltage of the secondary battery and a function of detecting a local maximum of the derivative of quantity of electricity with respect to voltage, the voltage measurement circuit has a function of measuring a charge voltage of the secondary battery, the current measurement circuit has a function of measuring a charge current of the secondary battery, charge of the secondary battery is started at a time t1, a quantity of electricity Q(t) is calculated with use of a current I(t) at a time t, a first curve in which a horizontal axis is the voltage V(t) and a vertical axis is the derivative of a quantity of electricity Q(t) with respect to voltage [dQ(t)/dV(t)] is analyzed to detect a time tp at which the first curve has a first local maximum, the charge is stopped at a time t2 at which a predetermined time is elapsed from the time tp, and a voltage V(tp) at the time tp is higher than or equal to 4.25 V.

In the above structure, the charge is preferably constant current charge.

In the above structure, the secondary battery includes a positive electrode, the positive electrode includes lithium and cobalt, a crystal structure determined in analysis of the positive electrode by powder X-ray diffraction at the time tp is preferably a crystal structure represented by a space group R-3m. In addition, in the above structure, the positive electrode includes lithium cobalt oxide, a crystal structure of the lithium cobalt oxide determined by the powder X-ray diffraction at the time tp is preferably a crystal structure represented by a space group R-3m.

In the above structure, it is preferable that the charging unit include a memory circuit, data corresponding to an ambient temperature be stored in the memory circuit, and the time tp be detected with use of the data.

In the above structure, it is preferably that the charging unit include a memory circuit, data corresponding to a positive electrode active material of the secondary battery be stored in the memory circuit, and the time tp be detected with use of the data.

One embodiment of the present invention is a charging method of a secondary battery, using a charging unit including a control circuit, a voltage measurement circuit, and a current measurement circuit, the control circuit has a function of controlling start and stop of charge of the secondary battery and a function of controlling a charge current of the secondary battery, the control circuit has a function of calculating a voltage change over time of the secondary battery and a function of detecting a local maximum of the voltage change over time, the voltage measurement circuit has a function of measuring a charge voltage of the secondary battery, the current measurement circuit has a function of measuring a charge current of the secondary battery, the control circuit starts charge of the secondary battery at a time t3, the voltage measurement circuit measures a voltage V(t) of the secondary battery at a time t and a voltage V(t−Δt1) of the secondary battery at a time (t−Δt1) obtained by substracting a time Δt1 from the time t, the control circuit analyzes a second curve in which a horizontal axis is the time t and a vertical axis is the voltage change over time [voltage V(t)−voltage V(t−Δt1)] of the secondary battery to detect a time tq at which the second curve has a first local minimum, the control circuit stops the charge at a time t4 at which a predetermined time is elapsed from the time tq, constant current charge is performed on the secondary battery from the time t3 until the time t4, and a voltage V(tq) of the secondary battery at the time tq is higher than or equal to 4.25 V.

In the above structure, it is preferable that the secondary battery include a positive electrode, the positive electrode include lithium and cobalt, a crystal structure determined in analysis of the positive electrode by powder X-ray diffraction at the time t3 be a crystal structure represented by the space group R-3m. In the above structure, it is preferable that the secondary battery include a positive electrode, the positive electrode include lithium cobalt oxide, a crystal structure of the lithium cobalt oxide determined by the powder X-ray diffraction at the time tq be a crystal structure represented by the space group R-3m.

In the above structure, it is preferable that the charging unit include a memory circuit, data corresponding to an ambient temperature be stored in the memory circuit, and the time tq be detected with use of the data.

In the above structure, it is preferable that the charging unit include a memory circuit, data corresponding to a positive electrode active material of the secondary battery be stored in the memory circuit, and the time tq be detected with use of the data.

A charging method of a secondary battery, using a charging unit having a function of controlling start and stop of charge of the secondary battery and having a function of controlling a charge current of the secondary battery, the secondary battery includes a positive electrode, and the positive electrode includes lithium and cobalt. The charging method includes a first step of starting constant current charge of the secondary battery at a time t1 and a second step of stopping the charge at a time t2, and a crystal structure determined by X-ray diffraction at the time t2 is a crystal structure represented by the space group R-3m.

In the above structure, when the positive electrode is analyzed by powder X-ray diffraction using CuKα1 radiation at the time t2, the positive electrode preferably has diffraction peaks at 2θ=19.35±0.100 and 2θ=45.55±0.20°.

In the above structure, the positive electrode preferably includes lithium cobalt oxide.

In the above structure, it is preferable that the positive electrode include a metal oxide represented by LiMO₂ (M is a metal), and the metal M include two or more metals including cobalt.

One embodiment of the present invention is a charging method of a secondary battery, using a charging unit including a control circuit and a voltage measurement circuit, the control circuit has a function of controlling start and stop of charge of the secondary battery and a function of controlling a charge current of the secondary battery, the control circuit has a function of calculating a voltage change over time of the secondary battery and has a function of detecting a local maximum of the voltage change over time, and the voltage measurement circuit has a function of measuring a charge voltage of the secondary battery. The charging method includes a first step of starting constant current charge of the secondary battery by the control circuit; a second step of measuring a voltage V of the secondary battery by the voltage measurement circuit; a third step in which a process proceeds to a fourth step when a voltage V is compared with a predetermined voltage V1 by the control circuit and the voltage V is higher than or equal to the voltage V1, and the process returns to the second step when the voltage V is lower than the voltage V1; the fourth step in which the control circuit accumulates a set of data containing dt/dV and a time t, and calculates a moving average of the dt/dV, [dt/dV]mean and a maximum value of the accumulated dt/dV, [dt/dV]max; a fifth step in which the control circuit compares the [dt/dV]mean with a value obtained by multiplying the [dt/dV]max by a constant Rt, and when the [dt/dV]mean is lower than the value obtained by multiplying the [dt/dV]max by the constant Rt, the process proceeds to a sixth step, and when the [dt/dV]mean is higher than or equal to the value obtained by multiplying the [dt/dV]max by the constant Rt, the process returns to the fourth step; and the sixth step in which the control circuit stops the constant current charge of the secondary battery.

In the above structure, it is preferable that the voltage V1 be higher than or equal to 4.25 V, and the constant Rt be greater than or equal to 0.6 and less than or equal to 0.9.

### Effect of the Invention

According to one embodiment of the present invention, a power storage system with a high energy density can be provided. According to another embodiment of the present invention, a power storage system with a high degree of safety can be provided. According to another embodiment of the present invention, a secondary battery with a high energy density can be provided. According to another embodiment of the present invention, a secondary battery with a high degree of safety can be provided. According to another embodiment of the present invention, a novel charging method of a secondary battery can be provided. According to another embodiment of the present invention, a power storage system using a highly reliable positive electrode active material can be provided. According to another embodiment of the present invention, a highly reliable positive electrode active material can be provided. According to another embodiment of the present invention, an excellent power storage system by applying a positive electrode active material of one embodiment of the present invention to the power storage system of one embodiment of the present invention can be provided. According to another embodiment of the present invention, a state of a secondary battery can be estimated. According to another embodiment of the present invention, a charge depth of a secondary battery can be estimated. According to another embodiment of the present invention, a full chargeable capacity of a secondary battery of a secondary battery can be estimated, and a deterioration state of the secondary battery can be estimated. According to another embodiment of the present invention, a dischargeable capacity of a secondary battery can be estimated.

According to another embodiment of the present invention, a novel charging unit, a novel charge control circuit, a novel battery control circuit, a novel battery protection circuit, a novel power storage device, a novel semiconductor device, a novel vehicle, a novel electronic device, or the like can be provided. According to another embodiment of the present invention, a charging unit, a charge control circuit, a battery control circuit, a battery protection circuit, a power storage device, a semiconductor device, a vehicle, an electronic device, or the like with low power consumption can be provided. According to another embodiment of the present invention, a charging unit, a charge control circuit, a battery control circuit, a battery protection circuit, a power storage device, a semiconductor device, a vehicle, an electronic device, or the like with a high degree of integration can be provided.

Note that the effects of one embodiment of the present invention are not limited to the effects listed above. The effects listed above do not preclude the existence of other effects. The other effects are effects that are not described in this section and will be described below. The effects that are not described in this section are derived from the description of the specification, the drawings, or the like and can be extracted as appropriate from the description by those skilled in the art. Note that one embodiment of the present invention has at least one of the effects listed above and/or the other effects. Accordingly, one embodiment of the present invention does not have the effects listed above in some cases.

### BRIEF DESCRIPTION OF THE DRAWINGS

FIG. 1A is a block diagram illustrating an example of a battery storage system. FIG. 1B is a block diagram illustrating an example of a battery storage system.

FIG. 2A is a block diagram illustrating an example of a battery storage system. FIG. 2B is a block diagram illustrating an example of a battery storage system.

FIG. 3A is a block diagram illustrating an example of a battery storage system. FIG. 3B is a block diagram illustrating an example of a battery storage system.

FIG. 4A is a block diagram illustrating an example of a battery storage system. FIG. 4B is a block diagram illustrating an example of a battery storage system.

FIG. 5 is a flowchart illustrating a charging method of a secondary battery.

FIG. 6 is a flowchart illustrating a charging method of a secondary battery.

FIG. 7A is a block diagram illustrating an example of a battery storage system. FIG. 7B is a block diagram illustrating an example of a battery storage system. FIG. 7C is a block diagram illustrating an example of a battery storage system.

FIG. 8A is a cross-sectional view of a positive electrode active material, and FIG. 8B to FIG. 8E are parts of the cross-sectional view of the positive electrode active material.

FIG. 9A and FIG. 9B are cross-sectional views of a positive electrode active material, and FIG. 9C and FIG. 9D are parts of the cross-sectional view of the positive electrode active material.

FIG. 10 is a cross-sectional view of a positive electrode active material.

FIG. 11 is a cross-sectional view of a positive electrode active material.

FIG. 12 is a diagram illustrating crystal structures of a positive electrode active material.

FIG. 13 is a diagram illustrating an example of a method for forming a positive electrode active material.

FIG. 14 is a diagram illustrating an example of a method for forming a positive electrode active material.

FIG. 15A and FIG. 15B are diagrams illustrating an external view of a secondary battery.

FIG. 16A and FIG. 16B are diagrams illustrating a method of fabricating a secondary battery.

FIGS. 17A and 17B are diagrams illustrating a method of fabricating a secondary battery.

FIG. 18 is a cross-sectional view illustrating an example of a secondary battery.

FIG. 19A is a diagram illustrating an example of a secondary battery. FIG. 19B and FIG. 19C are diagrams illustrating an example of a method of fabricating of a stack body.

FIG. 20A to FIG. 20C are diagrams illustrating an example of a method for fabricating a secondary battery.

FIG. 21A and FIG. 21B are cross-sectional views illustrating an example of a stacked body. FIG. 21C is a cross-sectional view illustrating an example of a secondary battery.

FIG. 22A and FIG. 22B are diagrams illustrating an example of a secondary battery. FIG. 22C is a diagram illustrating the inside of the secondary battery.

FIG. 23A to FIG. 23C are diagrams illustrating an example of a secondary battery.

FIG. 24 is a block diagram illustrating an example of a vehicle including a motor.

FIG. 25A to FIG. 25E are diagrams illustrating examples of transportation vehicles.

FIG. 26A illustrates an electric bicycle, FIG. 26B illustrates a secondary battery of an electric bicycle, and FIG. 26C illustrates an electric motorcycle.

FIG. 27A and FIG. 27B are diagrams illustrating examples of a power storage device.

FIG. 28A to FIG. 28E are diagrams illustrating an electronic device.

FIG. 29A to FIG. 29F are diagrams illustrating examples of electronic devices.

FIG. 30A to FIG. 30C are diagrams illustrating examples of electronic devices.

FIG. 31 is a diagram illustrating examples of electronic devices.

FIG. 32A to FIG. 32C are diagrams illustrating examples of electronic devices.

FIG. 33A to FIG. 33D are diagrams illustrating examples of electronic devices.

FIG. 34A and FIG. 34B are dQ/dV−V curves.

FIG. 35A and FIG. 35B are dQ/dV−V curves.

FIG. 36A is a V-C curve. FIG. 36B is a ΔV−t curve.

FIG. 37A and FIG. 37B are dQ/dV curves.

FIG. 38A is a graph showing a relation between a charge-discharge cycle number and discharge capacity. FIG. 38B is a graph showing a relation between the charge-discharge cycle number and a discharge capacity retention rate.

FIG. 39A and FIG. 39B are graphs each showing a relation between a charge time and a voltage and a relation between the charge time and charge capacity.

FIG. 40A is a graph showing a relation between a charge time and a voltage and a relation between the charge time and charge capacity. FIG. 40B is a graph showing a relation between a charge-discharge cycle number and the maximum charge voltage.

FIG. 41A and FIG. 41B are SEM images.

FIG. 42A and FIG. 42B are SEM images.

FIG. 43A and FIG. 43B are SEM images.

FIG. 44A shows a transmission electron image. FIG. 44B is a Z-contrast image. FIG. 44C is a transmission electron image.

FIG. 45A shows a transmission electron image. FIG. 45B is a Z-contrast image. FIG. 45C is a transmission electron image.

FIG. 46A shows a transmission electron image. FIG. 46B is a Z-contrast image. FIG. 46C is a transmission electron image.

FIG. 47A shows a transmission electron image. FIG. 47B is a Z-contrast image. FIG. 47C is a transmission electron image. FIG. 47D to FIG. 47F show EDX area analysis results.

FIG. 48A shows a transmission electron image. FIG. 48B is a Z-contrast image. FIG. 48C is a transmission electron image. FIG. 48D to FIG. 48F show EDX area analysis results.

FIG. 49A shows a transmission electron image. FIG. 49B is a Z-contrast image. FIG. 49C is a transmission electron image. FIG. 49D to FIG. 49F show EDX area analysis results.

FIG. 50A to FIG. 50C show EDX line analysis results.

FIG. 51 is a flowchart showing a charging method of a secondary battery.

FIG. 52 shows results of cycle performance of a secondary battery.

FIG. 53 shows a relation between an end voltage of charge and charge-discharge cycles of a secondary battery.

FIG. 54A to FIG. 54C show dQ/dV curves of a secondary battery.

FIG. 55A and FIG. 55B show dQ/dV curves of a secondary battery.

### MODE FOR CARRYING OUT THE INVENTION

Hereinafter, embodiments are described with reference to the drawings. Note that the embodiments can be implemented with many different modes, and it is readily understood by those skilled in the art that modes and details thereof can be changed in various ways without departing from the spirit and scope thereof. Thus, the present invention should not be construed as being limited to the following description of the embodiments.

Note that ordinal numbers such as “first”, “second”, and “third” in this specification and the like are used in order to avoid confusion among components. Thus, the ordinal numbers do not limit the number of components. In addition, the ordinal numbers do not limit the order of components. Furthermore, in this specification and the like, for example, a “first” component in one embodiment can be referred to as a “second” component in other embodiments or the scope of claims. Moreover, in this specification and the like, for example, a “first” component in one embodiment can be omitted in other embodiments or the scope of claims.

Note that in the drawings, the same elements, elements having similar functions, elements formed of the same material, elements formed at the same time, or the like are sometimes denoted by the same reference numerals, and repeated description thereof is omitted in some cases.

The position, size, range, and the like of each component illustrated in the drawings and the like are not accurately represented in some cases to facilitate understanding of the invention. Therefore, the disclosed invention is not necessarily limited to the position, size, range, and the like disclosed in the drawings and the like.

In a top view (also referred to as a plan view), a perspective view, or the like, some components are not illustrated for easy understanding of the drawings in some cases.

In addition, in this specification and the like, the terms “electrode” or “wiring” do not functionally limit these components. For example, “electrode” or “wiring” is used as part of “electrode” or “wiring” in some cases, and vice versa. Furthermore, the terms “electrode” or “wiring” also include the case where a plurality of “electrodes” or a plurality of “wirings” are formed in an integrated manner, for example.

Furthermore, in this specification and the like, a “terminal” refers to a wiring or an electrode connected to a wiring in some cases, for example. Moreover, in this specification and the like, part of a “wiring” is referred to as a “terminal” in some cases.

Note that each of the terms “over” or “under” in this specification and the like does not necessarily mean that a component is placed directly over and in contact with or directly under and in contact with another component. For example, the expression “electrode B over insulating layer A” does not necessarily mean that the electrode B is formed on and in direct contact with the insulating layer A, and does not exclude the case where another component is provided between the insulating layer A and the electrode B.

Furthermore, functions of a source and a drain are switched depending on operation conditions, e.g., when a transistor of opposite polarity is employed or a direction of current flow is changed in circuit operation. Therefore, it is difficult to define which is a source or a drain. Thus, the terms “source” and “drain” can be interchanged with each other in this specification.

In this specification and the like, the expression “electrically connected” includes the case where components are directly connected to each other and the case where components are connected through an “object having any electric function”. Here, there is no particular limitation on the “object having any electric function” as long as electric signals can be transmitted and received between components that are connected through the object. Thus, even when the expression “electrically connected” is used, there is a case where no physical connection is made and a wiring just extends in an actual circuit.

In this specification and the like, “parallel” indicates a state where two straight lines are placed at an angle of greater than or equal to −10° and less than or equal to 10°, for example. Accordingly, the case where the angle is greater than or equal to −5° and less than or equal to 5° is also included. Moreover, “perpendicular” and “orthogonal” indicate a state where two straight lines are placed at an angle of greater than or equal to 80° and less than or equal to 100°, for example. Accordingly, the case where the angle is greater than or equal to 850 and less than or equal to 950 is also included.

In this specification and the like, the terms “identical”, “the same”, “equal”, “uniform”, and the like used in describing calculation values and actual measurement values allow for a margin of error of ±20% unless otherwise specified.

Note that voltage refers to a potential difference between a given potential and a reference potential (e.g., a ground potential or a source potential) in many cases. Therefore, the terms voltage and potential can be replaced with each other in many cases.

Note that a “semiconductor” has characteristics of an “insulator” when the conductivity is sufficiently low, for example. Thus, a “semiconductor” and an “insulator” can be replaced with each other. In that case, a “semiconductor” and an “insulator” cannot be strictly distinguished from each other because a border therebetween is not clear. Accordingly, a “semiconductor” and an “insulator” in this specification can be replaced with each other in some cases.

Furthermore, a “semiconductor” has characteristics of a “conductor” when the conductivity is sufficiently high, for example. Thus, a “semiconductor” and a “conductor” can be replaced with each other. In that case, a “semiconductor” and a “conductor” cannot be strictly distinguished from each other because a border therebetween is not clear. Accordingly, a “semiconductor” and a “conductor” in this specification can be replaced with each other in some cases.

Note that in this specification and the like, an “on state” of a transistor refers to a state in which a source and a drain of the transistor are regarded as being electrically short-circuited (also referred to as a “conduction state”). Furthermore, an “off state” of a transistor refers to a state in which a source and a drain of the transistor are regarded as being electrically disconnected (also referred to as a “non-conduction state”).

In addition, in this specification and the like, an “on-state current” sometimes refers to a current that flows between a source and a drain when a transistor is in an on state. Furthermore, an “off-state current” sometimes refers to a current that flows between a source and a drain when a transistor is in an off state.

In this specification and the like, a high power supply potential VDD (hereinafter also simply referred to as “VDD” or an “H potential”) is a power supply potential higher than a low power supply potential VSS. The low power supply potential VSS (hereinafter also simply referred to as “VSS” or an “L potential”) is a power supply potential lower than the high power supply potential VDD. In addition, a ground potential can be used as VDD or VSS. For example, in the case where VDD is the ground potential, VSS is a potential lower than the ground potential, and in the case where VSS is the ground potential, VDD is a potential higher than the ground potential.

In this specification and the like, a gate refers to part or the whole of a gate electrode and a gate wiring. A gate wiring refers to a wiring for electrically connecting a gate electrode of at least one transistor to another electrode or another wiring.

In this specification and the like, a source refers to part or the whole of a source region, a source electrode, and a source wiring. A source region refers to a region in a semiconductor layer where the resistivity is lower than or equal to a given value. A source electrode refers to part of a conductive layer which is connected to a source region. A source wiring refers to a wiring for electrically connecting a source electrode of at least one transistor to another electrode or another wiring.

Moreover, in this specification and the like, a drain refers to part or all of a drain region, a drain electrode, or a drain wiring. A drain region refers to a region in a semiconductor layer where the resistivity is lower than or equal to a given value. A drain electrode refers to part of a conductive layer which is connected to a drain region. A drain wiring refers to a wiring for electrically connecting a drain electrode of at least one transistor to another electrode or another wiring.

In this specification and the like, segregation refers to a phenomenon in which, in a solid made of a plurality of elements (e.g., A, B, and C), a certain element (e.g., B) is spatially non-uniformly distributed.

In this specification and the like, a surface portion of a particle of an active material or the like refers to a region ranging from the surface to a depth of approximately 10 nm, in a perpendicular direction or a substantially perpendicular direction from the surface toward the inner portion. The surface portion refers to a region within 50 nm from the surface. Alternatively, the surface portion refers to a region within 5 nm from the surface. The surface portion can be rephrased as the vicinity of a surface, a region in the vicinity of a surface, or a shell. Note that “substantially perpendicular” refers to a state where an angle is greater than or equal to 80° and less than or equal to 100°. A plane generated by a fissure or a crack can be considered as a surface. A region at a position deeper than the superficial portion is referred to as an inner portion. In addition, the surface of the positive electrode active material in EDX line analysis or the like refers to a measurement point showing a measurement value which is closest to 50% of the average value of the detection amount of the transition metal in bulk. Alternatively, the interface can be an intersecting point between a tangent drawn by a tangent method to an intensity profile of the transition metal M obtained by EDX line analysis and an axis in the depth direction. The surface of the positive electrode active material in, for example, a STEM image is a boundary between a region where an image derived from the crystal structure of the positive electrode active material is observed and a region where the image is not observed, and is determined as the outermost surface of a region where an atomic column derived from an atomic nucleus of a metal element that has a larger atomic number than lithium. Alternatively, the surface refers to an intersection of a tangent drawn at a luminance profile from the surface toward the bulk and an axis in the depth direction in a STEM image. The surface in a STEM image or the like may be judged in combination with analysis with higher spatial resolution.

In this specification and the like, a layered rock-salt crystal structure of a composite oxide containing lithium and a transition metal refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may be included. In the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may be included.

In this specification and the like, an O3′ type crystal structure (also referred to as a pseudo-spinel crystal structure) of a composite oxide containing lithium and a transition metal refers to a crystal structure with a space group R-3m, which is not a spinel crystal structure but a crystal structure in which an ion of cobalt, magnesium, or the like is coordinated to six oxygen atoms and the cation arrangement has symmetry similar to that of the spinel crystal structure. Note that in the O3′ type crystal structure, a light element such as lithium is sometimes coordinated to four oxygen atoms. In that case, the ion arrangement also has symmetry similar to that of the spinel crystal structure.

The O3′ type crystal structure can be regarded as a crystal structure that contains Li between layers randomly and is similar to a CdCl₂ crystal structure. The crystal structure similar to the CdCl₂ crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have this crystal structure generally.

Anions of a layered rock-salt crystal and anions of a rock-salt crystal form a cubic close-packed structure (face-centered cubic lattice structure). Anions of an O3′ crystal are presumed to form a cubic close-packed structure. When these crystals are in contact with each other, there is a crystal plane at which orientations of cubic closest packed structures composed of anions are aligned. Note that space groups of the layered rock-salt crystal and the O3′ crystal are R-3m, which are different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the O3′ crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other.

A secondary battery includes a positive electrode and a negative electrode, for example. A positive electrode active material is a material included in the positive electrode. The positive electrode active material is a substance that performs a reaction contributing to a charge-discharge capacity, for example. Note that the positive electrode active material may partly contain a substance that does not contribute to the charge-discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

In this specification and the like, the Miller index is used for the expression of crystal planes and crystal orientations. An individual plane that shows a crystal plane is denoted by “( )”. In the crystallography, a bar is placed over a number in the expression of crystal planes, crystal orientations, and space groups; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and, in some cases, not only (hkl) but also (hkil) is used as the Miller index. Here, i is −(h+k).

In this specification and the like, a theoretical capacity of a positive electrode active material refers to the quantity of electricity obtained when all lithium that can be inserted into and extracted from the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification, a charge depth is a value indicating the degree of charge in a capacity, in other words, the amount of lithium extracted from a positive electrode, relative to the theoretical capacity of a positive electrode active material. For example, in the case of a positive electrode active material having a layered rock-salt structure such as lithium cobalt oxide (LiCoO₂) or lithium nickel cobalt manganese oxide (LiNiₓCo_{y}Mn_{z}O₂ (x+y+z=1)), a charge depth of 0 indicates a state where no Li has been extracted from the positive electrode active material; a charge depth of 0.5 indicates a state where lithium corresponding to 137 mAh/g has been extracted from the positive electrode active material; and a charge depth of 0.8 indicates a state where lithium corresponding to 219.2 mAh/g has been extracted from the positive electrode active material, relative to the theoretical capacity of 274 mAh/g. In the case where an expression LiaCoO₂ (0≤a≤1) is used, LiₐCoO₂ (0≤a≤1) is LiCoO₂ where a is 1 when the charge depth is 0; LiₐCoO₂ (0≤a≤1) is Li_{0.5}CoO₂ where a is 0.5 when the charge depth is 0.5; and LiₐCoO₂ (0≤a≤1) is Li_{0.2}CoO₂ where a is 0.2 when the charge depth is 0.8.

### Embodiment 1

In this embodiment, a charging unit of one embodiment of the present invention and a power storage system that includes the charging unit of one embodiment of the present invention are described.

### Example 1 of Power Storage System

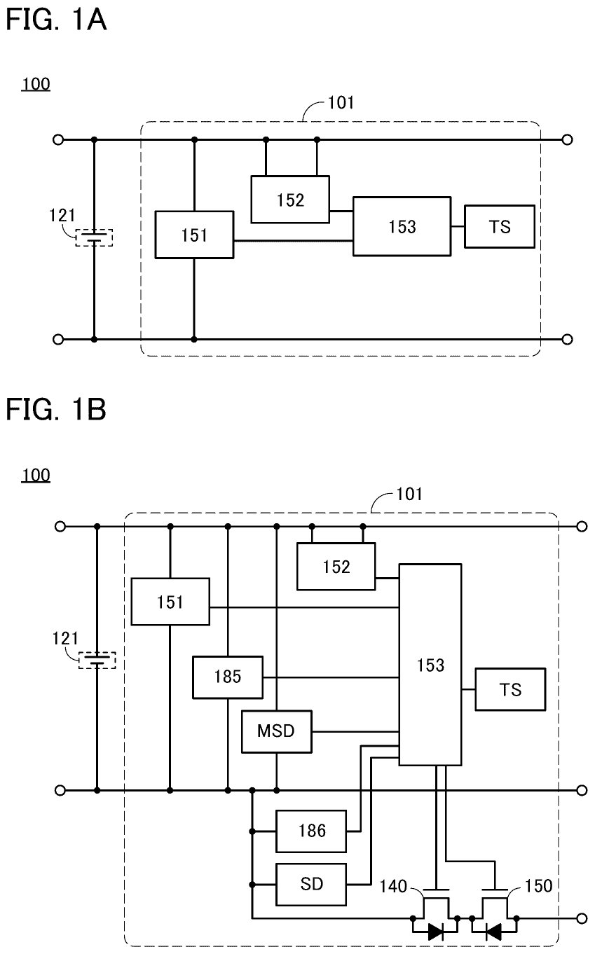

FIG. 1A illustrates an example of a power storage system 100. The power storage system 100 includes a charging unit 101 and a secondary battery 121. The charging unit 101 is electrically connected to a positive electrode and a negative electrode of the secondary battery 121.

The charging unit 101 includes a control circuit 153, a current measurement circuit 152, and a voltage measurement circuit 151. The charging unit 101 preferably includes a temperature sensor TS. The ambient temperature of the secondary battery can be measured by the temperature sensor TS. The temperature sensor TS is set to be in contact with an exterior body or a housing of the secondary battery, for example. Charge control using the temperature is described later.

The current measurement circuit 152 has a function of measuring a current of the secondary battery 121. In particular, the current measurement circuit 152 preferably has a function of measuring a charge current of the secondary battery 121. The current measurement circuit 152 can supply a measured current value to the control circuit 153.

The voltage measurement circuit 151 has a function of measuring a voltage of the secondary battery 121. In particular, the voltage measurement circuit 151 preferably has a function of measuring a charge voltage of the secondary battery 121. The voltage measurement circuit 151 can supply a measured voltage value to the control circuit 153.

The control circuit 153 has a function of controlling the start and stop of charge of the secondary battery 121. The control circuit 153 also has a function of controlling charge conditions of the secondary battery 121. Specifically, the control circuit 153 has a function of controlling a charge current of the secondary battery 121, for example.

As the control circuit 153, a CPU (central processing unit), an MCU (Micro Controller Unit), or the like can be used.

The control circuit 153 has a function of calculating change over time of a voltage of the secondary battery 121 supplied from the voltage measurement circuit 151. For example, the calculation of voltage change over time refers to an operation in which a plurality of sets of data containing a voltage value and time are obtained and utilized for calculation. Alternatively, the control circuit 153 has a function, specifically, of calculating time derivative. Note that the control circuit 153 preferably includes an analog-digital conversion circuit. The control circuit 153 can convert the obtained analog voltage value of the secondary battery into a digital value with the use of the analog-digital conversion circuit. In the case where an MCU is used as the control circuit 153, the control circuit 153 may include the voltage measurement circuit 151 and an analog-digital conversion circuit unit. The analog-digital conversion circuit may be prepared separately from the control circuit 153.

The control circuit 153 has a function of calculating the quantity of electricity of the secondary battery with the use of a voltage value of the secondary battery 121 supplied from the voltage measurement circuit 151 and a current value of the secondary battery 121 supplied from the current measurement circuit 152. The control circuit 153 has a function of calculating a derivative of quantity of electricity with respect to voltage (dQ/dV) of the secondary battery.

The control circuit 153 includes a memory circuit. The memory circuit has a function of a register of a CPU or an MCU, or a cache memory, for example. The memory circuit has a function of storing, for example, various programs used in the power storage system 100, data necessary for operation of the power storage system 100, or the like.

FIG. 1B illustrates an example in which the charging unit 101 includes has a detection circuit 185, a detection circuit 186, a short-circuit detection circuit SD, a micro-short-circuit detection circuit MSD, a transistor 140, and a transistor 150 in addition to the structure illustrated in FIG. 1A. The detection circuit 185, the detection circuit 186, the short-circuit detection circuit SD, the micro-short-circuit detection circuit MSD, the transistor 140, and the transistor 150 will be described later in detail.

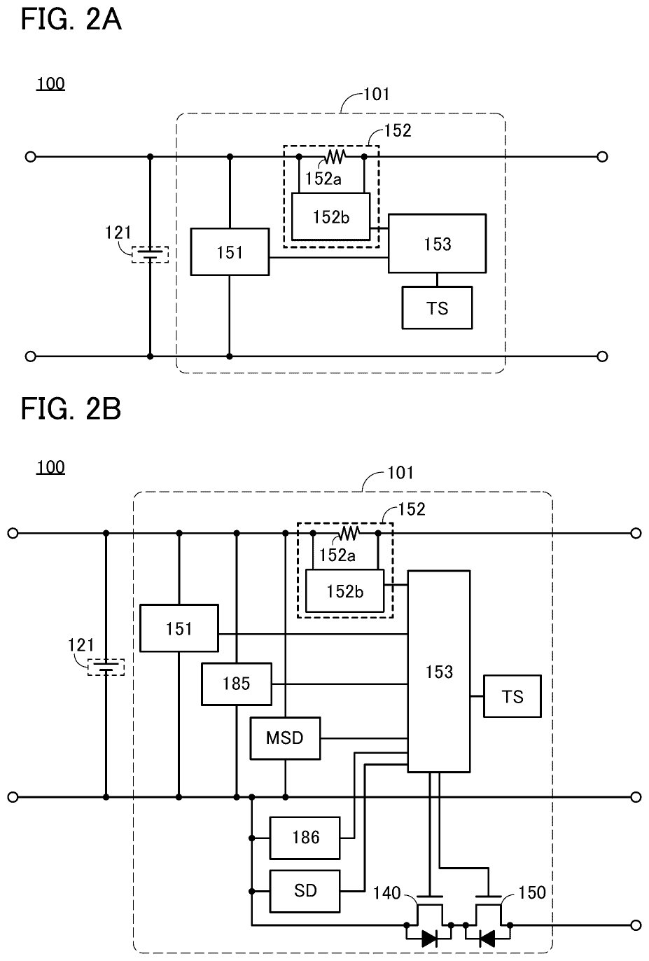

The current measurement circuit 152 includes a resistor, for example. FIG. 2A and FIG. 2B illustrate examples in which the current measurement circuit 152 includes a resistor 152a and a circuit 152b.

The resistor 152a has a function of a shunt resistor. The circuit 152b has a function of measuring voltages at both ends of the resistor 152a.

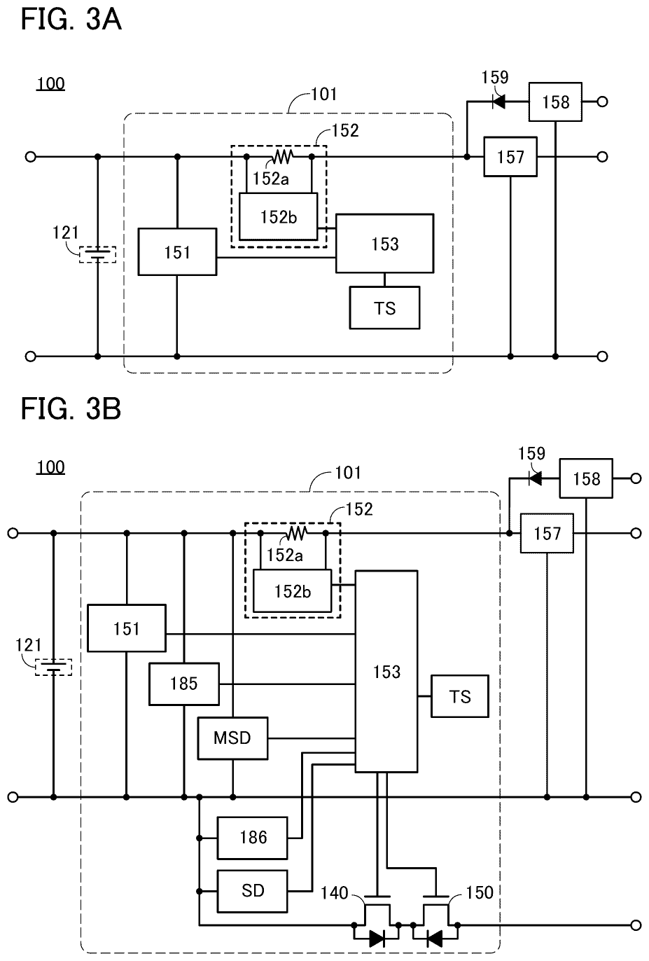

The power storage system 100 may further include a DC-DC converter 157 as illustrated in FIG. 3A and FIG. 3B. The DC-DC converter 157 includes a voltage conversion circuit and a control circuit. The DC-DC converter 157 has a function of converting a voltage of the secondary battery 121 and outputting the converted voltage.

The power storage system 100 may further include a circuit 158 as illustrated in FIG. 3A and FIG. 3B. The circuit 158 preferably has a function of an AC adapter. The circuit 158 has a function of converting AC power into DC power, for example. The circuit 158 may have a function of converting a voltage, for example. The circuit 158 has a function of supplying electric power that has been converted into DC to the secondary battery. The circuit 158 may have a function of controlling a current value and a voltage value to be supplied when supplying electric power to the secondary battery. Alternatively, the circuit 158 may have a function of controlling a current value and a voltage value that are supplied to the secondary battery, on the basis of a signal supplied from the control circuit 153.

Furthermore, as illustrated in FIG. 3A and FIG. 3B, a diode 159 may be provided between the circuit 158 and the charging unit 101 in the power storage system 100. The diode 159 has a function of inhibiting a reverse current from the charging unit 101 to the circuit 158.

In the secondary battery, the crystal structure of a positive electrode active material changes as the charge depth is deeper (as the charge capacity is increased). If the change of the crystal structure is irreversible, the chargeable capacity of the secondary battery might be decreased by repeated charge in some cases.

Therefore, for achievement of a secondary battery with a high capacity and a long lifetime, for example, the charge depth of the secondary battery is required to be increased and be controlled to be in a range where the change of the crystal structure can be substantially reversible.

For example, when a certain voltage is set as an upper limit voltage of charge of the secondary battery, the charge depth of the secondary battery can be controlled to be in the range where the change of the crystal structure can be substantially reversible. However, the state of the secondary battery is changed by repeated charge and discharge; thus, it is difficult to keep the same charge depth of the secondary battery as the number of charge-discharge cycles is increased, even when charge is performed with the same voltage set as the upper limit voltage. Accordingly, a monitoring system for a charge process is needed to control the charge depth of the secondary battery to be in the range where the crystal structure can be substantially reversible.

The use of the charging unit of one embodiment of the present invention can monitor a charge process, and control the charge depth of the secondary battery to be deep and be in the range where the crystal structure can be substantially reversible. The positive electrode active material of one embodiment of the present invention is preferably used for the secondary battery.

The charging unit of one embodiment of the present invention controls the charge conditions of the secondary battery, thereby inhibiting the collapse of the crystal structure of a positive electrode active material of the secondary battery. Specifically, for example, the charging unit of one embodiment of the present invention can increase the charge voltage of the secondary battery to the utmost limit in the range where the collapse of the crystal structure can be inhibited, increase the reliability of the secondary battery, and achieve the high energy density by utilizing the secondary battery to the fullest extent.

In addition, the charging unit of one embodiment of the present invention can inhibit the collapse of the crystal structure of a positive electrode active material having a layered crystal structure, in particular. The positive electrode active material having a layered crystal structure has, for example, a layered arrangement of metal serving as carrier ions. For example, in lithium cobalt oxide, lithium is present in a layered manner between CoO₂ layers. In the positive electrode active material having a layered crystal structure, crystal distortion by extraction of carrier ions in charging, a change of the crystal structure due to the extraction of carrier ions, or the like might occur. For example, in lithium cobalt oxide, a shift between the CoO₂ layers, shortening of the interlayer distance between the CoO₂ layers, or the like might occur at the time of extraction of lithium ions in charging. In the case where such a change in the crystal structure of the positive electrode active material is reversible, decreases in a charge capacity and a discharge capacity due to repeated charge and discharge can be reduced. On the other hand, when the charge voltage is too high, the charge depth is increased and the amount of extracted carrier ions is increased. With the increased charge depth, the change of the crystal structure due to charge become irreversible, which might lower the charge capacity and the discharge capacity.

In addition, too high a charge voltage may cause dissolution of a component of the positive electrode active material into an electrolyte solution and collapse of the positive electrode active material. Charge at a high voltage may cause a decomposition reaction or the like of a component of an electrolyte.

The charging unit of one embodiment of the present invention can, with a simple method, detect a change of a crystal structure, increase a charge voltage to the utmost limit in a range where a high reliability can be secured, and efficiently utilize a charge-discharge capacity of a secondary battery to the fullest extent.

The secondary battery 121 including the charging unit of one embodiment of the present invention is preferably a secondary battery of which an upper limit voltage of charge can be determined on the basis of a waveform obtained in charging. Here, the waveform can have a variety of shapes, for example, a curve, a straight line, and a combined shape of a curve and a straight line. In addition, the waveform is not limited to a periodic wave. As an example of the waveform obtained in charging, a dQ/dV−V curve, a ΔV−t curve, or the like obtained from data of a voltage, a time, and a current in charging can be given, for example. That is, in the secondary battery 121, an extremum due to a change of the crystal structure of the positive electrode active material is preferably detected in a waveform obtained in charging. Furthermore, in the secondary battery 121, the charge voltage in repeated charge and discharge is preferably increased to the utmost limit, and also in the increased charge voltage, the change of the crystal structure of the positive electrode active material is preferably substantially reversible. Here, the term substantially reversible means that the change is reversible or that a deterioration due to repeated changes of a crystal structure is extremely small even in the case where the change is irreversible. The positive electrode active material of one embodiment of the present invention changes from an O3 type crystal structure into an O3′ type crystal structure described later when the SOC (State of Charge) of the secondary battery is approximately 80% or in the vicinity thereof. In addition, in the case where this change is generated, an extremum is observed in a dQ/dV curve or the like. The charging unit of one embodiment of the present invention has a function of detecting the extremum and controlling charge.

To efficiently utilize the secondary battery 121 to the fullest extent in a range where the change of the crystal structure is substantially reversible, the extremum due to the change of the crystal structure in the secondary battery 121 is preferably in the vicinity of the upper limit voltage of charge. For example, the peak due to the change of the crystal structure is preferably lower than the upper limit voltage of charge, and the difference between the voltage at which the extremum is detected and the upper limit voltage of charge is preferably less than or equal to 0.15 V.

Moreover, preferably, in the secondary battery 121, the crystal structure of the positive electrode active material can change substantially reversibly in charging and discharging, even when charge is performed at a voltage higher than a voltage at which the extremum is detected for a predetermined time. With the secondary battery 121 having such characteristics, the charging unit of one embodiment of the present invention can control the upper limit voltage of charge simply using the extremum, in order to utilize the secondary battery to the fullest extent.

The extremum due to the change of the crystal structure is detected, for example, in a voltage change curve over time of a secondary battery. Alternatively, the extremum is detected in a differential curve of voltage with respect to time (dV/dt curve) of the secondary battery.

In addition, the extremum due to the change of the crystal structure is detected, for example, in a differential curve of quantity of electricity with respect to voltage (dQ/dV curve) of the secondary battery.

Constant current-constant voltage charge (CC-CV charge) is employed for charge of a secondary battery in some case. In CC-CV charge, constant current charge is performed up to the upper limit voltage of charge, and then, constant voltage charge is performed. In CC-CV charge, constant voltage charge is performed at the upper limit voltage of charge, whereby it can take a time to perform the charge at the upper limit voltage and the charge capacity is less likely to be influenced by a change of impedance or the like due to deterioration of the secondary battery, and a charge capacity with fewer variations can be obtained.

Increasing the charge voltage can increase the charge capacity. However, charge at a high voltage may cause collapse of the crystal structure of the positive electrode active material, a decomposition reaction of a component of an electrolyte, or the like, depending on the performance of the positive electrode active material. Thus, the constant voltage charge at the upper limit voltage might promote the deterioration of the secondary battery. The use of the constant current charge is preferable because the charge time at the upper limit voltage can be reduced and the lifetime of the secondary battery can be longer. In particular, if the ambient temperature of the secondary battery is a high temperature exceeding 40° C., the secondary battery might be remarkably degraded in the constant voltage charge at the upper limit voltage. Therefore, in the case where the ambient temperature of the secondary battery is high, constant current charge is further preferably performed. In the case where the ambient temperature of the secondary battery is high, it is also preferable that constant voltage charge at a high voltage not be employed or the time of the constant voltage charge at a high voltage be as short as possible.

Here is a description of charge in the case of using a positive electrode active material represented by a chemical formula AM_{y}O_{Z} (y>0, z>0), specifically, a positive electrode active material represented by a chemical formula AM_{y}O₂, for example. Details of the positive electrode active material that is represented by the chemical formula AM_{y}O_{Z} (y>0, z>0), the element A, and the metal M are described later. Although the positive electrode active material is represented by the chemical formula AMO₂, the composition of A:M:O is not limited to 1:1:2. In addition, lithium cobalt oxide is represented by LiCoO₂ in some cases. Moreover, lithium nickel oxide is represented by LiNiO₂ in some cases.

With the use of the charging unit of one embodiment of the present invention, for example, the secondary battery is charged so that the charge depth (SOC: State of Charge) is 85% or lower, 80% or lower, or 77% or lower at a temperature of higher than or equal to 35° C. and lower than or equal to 55° C.

The degree of charge, that is, the remaining amount of lithium that can be inserted into and extracted from a positive electrode active material is represented by x in a compositional formula, e.g., LiₓCoO₂. In the case of a positive electrode active material in a secondary battery, x can be represented by (theoretical capacity−charge capacity)/theoretical capacity. For example, when a secondary battery using LiCoO₂ as a positive electrode active material is charged to 219.2 mAh/g, the positive electrode active material can be represented by Li_{0.2}CoO₂, i.e., x=0.2. Note that “x in LiₓCoO₂ is small” means, for example, 0.1<x≤0.24.

In the power storage system of one embodiment of the present invention, charge is performed so that x can be less than or equal to 0.2, less than or equal to 0.24, or less than or equal to 0.3.

Note that the theoretical capacity of a positive electrode active material refers to the quantity of electricity obtained when all lithium that can be inserted into and extracted from the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

Charge capacity and/or discharge capacity used for calculation of x in LiₓCoO₂ is preferably measured under the condition where there is no influence or small influence of a short circuit and/or decomposition of an electrolyte. For example, data of a secondary battery, containing a sudden change that seems to result from a short circuit should not be used for calculation of x.

In such a case, for example, charge is performed such that the upper limit voltage of charge, that is, the potential of the positive electrode, is preferably 4.8 V or lower, further preferably 4.75 V or lower, further preferably 4.7 V or lower, further preferably 4.65 V or lower with reference to the lithium potential (Li/Li⁺) at higher than or equal to 35° C. and lower than or equal to 55° C.

In such a case, charge is performed such that a charge rate (also referred to as C rate or capacity rate) is preferably 0.35 C or more, further preferably 0.45 C or more, further preferably 0.7 C or more, further preferably 0.9 C or more at higher than or equal to 40° C. and lower than or equal to 55° C., for example. Here, “C” represents a unit of a rate. In particular, charge is performed at the charge rate at a voltage at which the potential of the positive electrode can be 4.2 V or higher, 4.3 V or higher, or 4.4 V or higher with reference to the lithium potential (Li/Li⁺). Here, on the assumption that the quantity of electricity obtained when the total amount of the element A (the element A is lithium in the case of lithium cobalt oxide) included in the positive electrode active material is used in a charge reaction is 1, a charge rate of 1 C is a current density at which approximately 0.7 times the quantity of electricity is stored in one hour, for example.

Note that by setting the charge depth shallow, the lifetime of the secondary battery can be increased; however, when the charge depth is too low, the capacity of the secondary battery becomes small. Therefore, the charge depth is preferably for example, higher than or equal to 50%, further preferably higher than or equal to 60%, still further preferably higher than or equal to 70%, still further preferably higher than or equal to 73%. The charge depth may be higher than 75%.

Here, SOC refers to a value normalized with the capacity per weight of the positive electrode active material, and a state where all of lithium contained in the positive electrode active material is extracted is regarded as SOC=100%.

Note that the calculation method of SOC in the secondary battery is not limited to the above example. For example, charge corresponding to a rated capacity of the secondary battery may be regarded as SOC=100%. The capacity normalization used in SOC is not limited to the above example. The volume of the secondary battery, the internal volume of the secondary battery, the volume of part of the secondary battery, the weight of the secondary battery, the weight of a content of the secondary battery, the weight of part of the secondary battery, or the like may be used for normalization.

In the charging unit of one embodiment of the present invention, an extremum resulting from a change of the crystal structure of the positive electrode active material can be detected in a dQ/dV curve or the like, and constant current charge can be performed. In addition, constant current charge using the detection of the extremum is easy and good in controllability. Thus, with the use of the charging unit of one embodiment of the present invention, a secondary battery in which variation in charge capacity is small and deterioration due to charge at a high voltage is suppressed can be achieved.

Details of the secondary battery that can be used as the secondary battery 121 are described later.

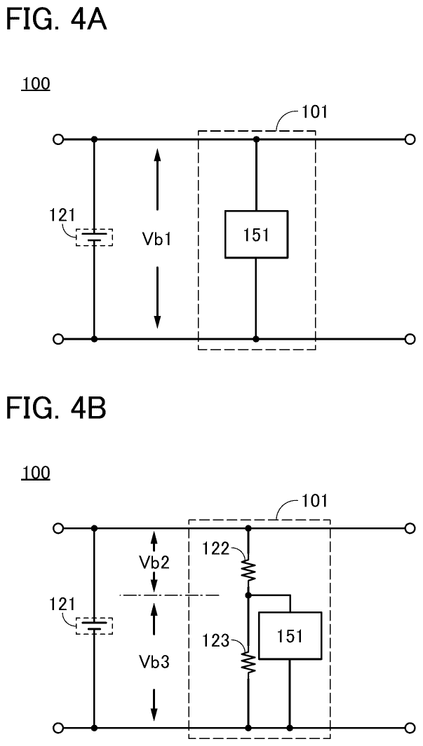

Note that the voltage measurement circuit 151 may measure a voltage Vb1 between the positive electrode and the negative electrode of the secondary battery as illustrated in FIG. 4A or may measure a voltage obtained by dividing the voltage Vb1 by resistors as illustrated in FIG. 4B. In this specification and the like, the voltage of the secondary battery refers to a voltage between the positive electrode and the negative electrode of the secondary battery, for example.

In FIG. 4B, the voltage Vb1 is divided into a voltage Vb2 and a voltage Vb3 by a resistor 122 and a resistor 123, and the voltage measurement circuit 151 measures the voltage Vb3.

In the case where the voltage measurement circuit 151 measures voltages obtained by resistor division of the voltage between the positive electrode and the negative electrode of the secondary battery, the voltage measurement circuit 151 or the control circuit 153 may estimate the voltage between the positive electrode and the negative electrode of the secondary battery from the voltages obtained by resistor division.

Furthermore, the charging unit of one embodiment of the present invention preferably has a function of a coulomb counter. For example, the charging unit of one embodiment of the present invention has a function of calculating a charge capacity and a discharge capacity of a secondary battery by calculating the quantity of accumulated electric charges of the secondary battery 121 using the current measurement circuit 152 and the control circuit 153. The charging unit of one embodiment of the present invention may have a function of analyzing the charge depth (SOC: State of Charge) using the calculated charge capacity and discharge capacity.

### Example 1 of Charging Method

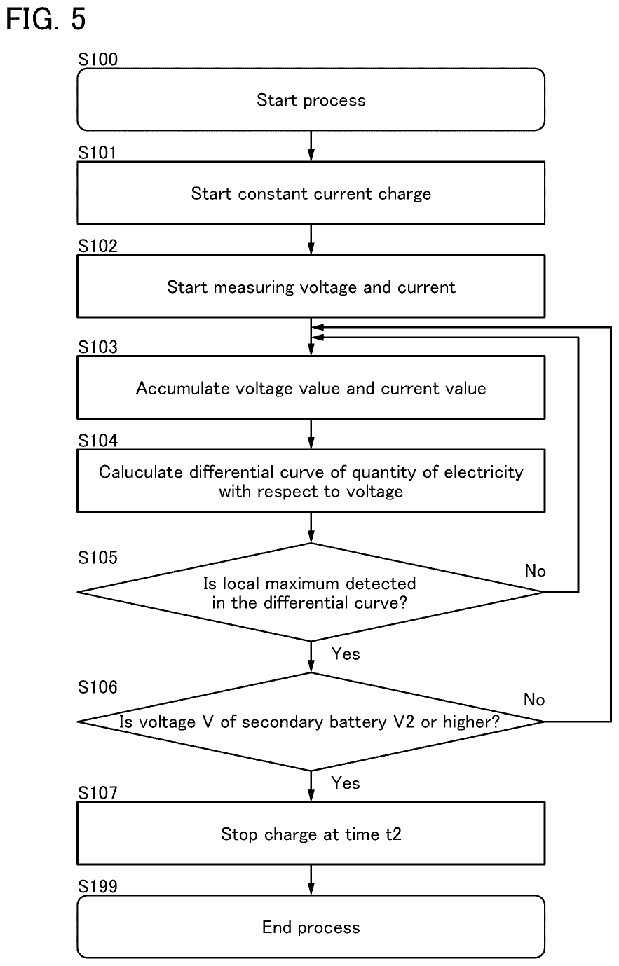

Next, an example of a charging method using the charging unit of one embodiment of the present invention is described with reference to a flowchart of FIG. 5.

First, a process starts in Step S100.

Next, in Step S101, constant current charge of a secondary battery is started at the time t1. Note that the constant current charge is continued until charge is stopped in Step S107.

Next, in Step S102, the voltage measurement circuit 151 starts measurement of a voltage of the secondary battery. In addition, the current measurement circuit 152 starts measurement of a current of the secondary battery. The voltage measurement circuit 151 supplies the measured voltage value to the control circuit 153. The current measurement circuit 152 supplies the measured current value to the control circuit 153.

Next, in Step S103, the control circuit 153 accumulates, as a set of data with time, the voltage value measured by the voltage measurement circuit 151 and the current value measured by the current measurement circuit 152 after Step S102. In the data accumulation, the memory circuit or the like included in the control circuit 153 can be used. As the time linked to the voltage value and the current value, an elapsed time from the start of charge may be used, for example.

Next, in Step S104, the control circuit 153 calculates a differential curve of quantity of electricity with respect to voltage (dQ/dV curve) of the secondary battery with use of the sets of data containing the voltage value, the current value, and time, which are accumulated at any time. Here, in Step S103, after a certain period during which the sets of data containing the voltage value, the current value, and time are accumulated, the differential curve of quantity of electricity with respect to voltage of the secondary battery may be calculated. For example, the sets of data may be accumulated in a period which is sufficient for detection of the extremum.

Next, in Step S105, the control circuit 153 analyzes a curve with the horizontal axis of a voltage V and the vertical axis of a derivative of quantity of electricity Q with respect to voltage, dQ/dV (hereinafter, the curve is referred to as a dQ/dV−V curve) and performs determination. When an extremum (also referred to as a peak), for example, a local maximum (a peak with an upward projection) in this case, is detected in the dQ/dV−V curve, the process proceeds to Step S106. When it is not detected, the process returns to Step S103. Note that a plurality of extrema may be detected in the dQ/dV−V curve. In such a case, the highest extremum of the plurality of extrema is detected. Alternatively, r (r is an integer of 2 or more) higher extrema of the plurality of extrema are detected and any of the r extrema may be selected.

Here, the “higher extrema” refer to ones that are high in a rank determined under predetermined conditions. For example, the rank may be a descending order of the extrema.

The control circuit 153 preferably continue to accumulate the set of data containing the voltage value, the current value, and time, while the steps from Step S103 to Step S105 are repeated. In other words, when steps from Step S103 to Step S105 are repeated n times, the dQ/dV−V curve can be calculated with use of all the pieces of data of n repetitions. Alternatively, data of the latest time or data of the latest several times of the n times may be used.

Next, in Step S106, when the voltage V of the secondary battery is higher than or equal to a voltage V2, the process proceeds to Step S107. If the voltage V is lower than the voltage V2, the process returns to Step S103. Here, the voltage V2 is, for example, higher than or equal to 4.25 V, or higher than or equal to 4.25 and lower than 4.8 V.

Alternatively, determination in Step S006 may be performed on the basis of the charge depth of the secondary battery. For example, if the charge depth of the secondary battery is higher than or equal to 51%, the process proceeds to Step S007, and if it is lower than S1%, the process returns to Step S003. Here, S1 is higher than or equal to 60 [%], or higher than or equal to 60 [%] and lower than or equal to 95 [%].

The control circuit 153 can accumulate the sets of data containing the voltage value, the current value, and time continually, until the process proceeds to Step S107 from the initial Step S103 of the repeated Steps S103.

Next, in Step S107, a time tp showing an extremum is detected by analysis in the dQ/dV−V curve, and charge is stopped at time t2, at which a predetermined time is elapsed from the time tp. Here, the predetermined time is, for example, the time required for stopping the charge by the control circuit 153. Alternatively, the time t2 may be set in the following manner: in the dQ/dV−V curve, a region having a desired voltage width with a voltage giving the extremum as a center is determined and a time corresponding to the voltage at the top edge in the region is set as the time t2, for example. When the extremum is not detected in Step S107, the charge may be stopped when the charge voltage reaches a predetermined charge voltage.

Furthermore, as the conditions of stopping the charge in Step S107, the detection of the extremum is given here; alternatively, stopping the charge may be controlled on the basis of an elapsed time or the like from a detected inflection point, for example.

Smoothing of a curve to be analyzed may be performed. As the smoothing method, for example, a moving average may be used.

Here, the inflection point detected at the time tp is, for example, an inflection point that is ascribable to a change of a crystal structure in the positive electrode active material of the positive electrode of the secondary battery.

By using the positive electrode active material of one embodiment of the present invention as the positive electrode active material, the collapse of the crystal structure of the positive electrode active material due to the repeated charge and discharge can be inhibited when charge of the secondary battery is stopped at a time close to the time tp.

A specific example of the inflection points detected at the time tp can be an inflection point corresponding to a change of the crystal structure of the positive electrode active material from the O3 type crystal structure to the O3′ type crystal structure, with use of the positive electrode active material of one embodiment of the present invention. The positive electrode active material here is, for example, lithium cobalt oxide. The charge voltage or the charge depth at the time t2 is preferably lower than the charge voltage or shallower than the charge depth at which the crystal structure of the positive electrode active material changes to the H1-3 type crystal structure. The O3 type crystal structure, the O3′ type crystal structure, and the H1-3 type crystal structure will be described in detail later. Note that the change from the O3 type crystal structure to the O3′ type crystal structure is expressed as a phase change in some cases.

In the power storage system of one embodiment of the present invention, the crystal structure in the positive electrode active material of the secondary battery can be controlled to be the O3′ type crystal structure at the time t2, for example. Accordingly, the collapse of the crystal structure of the positive electrode active material in the secondary battery due to repeated charge and discharge can be inhibited.

Note that when the positive electrode in the charge state corresponding to the time t2 is analyzed by X-ray diffraction, the crystal structure to be determined is preferably expressed by the space group R-3m. Further preferably, the crystal structure to be determined is expressed by the space group R-3m and is indicated to be the O3′ type crystal structure.

For example, in the charge state corresponding to the time t2, in the case where the positive electrode that is obtained by disassembling the secondary battery charged by the power storage system of one embodiment of the present invention is evaluated by the X-ray diffraction, a spectrum corresponding to the space group R-3m is observed. For measurement conditions, a measurement method, and the like, description below can be referred to.

Furthermore, in the case where the positive electrode in the state before the charge of the secondary battery is also analyzed by the X-ray diffraction, the crystal structure to be determined is preferably expressed by the space group R-3m.

In the power storage system of one embodiment of the present invention, the crystal structure to be determined is expressed by the space group R-3m when the positive electrode is analyzed by the X-ray diffraction at the time t2 and before the charge, in which case a decrease in the discharge capacity of the secondary battery due to charge-discharge cycles can be little.

Here, a case is considered where the steps of Step S101 to Step S107 are performed s times. Note that s is an integer of 2 or more. In such a case, the time tp and the time t2 that are obtained on the basis of the extrema detected in Step S102 to Step S106 may be used in the next charge cycle. Specifically, the time tp and the time t2 obtained in a (s−1)th charge may be used as conditions of stopping charge in Step S107 of an s-th charge.

Next, in Step S199, the process ends.

The above description is an example in which the constant current charge is performed continuously in a period from the start of charge in Step S101 to the stop of the charge in Step S107. In this case, the current value in the constant current charge is set to be, for example, a constant current value in the period from the start of charge in Step S101 to the stop of the charge in Step S107. Alternatively, the current value in the constant current charge may be changed stepwisely in the period from the start of charge in Step S101 to the stop of the charge in Step S107. Specifically, for example, in the case where Step S103 to Step S105 are repeated n times, the current value may be changed after a certain number of times.

The charging unit of one embodiment of the present invention can analyze charge characteristics of the secondary battery in Step S103 to Step S106 and change the charge conditions of the secondary battery in Step S107 on the basis of the analysis result. Specifically, the charge of the secondary battery can be stopped, for example. The charging characteristics analyzed in Step S103 to Step S106 vary in accordance with the ambient temperature in charge and discharge of the secondary battery, deterioration of the secondary battery due to charge-discharge cycles, and the like. The charging unit of one embodiment of the present invention can inhibit the deterioration of the secondary battery by changing the charge conditions of the secondary battery, for example, a charge voltage or the like of the secondary battery, in accordance with the variation in charge characteristics.

Furthermore, the charging unit of one embodiment of the present invention enables the secondary battery to be charged to the utmost limit in a range where the deterioration of the secondary battery is inhibited, by analyzing the charge characteristics.

Alternatively, in Step S107, constant voltage charge may be performed after the time t4 at a voltage lower than the upper limit voltage of the constant current charge at the time t4.

### Example 2 of Charging Method

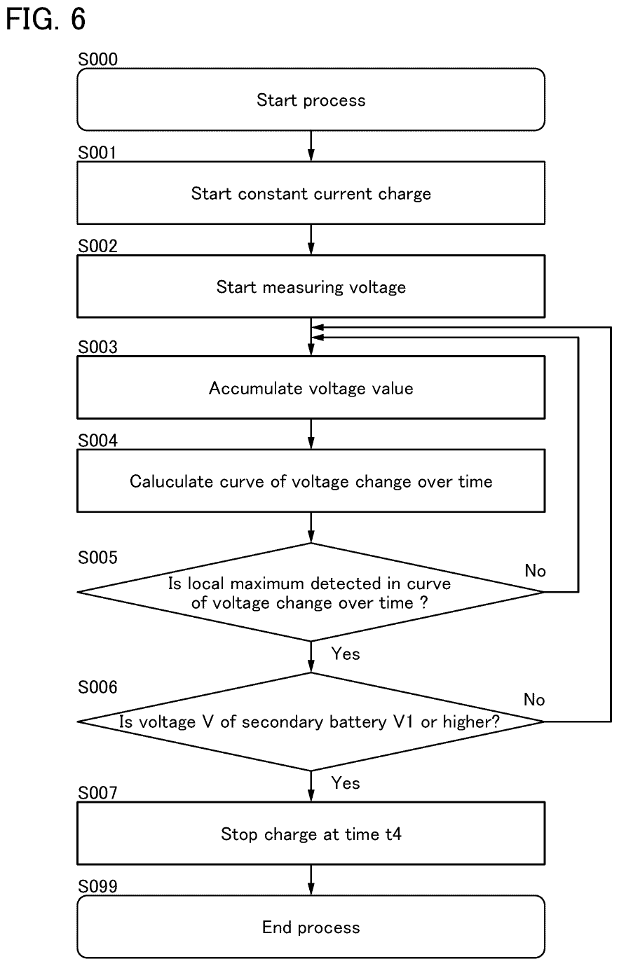

An example of a charging method using the charging unit of one embodiment of the present invention is described with reference to a flowchart of FIG. 6. In the charging method illustrated in FIG. 6, simple calculation by the control circuit 153 in a small circuit scale can be performed, as compared with in the charging method illustrated in FIG. 5, in some cases.

The dQ/dV can be expressed by the following formula.

dQ/dV=(dQ/dt)×(dt/dV)

In the constant current charge, dQ/dt is constant; thus, the dQ/dV is proportional to dt/dV. Thus, by evaluating the dt/dV characteristics in the constant current charge, information similar to the dQ/dV characteristics can be obtained.

An example of evaluating the dt/dV characteristics in the region where constant current charge is performed will be described below. In acquisition of the dt/dV characteristics, the current value of the secondary battery is not needed to be acquired every time, and the acquisition of the dt/dV characteristics can be performed more easily than that of dQ/dV in some cases. In addition, only two parameters of voltage and time are to be acquired, and thus calculation is simple and easy and the circuit scale can be reduced in some cases. The quantity of data to be acquired is small; thus the memory circuit scale can be reduced in some cases.

Furthermore, a change in the dQ/dV in the constant current charge is gentler than a change in the dQ/dV in the constant voltage charge in some cases.

In view of the above, even if the voltage resolution of a circuit that acquires dt/dV characteristics in the constant current charge or the like is 12 bits or lower, for example, in the power storage system of one embodiment of the present invention, adequate evaluation can be performed. In particular, in the secondary battery using the positive electrode active material of one embodiment of the present invention, an extremum can be observed stably in the dQ/dV curve in the constant current charge. Accordingly, charge can be controlled with high accuracy even in a simpler measurement system.

First, the process starts in Step S000.

Next, in Step S001, the constant current charge of the secondary battery is started at the time t3. Note that the constant current charge is continuously performed until the charge is stopped in Step S007.

Next, in Step S002, the voltage measurement circuit 151 starts measurement of a voltage of the secondary battery. The voltage measurement circuit 151 supplies the measured voltage value to the control circuit 153.

Next, in Step S003, the control circuit 153 accumulates, as a set of data with time, the voltage value measured by the voltage measurement circuit 151 after Step S002. In the data accumulation, the memory circuit or the like included in the control circuit 153 can be used. As the time linked to the voltage value, an elapsed time from the start of charge may be used, for example.

The obtained voltage value is converted from an analog value into a digital value in the control circuit 153. Alternatively, the control circuit 153 may use the obtained analog value in calculation without converting it into a digital value. Here is described an example in which an MCU is used as the control circuit 153, and an analog-digital conversion circuit incorporated in the MCU is used to convert the voltage value.

Here, an MCU incorporating an analog-digital conversion circuit having a 12-bit voltage resolution is used as an example.

When a change of a voltage value or an absolute value of the change of the voltage value becomes greater than or equal to a predetermined value, a set of data containing the voltage value and time is acquired and accumulated. The predetermined value can be, for example, the minimum value of the voltage resolution of the analog-digital conversion circuit or may be a value higher than or equal to the minimum value.

In the case where a change of a voltage value or an absolute value of the change of the voltage value is less than the predetermined value, a set of data containing the voltage value and time is acquired and accumulated when a predetermined time has passed since the previous acquisition of the set of data.

Next, in Step S004, the control circuit 153 calculates a voltage change over time of the secondary battery by using the sets of data containing the voltage value and time accumulated at any time. The voltage change over time can be expressed as a voltage [V(t)−V(t−Δt1)] using a voltage V(t) at the time t and a voltage V(t−Δt1) at the time (t−Δt1). The curve of a voltage change over time is referred to as a ΔV−t curve in some cases. In addition, for example, it is acceptable to use a derivative of voltage with respect to time (dV/dt) as the voltage change over time. Note that the calculation of the change over time is performed after the time t satisfies t=Δt1. Here, in Step S003, calculation of the change over time may be performed after the sets of data containing a voltage value and time are accumulated for a predetermined time. For example, the sets of data may be accumulated in a period that is sufficient for detection of an extremum.

Next, in Step S005, the control circuit 153 analyzes a curve of a voltage change over time of the secondary battery (e.g., ΔV−t curve) and performs determination. When the extremum, for example, the local minimum (a peak with a downward projection) in this case, is detected in the curve of a change over time, the process proceeds to Step S006. When it is not detected, the process returns to Step S003. Note that a plurality of extrema may be detected in the ΔV−t curve. In such a case, the highest extremum of the plurality of extrema is detected. Alternatively, r (r is an integer of 2 or more) higher extrema of the plurality of extrema are detected and any of the r values may be selected.

The control circuit 153 preferably continue to accumulate the sets of data containing the voltage value, the current value, and time, while the steps from Step S003 to Step S005 are repeated. In other words, when the steps from Step S003 to Step S005 are repeated n times, the curve of a change over time can be calculated with use of all the pieces of data of n repetitions. Alternatively, only data of the latest time or data of the latest several times of the n times may be used. Here, n is an integer of 1 or more.

Next, in Step S006, the control circuit 153 performs determination on the basis of the voltage of the secondary battery. If the voltage V of the secondary battery is higher than or equal to the voltage V1, the process proceeds to Step S007. When V is lower than the voltage V1, the process returns to Step S003. Here, the voltage V1 is, for example, higher than or equal to 4.25 V, or higher than or equal to 4.25 V and less than 4.8 V. Here, when the voltage measurement circuit 151 measures voltages obtained by dividing the voltage between the positive electrode and the negative electrode of the secondary battery with resistors, an estimated value of the voltage between the positive electrode and the negative electrode of the secondary battery, which is estimated from the voltages obtained by resistor division, is preferably used as the voltage V1.

Alternatively, determination in Step S006 may be performed on the basis of the charge depth of the secondary battery. For example, if the charge depth of the secondary battery is greater than or equal to 51%, the process proceeds to Step S007, and if it is less than S1%, the process returns to Step S003. Here, S1 is higher than or equal to 60 [%], or higher than or equal to 60 [%] and lower than or equal to 95 [%].

The control circuit 153 can accumulate the set of data containing the voltage value and time continually, until the process proceeds to Step S007 from the initial Step S003 of the repeated Steps S003.

Next, in Step S007, a time tq showing an extremum is detected by analysis in the ΔV−t curve, and charge is stopped at time t4, at which a predetermined time is elapsed from the time tq. Alternatively, the time t4 may be set in the following manner: in the ΔV−t curve, a region having a desired time width with the time showing the extremum as a center is determined and a time corresponding to the time at the top edge in the region is set as the time t4, for example. Here, the predetermined time is the time required for stopping of the charge by the control circuit 153. When the extremum is not detected in Step S007, the charge may be stopped when the charge voltage reaches a predetermined charge voltage.

Furthermore, as the conditions of stopping the charge in Step S007, the detection of the extremum is given here; alternatively, an inflection point is detected and stopping the charge may be controlled on the basis of an elapsed time or the like from the detected inflection point, for example.

Here, a case is considered where the steps from Step S001 to Step S007 are repeated w times. Note that w is an integer of 2 or more. In such a case, the time t3 and the time t4 that are obtained on the basis of the extrema detected in Step S002 to Step S006 may be used in the next charge cycle. Specifically, the time tq and the time t4 obtained in a (w−1)th charge may be used as conditions of stopping charge in Step S007 of a w-th charge.

In Step S099, the process ends.

The above description is an example in which the constant current charge is performed continuously in a period from the start of charge in Step S001 to the stop of the charge is stopped in Step S007. In this case, the current value in the constant current charge is set to, for example, a constant current value in the period from the start of charge in Step S001 to the stop of the charge in Step S007. Alternatively, the current value in the constant current charge may be changed stepwisely in the period from the start of charge in Step S001 to the stop of the charge in Step S007. Specifically, for example, in the case where Step S003 to Step S005 are repeated n times, the current value may be changed after a certain number of times.

### Example 3 of Charging Method

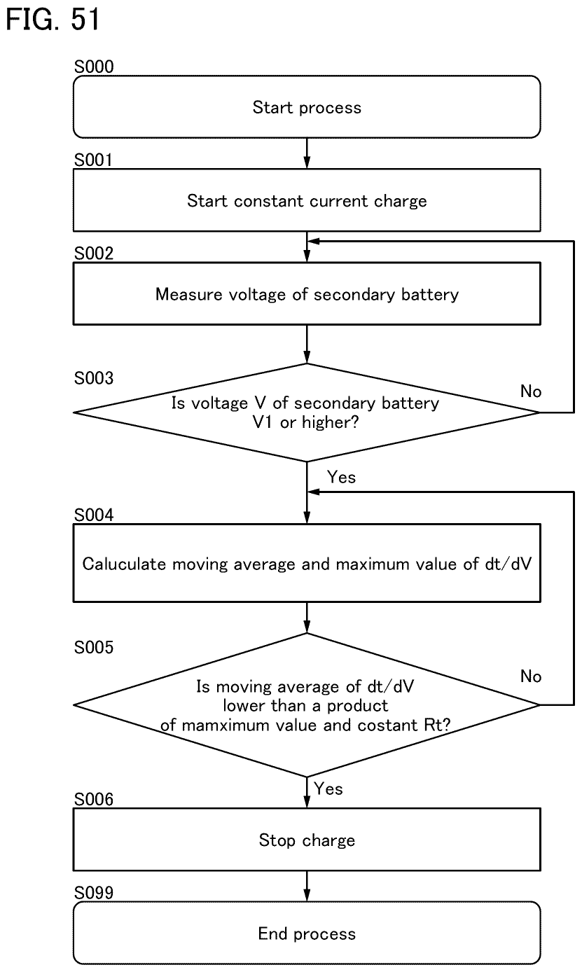

An example of a charging method using the charging unit of one embodiment of the present invention is described with reference to a flowchart of FIG. 51.

First, the process starts in Step S000.

Next, in Step S001, the constant current charge of the secondary battery is started. Note that the constant current charge is continuously performed until the charge is stopped in Step S006.

Next, in Step S002, the voltage measurement circuit 151 starts measurement of a voltage of the secondary battery. The measured voltage V is supplied from the voltage measurement circuit 151 to the control circuit 153.

Next, in Step S003, the control circuit 153 compares the measured voltage V and the predetermined voltage V1. If the voltage V is higher than or equal to the voltage V1, the process proceeds to Step S004, or when the voltage V is lower than the voltage V1, the process returns to Step S002.

In Step S004, the control circuit 153 conducts evaluation of dQ/dV. Here, since charge current is constant, a value dt/dV is measured. The value of dt/dV can be accumulated at any time in a charge process. With use of the accumulated sets of data containing the voltage V and the time t, the moving average of dt/dV, [dt/dV]mean, and the maximum value of dt/dV, [dt/dV]max, are calculated.

Note that as a value corresponding to the dt/dV, for example, a time required for a change of a voltage by a predetermined value may be calculated. The predetermined value may be, for example, greater than or equal to 0.5 mV and less than or equal to 10 mV.

Next, in Step S005, the moving average [dt/dV]mean is compared with a value obtained by multiplying the maximum value [dt/dV]max by a constant Rt. When the moving average [dt/dV]mean is less than the value obtained by multiplying the maximum value [dt/dV]max by the constant Rt, the process proceeds to Step S006. When the moving average [dt/dV]mean is greater than or equal to the value obtained by multiplying the maximum value [dt/dV]max by the constant Rt, the process returns to Step S004.

The time at which the moving average [dt/dV]mean is less than the value obtained by multiplying the maximum value [dt/dV]max by the constant Rt corresponds to, for example, a time at which dt/dV decreases from the local maximum value in the vicinity of the voltage V1 to (Rt×100) [%] of the local maximum value in the dt/dV curve. Here, Rt is greater than or equal to 0.6 and less than or equal to 0.9, for example. By setting Rt within the range of 0.6 to 0.9, a small decrease due to measurement noise and the extremum of the dt/dV curve (or the dQ/dV curve) can be differentiated, leading to the improvement of measurement accuracy. Furthermore, by setting Rt within the range of 0.6 to 0.9, a change of the crystal structure of the positive electrode active material can be detected and the change of the crystal structure of the positive electrode active material in a charged state can be in a range where the change is substantially reversible.

In Step S006, the charge of the secondary battery is stopped.

In Step S099, the process ends.

The example of the constant current charge is illustrated in the flowchart of FIG. 51. However, in the case where the charge current is not constant, for example, the average value in the measurement time of the quantity of electricity Q and the time in the vicinity thereof may be compared with a value obtained by multiplying the maximum value of the quantity of electricity Q by a constant, instead of the comparison between the moving average of dt/dV, [dt/dV]mean and the value obtained by multiplying the maximum value [dt/dV]max by the constant Rt.

### <Estimation of SOH>

The charging unit of one embodiment of the present invention preferably has a function of estimating SOH (State Of Health) of a secondary battery. SOH is an index to express a full chargeable capacity at a certain point in time with reference to a full chargeable capacity of a new product. SOH is a numerical value that becomes less than 100 as a secondary battery deteriorates, when the full chargeable capacity of a new secondary battery is 100, and the unit is “%”.

As for the extremum of the dQ/dV−V curve analyzed in the above example, the intensity (e.g., the height of a peak with an upward projection) of the extremum may decrease in some cases. The intensity may decrease because a phase change corresponding to the extremum is unlikely to occur in the positive electrode active material, and the decrease of the intensity may have a correlation with SOH, for example.

The charging unit of one embodiment of the present invention preferably has a function of observing the intensity of the extremum included in the dQ/dV−V curve and estimating SOH.

As for the extremum of the dQ/dV−V curve analyzed in the above example, the voltage serving as the extremum may sometimes have a correlation with a fully-discharged capacity (a dischargeable capacity of a secondary battery) after the charge is performed. The charging unit of one embodiment of the present invention preferably has a function of observing the intensity of the extremum included in the dQ/dV−V curve and estimating the dischargeable capacity of the secondary battery.

<Charge Control with Temperature>

The charging unit 101 preferably controls charge with use of temperature.

The control circuit 153 preferably changes charge conditions in accordance with the ambient temperature of the secondary battery measured by the temperature sensor TS.

The memory circuit included in the control circuit 153 preferably has a table in which the ambient temperature and charge conditions of the secondary battery are linked, for example.

In the memory circuit included in the control circuit 153, charge characteristics linked to the ambient temperature of the secondary battery are preferably stored. The charge characteristics may be a past measured value of the secondary battery 121, a measured value of another secondary battery with similar characteristics, or a waveform obtained by calculation. In the flowcharts of FIG. 5 and FIG. 6, the extremum (peak) may be estimated by using such measurement values. Machine learning or the like can be used for the estimation, for example.

The control circuit 153 may use the charge characteristics of the secondary battery, which are stored in the memory circuit, for the analysis of the extrema in the differential curves of voltage and quantity of electricity. Here, for example, a capacity-voltage curve, a voltage-dQ/dV curve, a ΔV−t curve, impedance characteristics, or the like can be used as the charge characteristics.

### Example 2 of Power Storage System

FIG. 1B illustrates an example in which the charging unit 101 includes the detection circuit 185 having a function of detecting overcharge and overdischarge, the detection circuit 186 having a function of detecting charge overcurrent or discharge overcurrent, the short-circuit detection circuit SD, the micro-short-circuit detection circuit MSD, the transistor 140, and the transistor 150 in addition to the structure illustrated in FIG. 1A.

The charging unit 101 in FIG. 1B has a function of inhibiting overcharge, overdischarge, charge overcurrent, discharge overcurrent, a short circuit, a micro-short circuit, and the like and can function as a protection circuit of the secondary battery. A micro-short circuit here refers to a minute short circuit caused in a secondary battery. A micro-short circuit refers to not a state where the positive electrode and the negative electrode of a secondary battery are short-circuited so that charge and discharge are impossible, but a phenomenon in which a slight short-circuit current flows through a minute short-circuit portion. A large voltage change may occur in a relatively short time and a small area in some cases.

Transistors called power MOSFETs can be used as the transistor 140 and the transistor 150, for example.

The control circuit 153 has a function of blocking current flowing to the secondary battery 121 by supplying signals to gates of the transistor 140 and the transistor 150.

The detection circuit 185 monitors the voltage of the secondary battery, and when the detection circuit 185 detects overcharge or overdischarge, the detection circuit 185 can supply a signal of detection to the control circuit 153. The control circuit receives the signal and can supply a signal to at least one of the gates of the transistor 140 and the transistor 150, so that current flowing to the secondary battery 121 can be blocked.

The detection circuit 186 monitors the current of the secondary battery 121, and when detecting an overcurrent in charging or discharging, the detection circuit 186 can supply a signal of detection to the control circuit 153. The control circuit receives the signal and can supply a signal to at least one of the gates of the transistor 140 and the transistor 150, so that current flowing to the secondary battery 121 can be blocked.

The overcharge detected in the detection circuit 185 may be detected by using an extremum of the charge voltage change curve over time (e.g., ΔV−t curve) or using an extremum of the differential curve of quantity of stored electricity with respect to voltage (dQ/dV curve) described above. Alternatively, the overcharge detected in the detection circuit 185 may be detected by comparison with a predetermined voltage value with use of a comparison circuit. The predetermined voltage value may be different depending on the ambient temperature of the secondary battery. The voltage value depending on the ambient temperature of the secondary battery is stored in the memory circuit included in the control circuit 153, for example.

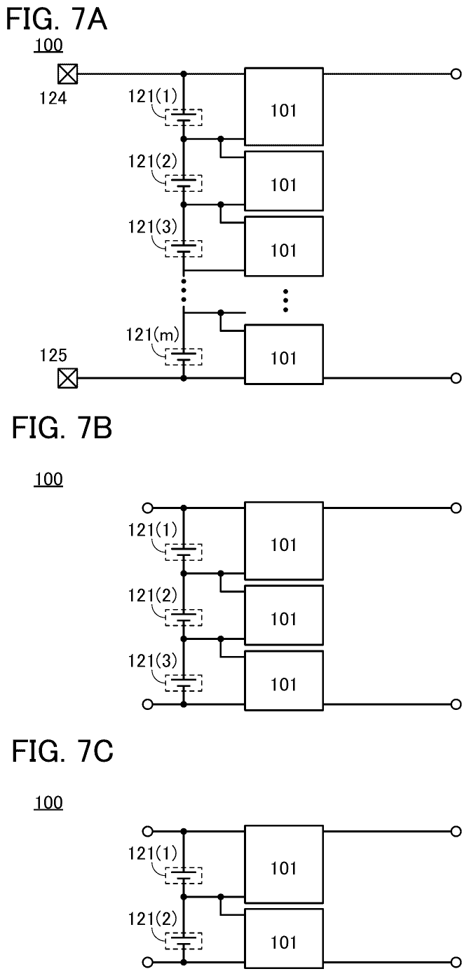

In examples of the power storage systems 100 in FIG. 7A, FIG. 7B, and FIG. 7C, m secondary batteries 121 that are connected in series are connected to the respective charging units 101. FIG. 7A illustrates an example of the power storage system 100 in the case where m is an integer of 4 or more, and a secondary battery 121(1), a secondary battery 121(2), a secondary battery 121(3), and a secondary battery 121(m) are illustrated as the first, the second, the third, and the m-th secondary batteries 121, respectively, of the m secondary batteries 121, and the other secondary batteries are not illustrated. FIG. 7B illustrates an example of the power storage system 100 in which m is 3, and FIG. 7C illustrates an example of the power storage system 100 in which m is 2.

Them charging units 101 may share a function. For example, the detection circuit 185 included in the charging unit 101 may detect overcharge at a voltage between a terminal 124 electrically connected to a positive electrode of the secondary battery 121(1) and a terminal 125 electrically connected to a negative electrode of the secondary battery 121(m). Moreover, for example, the detection circuit 186 and the short-circuit detection circuit SD included in the charging unit 101 may detect overcharge or a short circuit on the basis of a current between the terminal 124 and the terminal 125.

In addition, the power storage system 100 can independently control the m secondary batteries 121 (121(1) to 121(m)) with the charging units 101 connected to the respective secondary batteries. At this time, in the secondary battery 121 where charge is completed earlier among the m secondary batteries 121, a current is made to flow through a path that is connected in parallel to the secondary battery 121, for example, a transistor, a resistor, a diode, or the like connected in parallel to the secondary battery 121 after charge is completed, for example. Thus, the charging unit 101 preferably has a switch for switching of a current path between the secondary battery 121 and the path.

In addition, the power storage system 100 may control charge with use of the total of voltages of the m secondary batteries 121 that are connected in series (for example, in FIG. 7A, a voltage between the positive electrode of the secondary battery 121(1) and the negative electrode of the secondary battery 121(m). In such a case, it is possible to use an m-fold voltage value as the voltage used for the control of charge.

Note that this embodiment can be combined with any of the other embodiments in this specification as appropriate.

### Embodiment 2

In this embodiment, an example of a secondary battery of one embodiment of the present invention will be described.

A secondary battery of one embodiment of the present invention includes a positive electrode, a negative electrode, and an electrolytic.

### <Positive Electrode>

The positive electrode of one embodiment of the present invention contains a positive electrode active material.

### [Positive Electrode Active Material]

A compound containing the metal M (M is a metal, for example) is preferably used as the positive electrode active material. As the metal M, for example, a transition metal can be used. As the metal M, the positive electrode material may contain, an element with no valence change that can have the same valence as the metal M, specifically a trivalent main group element, for example. As the metal M, cobalt, nickel, manganese, iron, vanadium, chromium, niobium, aluminum, or the like can be used, for example. The positive electrode active material of one embodiment of the present invention preferably contains at least one of cobalt, nickel, and manganese, particularly cobalt, as the metal M. In addition to or instead of the metal M, sulfur may be used. As the compound, an oxide, a fluoride; a sulfide, a phosphate, a sulfate, a borate, a silicate, a fluorophosphate, a sulfate fluoride, or the like can be used, for example.

The positive electrode active material preferably includes the element A in addition to the above metal M. As the element A, one or more of alkaline metals such as lithium, sodium, and potassium and Group 2 elements such as calcium, beryllium, and magnesium can be used. The element A is preferably an element that functions as a carrier metal. In charge and discharge of the secondary battery of one embodiment of the present invention, extraction and insertion of the element A from and into the positive electrode active material are caused.

As the positive electrode active material, a layered rock-salt crystal structure can be used. For example, a composite oxide having a spinel crystal structure can be used as the positive electrode active material. As the positive electrode active material, a polyanionic positive electrode material can be used. Examples of the polyanionic positive electrode material are a material with an olivine crystal structure and a material with a NASICON structure.

The positive electrode active material of one embodiment of the present invention is represented by the chemical formula AM_{y}O_{Z} (y>0, z>0) in some cases. More specifically, for example, the positive electrode active material of one embodiment of the present invention is represented by the chemical formula AMO₂ in some cases. Although the positive electrode active material is represented by AMO₂, the composition of A:M:O is not limited to 1:1:2. For example, lithium cobalt oxide is represented by LiCoO₂ in some cases. As another example, lithium nickel oxide is represented by LiNiO₂ in some cases.

Furthermore, the positive electrode active material of one embodiment of the present invention preferably contains an element X. An element such as magnesium, calcium, barium, zirconium, lanthanum, titanium, yttrium, or the like can be used as the element X. An element such as nickel, aluminum, manganese, cobalt, vanadium, iron, chromium, or niobium can be used as the element X. An element such as potassium, sodium, copper, zinc, chlorine, fluorine, hafnium, silicon, sulfur, phosphorus, boron, or arsenic can be used as the element X. Two or more of the elements described above as the element X may be used in combination. For example, one or more of magnesium, calcium, and barium and one or more of nickel, aluminum, and manganese can be used as the element X.

Part of the element X substitutes for the element A site, for example, in some cases. Alternatively, part of the element X may substitute for the metal M site, for example, in some cases.

In the positive electrode active material of one embodiment of the present invention, the concentration of the element X in the surface portion is higher than that in the inner portion in some cases. In the positive electrode active material of one embodiment of the present invention, the element X may be uniformly dissolved in the whole positive electrode active material in some cases.

The positive electrode active material of one embodiment of the present invention may be represented by the chemical formula A_{1-w}X_{w}M_{y}O_{z} (y>0, z>0, and 0<w<1). The positive electrode active material of one embodiment of the present invention may be represented by the chemical formula AM_{y-j}XⱼO_{Z} (y>0, z>0, and 0<j<y). The positive electrode active material of one embodiment of the present invention may be represented by the chemical formula A_{1-w}X_{w}M_{y-j}XⱼO_{Z} (y>0, z>0, 0<w<1, and 0<j<y).

Furthermore, the positive electrode active material of one embodiment of the present invention preferably contains halogen. The positive electrode active material preferably contains halogen such as fluorine or chlorine. When the positive electrode active material of one embodiment of the present invention contains the halogen, substitution of the element X for the element A site is promoted in some cases.

### [Structure 1 of Positive Electrode Active Material]

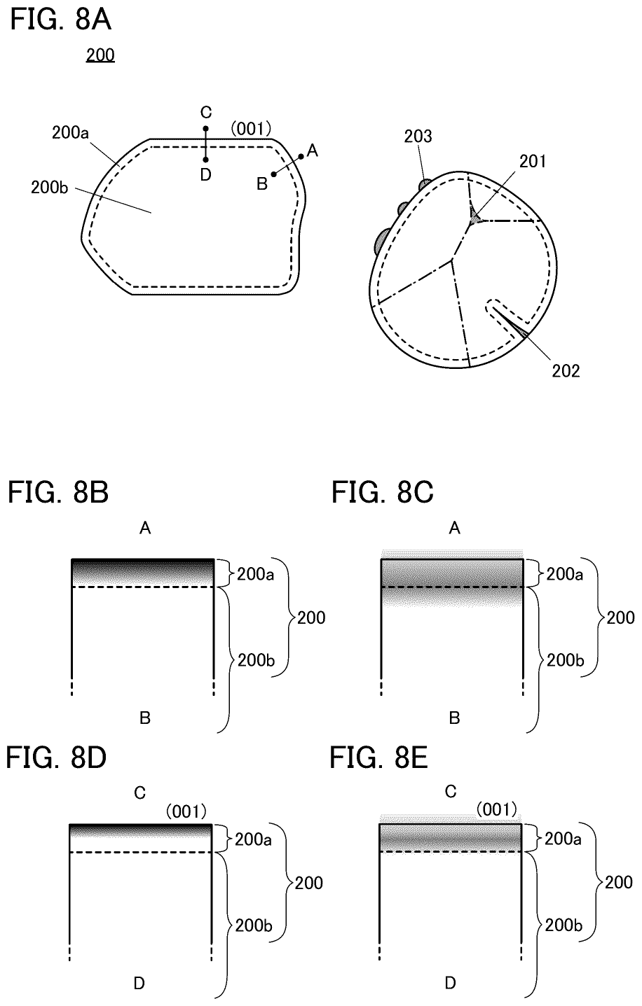

FIG. 8A is a cross-sectional view of a positive electrode active material 200 that can be used for a secondary battery of one embodiment of the present invention. FIG. 8B and FIG. 8C show enlarged views of a portion near the line A-B in FIG. 8A. FIG. 8C and FIG. 8D show enlarged views of a portion near the line C-D in FIG. 8A.

As illustrated in FIG. 8A to FIG. 8E, the positive electrode active material 200 includes a surface portion 200a and an inner portion 200b. In each drawing, the dashed line denotes a boundary between the surface portion 200a and the inner portion 200b. In FIG. 8A, the dashed-dotted line denotes part of a crystal grain boundary 201.

In this specification and the like, the surface portion 200a refers to a region ranging from the surface to 10 nm toward the inner portion of the positive electrode active material. A plane generated by a fissure and/or a crack can be considered as a surface. The surface portion 200a may also be referred to as the vicinity of a surface, a region in the vicinity of a surface, or the like. The inner portion 200b refers to a region deeper than the surface portion 200a of the positive electrode active material. The inner portion 200b may also be referred to as an inner region or the like.

The surface portion 200a preferably has a higher concentration of an additive element, which is described later, than the inner portion 200b. The additive element preferably has a concentration gradient. In the case where a plurality of kinds of additive elements are included, the additive elements preferably exhibit concentration peaks at different depths from a surface.

The concentration of the additive element in the surface portion 200a is preferably higher than the average concentration of the additive element in the whole particle.

The concentration of the additive element can be measured by XPS, ICP-MS, EDX area analysis, or the like.

For example, the additive element XT preferably has a concentration gradient as illustrated in FIG. 8B by gradation, in which the concentration increases from the inner portion 200b toward the surface. As examples of the additive element XT which preferably has such a concentration gradient, one or more of the above-described additive elements X can be used, and magnesium, fluorine, titanium, silicon, phosphorus, boron, calcium, and the like can be given as specific examples.

Another additive element X2 preferably has a concentration gradient as illustrated in FIG. 8C by gradation and exhibits a concentration peak at a deeper region than that illustrated in FIG. 8B. The concentration peak may be located in the surface portion 200a or located deeper than the surface portion 200a. The concentration peak is preferably located in a region other than an outermost surface layer. For example, the concentration peak is preferably located in a region ranging from the surface to a depth of from 5 nm to 30 nm, both inclusive, toward the inner portion. As the additive element X2 that preferably has such a concentration gradient, one or more of the above additive elements X can be used, and aluminum and manganese can be given as specific examples.

It is preferable that the crystal structure continuously change from the inner portion 200b toward the surface owing to the above-described concentration gradient of the additive element.

In order to prevent breakage of a layered structure formed of octahedrons of the transition metal M and oxygen even when lithium is extracted from the positive electrode active material 200 of one embodiment of the present invention owing to charge, the surface portion 200a having a high additive element concentration, i.e., the outer portion of the particle, is reinforced.

However, the additive elements do not necessarily have similar concentration gradients throughout the surface portion 200a of the positive electrode active material 200. For example, an example of distribution of the additive element XT near the line C-D in FIG. 8A is illustrated in FIG. 8D and an example of distribution of the additive element X2 near the line C-D in FIG. 8A is illustrated in FIG. 8E where one of the additive elements is denoted by XT and another of the additive elements is denoted by X2.

Here, the portion near the line C-D has a layered rock-salt crystal structure belonging to R-3m and the surface of the portion has a (001) orientation. The distribution of the additive element in the surface having a (001) orientation may be different from that at other surfaces. For example, at least one of the additive element X and the additive element X2 may be distributed shallower from the surface having a (001) orientation and the surface portion 200a thereof than from a surface having an orientation other than a (001) orientation. Alternatively, the surface having a (001) orientation and the surface portion 200a thereof may have a lower concentration of at least one of the additive element XT and the additive element X2 than a surface having an orientation other than a (001) orientation. Further alternatively, in the surface having a (001) orientation and the surface portion 200a thereof, the concentration of at least one of the additive element XT and the additive element X2 may be below the lower detection limit.

In a layered rock-salt crystal structure belonging to R-3m, cations are arranged parallel to the (001) plane. In other words, an MO₂ layer formed of octahedrons of the transition metal M and oxygen and a lithium layer are alternately stacked parallel to the (001) plane. Accordingly, a diffusion path of lithium ions also exists parallel to the (001) plane.

Since an MO₂ layer formed of octahedrons of the transition metal M and oxygen is relatively stable, the (001) plane having the MO₂ layer in the surface is relatively stable. A diffusion path of lithium ions is not exposed at the (001) plane.

By contrast, a diffusion path of lithium ions is exposed at a surface having an orientation other than a (001) orientation. Thus, the surface having an orientation other than a (001) orientation and the surface portion 200a thereof easily lose stability because they are regions where extraction of lithium ions starts as well as important regions for maintaining a diffusion path of lithium ions. It is thus extremely important to reinforce the surface having an orientation other than a (001) orientation and the surface portion 200a thereof so that the crystal structure of the whole positive electrode active material 200 is maintained.

Accordingly, in the positive electrode active material 200 of another embodiment of the present invention, it is important to distribute the additive element in the surface having an orientation other than a (001) orientation and the surface portion 200a thereof as illustrated in FIG. 8B and FIG. 8C. By contrast, in the surface having a (001) orientation and the surface portion 200a thereof, the peak position of the additive element may be shallow, the concentration of the additive element may be low as described above or the additive element may be absent.

Although described later, in the formation method in which high-purity LiMO₂ is formed, the additive element is mixed afterwards, and heating is performed, the additive element spreads mainly via a diffusion path of lithium ions and thus, distribution of the additive element in the surface having an orientation other than a (001) orientation and the surface portion 200a thereof can easily fall within a preferred range.

By the formation method in which high-purity LiMO₂ is formed, the additive element is then mixed, and heating is performed, the distribution of the additive element can be a favorable distribution in a surface having an orientation other than a (001) orientation and the surface portion 200a thereof as compared to the distribution of the additive element in a (001) plane. Moreover, in the formation method involving the initial heating, lithium atoms in the surface portion are expected to be extracted from LiMO₂ owing to the initial heating and thus, atoms of the additive element such as magnesium atoms can be probably distributed easily in the surface portion at a high concentration.

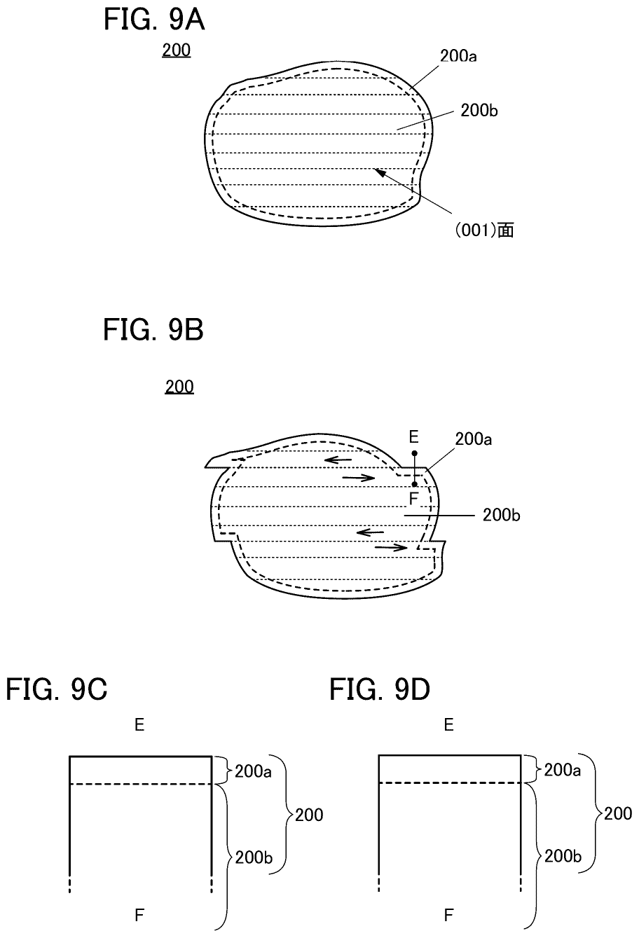

The positive electrode active material 200 preferably has a smooth surface with little unevenness; however, it is not necessary that the entire positive electrode active material 200 be in such a state. In a composite oxide with a layered rock-salt crystal structure belonging to R-3m, slipping easily occurs at a plane parallel to a (001) plane, e.g., lithium arrangement plane. In the case where a (001) plane is horizontal as illustrated in FIG. 9A, a pressing step or other steps sometimes causes slipping in a horizontal direction as denoted by arrows in FIG. 9B, resulting in deformation.

In this case, at a surface newly formed as a result of slipping and the surface portion 200a thereof, the additive element is not present or the concentration of the additive element is below the lower detection limit in some cases. The line E-F in FIG. 9B denotes sections of examples of the surface newly formed as a result of slipping and its surface portion 200a. FIG. 9C and FIG. 9D show enlarged views of the vicinity of the line E-F. In FIG. 9C and FIG. 9D, there exists neither gradation of the additive element X1 nor that of the additive element X2, which is different from FIG. 8B to FIG. 8E.

However, because slipping easily occurs parallel to a (001) plane, the newly formed surface and the surface portion 200a thereof have a (001) orientation. Since a diffusion path of lithium ions is not exposed at a (001) plane and the surface having a (001) plane is relatively stable, substantially no problem is caused even when the additive element is not present or the concentration of the additive element is below the lower detection limit.

Note that as described above, in a composite oxide whose composition is LiMO₂ and which has a layered rock-salt crystal structure belonging to R-3m, the transition metal M is arranged parallel to a (001) plane. In a HAADF-STEM image, the luminance of the transition metal M, which has the largest atom number in LiMO₂, is the highest. Thus, in a HAADF-STEM image, arrangement of atoms with a high luminance may be regarded as arrangement of atoms of the transition metal M. Repetition of such arrangement with a high luminance may be referred to as crystal fringes or lattice fringes. Such crystal fringes or lattice fringes may be deemed to be parallel to a (001) plane in the case of a layered rock-salt crystal structure belonging to R-3m.

The positive electrode active material 200 has a depression, a crack, a concave, a V-shaped cross section, or the like in some cases. These are examples of defects, and when charge and discharge are repeated, dissolution of the transition metal M, breakage of a crystal structure, cracking of the positive electrode active material 200, extraction of oxygen, or the like might be derived from these defects. However, when there is a filling portion 202 that fills such defects, dissolution of the transition metal M or the like can be inhibited. Thus, the positive electrode active material 200 can have high reliability and excellent cycle performance.

The positive electrode active material 200 may include a projection portion 203, which is a region where the additive element is unevenly distributed.

As described above, an excessive amount of the additive element in the positive electrode active material 200 might adversely affect insertion and extraction of lithium. The use of such a positive electrode active material 200 for a secondary battery might cause an increase of an internal resistance, a decrease of a charge-discharge capacity, and the like. Meanwhile, when the amount of the additive element is insufficient, the additive element is not distributed throughout the surface portion 200a, which might diminish the effect of inhibiting deterioration of a crystal structure. The additive element is required to be contained in the positive electrode active material 200 at an appropriate concentration; however, the adjustment of the concentration is not easy.

For this reason, in the positive electrode active material 200, when the region where the additive element is unevenly distributed is included, some excess atoms of the additive element are removed from the inner portion 200b, so that the additive element concentration can be appropriate in the inner portion 200b. This can inhibit the increase of the internal resistance, the decrease of the charge-discharge capacity, and the like when the positive electrode active material 200 is used for a secondary battery. A feature of inhibiting the increase of the internal resistance in a secondary battery is extremely preferable especially in charge and discharge at a high rate such as charge and discharge at 2 C or more.

In the positive electrode active material 200 including the region where the additive element is unevenly distributed, mixing of excess additive elements to some extent in the formation process is acceptable. This is preferable because the margin of production can be increased.

Note that in this specification and the like, uneven distribution means that the concentration of an element in a certain region differs from that in another region. It may be rephrased as segregation, precipitation, unevenness, deviation, a mixed area with a high concentration and a low concentration, or the like.

Magnesium, which is an example of the additive element X1, is divalent and is more stable in lithium sites than in transition metal sites in a layered rock-salt crystal structure; thus, magnesium is likely to enter the lithium sites. An appropriate concentration of magnesium at the lithium sites of the surface portion 200a facilitates maintenance of the layered rock-salt crystal structure. Magnesium can inhibit extraction of oxygen around magnesium when the charge depth is large. Magnesium is also expected to increase the density of the positive electrode active material. An appropriate magnesium concentration is preferable because an adverse effect on insertion and extraction of lithium in charging and discharging can be prevented. However, excess magnesium might adversely affect insertion and extraction of lithium. Thus, as will be described later, the concentration of the transition metal M is preferably higher than that of magnesium in the surface portion 200a, for example.

Aluminum, which is an example of the additive element X2, is trivalent and can be present at a transition metal site in a layered rock-salt crystal structure. Aluminum can inhibit dissolution of surrounding cobalt. The bonding strength of aluminum with oxygen is high, thereby inhibiting extraction of oxygen around aluminum. Hence, aluminum contained as the additive element enables the positive electrode active material 200 to have the crystal structure that is unlikely to be broken by repeated charge and discharge.

When fluorine, which is a monovalent anion, is substituted for part of oxygen in the surface portion 200a, the lithium extraction energy is lowered. This is because the change in valence of cobalt ions associated with lithium extraction is trivalent to tetravalent in the case of not containing fluorine and is divalent to trivalent in the case of containing fluorine, and the oxidation-reduction potential differs therebetween. It can thus be said that when fluorine is substituted for part of oxygen in the surface portion 200a of the positive electrode active material 200, lithium ions near fluorine are likely to be extracted and inserted smoothly. Thus, using such a positive electrode active material 200 in a secondary battery is preferable because the charge and discharge characteristics, rate performance, and the like are improved.

An oxide of titanium is known to have superhydrophilicity. Accordingly, the positive electrode active material 200 that includes titanium oxide in the surface portion 200a presumably has good wettability with respect to a high-polarity solvent. In a secondary battery formed using this positive electrode active material 200, the positive electrode active material 200 and a high-polarity electrolyte solution can have favorable contact at the interface therebetween, which may inhibit an internal resistance increase.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can reduce a charge-discharge capacity decrease due to repeated charge and discharge.

A short circuit of a secondary battery might cause not only a malfunction in charging operation and/or discharging operation of the secondary battery but also heat generation and ignition. In order to obtain a safe secondary battery, short-circuit current is preferably inhibited even at a high charge voltage. With the positive electrode active material 200 of one embodiment of the present invention, short-circuit current is inhibited even at a high charge voltage. Thus, a secondary battery with both high charge-discharge capacity and high safety can be obtained.

The concentration gradient of the additive element can be evaluated using energy dispersive X-ray spectroscopy (EDX), electron probe microanalysis (EPMA), or the like. In EDX measurement, measurement for two-dimensional evaluation of an area by area scan is referred to as EDX area analysis. The measurement by line scan, which is performed to evaluate the atomic concentration distribution in a positive electrode active material particle, is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 200a, the inner portion 200b, the vicinity of the crystal grain boundary 201, and the like of the positive electrode active material 200 can be quantitatively analyzed. By EDX line analysis, the concentration distribution and the highest value of the additive element can be analyzed. An analysis method using a thinned sample, such as STEM-EDX, is preferred because the method makes it possible to analyze the concentration distribution in the depth direction from the surface toward the center in a specific region of a particle regardless of the distribution in the front-back direction.

When the positive electrode active material 200 containing magnesium as the additive element is subjected to the EDX line analysis, a peak of the magnesium concentration in the surface portion 200a is preferably present in a region ranging from the surface to 3 nm in depth, further preferably 1 nm in depth, still further preferably 0.5 nm in depth toward the center of the positive electrode active material 200.

When the positive electrode active material 200 contains magnesium and fluorine as the additive elements, the distribution of fluorine preferably overlaps with the distribution of magnesium. Thus, in the EDX line analysis, a peak of the fluorine concentration in the surface portion 200a is preferably present in a region ranging from the surface to 3 nm in depth, further preferably 1 nm in depth, still further preferably 0.5 nm in depth toward the center of the positive electrode active material 200.

Note that the concentration distribution may differ between the additive elements. For example, in the case where the positive electrode active material 200 contains aluminum as the additive element, the distribution of aluminum is preferably slightly different from that of magnesium and that of fluorine as described above. For example, in the EDX line analysis, the peak of the magnesium concentration is preferably closer to the surface than the peak of the aluminum concentration is in the surface portion 200a. For example, the peak of the aluminum concentration is preferably present in a region that is greater than or equal to 0.5 nm and less than or equal to 50 nm in depth, further preferably greater than or equal to 5 nm and less than or equal to 30 nm in depth from the surface toward the center of the positive electrode active material 200. Alternatively, it is preferably present in a region that is greater than or equal to 0.5 nm and less than or equal to 30 nm. Further alternatively, it is preferably present in a region that is greater than or equal to 5 nm and less than or equal to 50 nm.

When the positive electrode active material 200 is subjected to line analysis or area analysis, the atomic ratio of an additive element I to the transition metal M (I/M) in the surface portion 200a is preferably greater than or equal to 0.05 and less than or equal to 1.00. When the additive element is titanium, the atomic ratio of titanium to the transition metal M (Ti/A) is preferably greater than or equal to 0.05 and less than or equal to 0.4, further preferably greater than or equal to 0.1 and less than or equal to 0.3. When the additive element is magnesium, the atomic ratio of magnesium to the transition metal M (Mg/M) is preferably greater than or equal to 0.4 and less than or equal to 1.5, further preferably greater than or equal to 0.45 and less than or equal to 1.00. When the additive element is fluorine, the atomic ratio of fluorine to the transition metal M (F/M) is preferably greater than or equal to 0.05 and less than or equal to 1.5, further preferably greater than or equal to 0.3 and less than or equal to 1.00.

According to results of the EDX line analysis, where a surface of the positive electrode active material 200 is can be estimated as follows.

A point where the detected amount of an element which uniformly exists in the inner portion 200b of the positive electrode active material 200, e.g., oxygen or the transition metal M such as cobalt, is ½ of the detected amount thereof in the inner portion 200b is assumed as the surface.

Since the positive electrode active material 200 is a composite oxide, the detected amount of oxygen is preferably used to estimate where the surface is. Specifically, an average value Oₐᵥₑ of the oxygen concentration of a region of the inner portion 200b where the detected amount of oxygen is stable is calculated first. At this time, in the case where oxygen O_{background} which is probably led from chemical adsorption or the background is detected in a region that is obviously outside the surface, O_{background} is subtracted from the measurement value to obtain the average value Oₐᵥₑ of the oxygen concentration. The measurement point where the measurement value which is closest to ½ of the average value Oₐᵥₑ, or ½Oₐᵥₑ, is obtained can be estimated to be the surface of the positive electrode active material.

Where the surface is can also be estimated with the use of the transition metal M contained in the positive electrode active material 200. For example, in the case where 95% or more of the transition metals M is cobalt, the detected amount of cobalt can be used to estimate where the surface is as in the above description. Alternatively, the sum of the detected amounts of the transition metals M can be used for the estimation in a similar manner. The detected amount of the transition metal M is unlikely to be affected by chemical adsorption and is thus suitable for the estimation of where the surface is.

When the positive electrode active material 200 is subjected to line analysis or area analysis, the atomic ratio of an additive element I to the transition metal M (I/M) is preferably greater than or equal to 0.020 and less than or equal to 0.50 in the vicinity of a grain boundary 201. It is further preferably greater than or equal to 0.025 and less than or equal to 0.30. It is still further preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. It is further preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

For example, when the additive element is magnesium and the transition metal M is cobalt, the atomic ratio of magnesium to cobalt (Mg/Co) is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. It is further preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

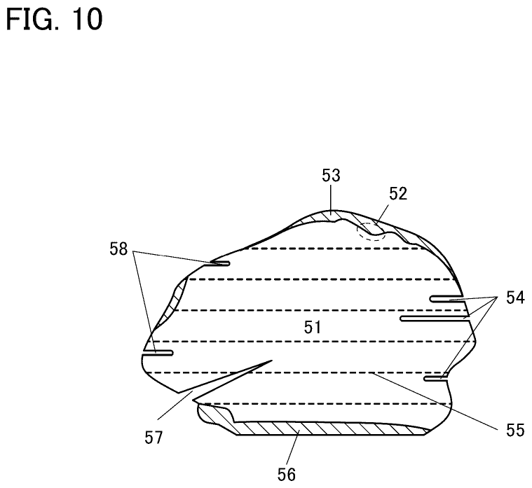

Note that when the positive electrode active material 200 undergoes charge and discharge under conditions with a large charge depth, including charge at 4.5 V or more, or at a high temperature (45° C. or higher), a progressive defect (also referred to as a pit) might be generated in the positive electrode active material. In addition, a defect such as a crevice (also referred to as a crack) might be generated by expansion and contraction of the positive electrode active material due to charge and discharge. FIG. 10 illustrates a schematic cross-sectional view of a positive electrode active material 51. Although pits in the positive electrode active material 51 are illustrated as holes of the pit 54 and the pit 58, their opening shape is not circular but a wide groove-like shape. A source of a pit can be a point defect. Presumably, the crystal structure of LiMO₂ in the vicinity of a portion where a pit is formed is broken and differs from a layered rock-salt crystal structure. The breakage of the crystal structure might inhibit diffusion and release of lithium ions that are carrier ions; thus, a pit is probably a cause of deterioration of cycle performance. A crack of the positive electrode active material 51 is denoted by a crack 57. A crystal plane parallel to arrangement of cations is represented by a crystal plane 55, a depression portion is represented by a depression portion 52, and regions where the additive element is present are represented by a region 53 and a region 56.

Typical positive electrode active materials of lithium ion secondary batteries are lithium cobalt oxide (LCO) and nickel-manganese-lithium cobalt oxide (NMC), which can also be regarded as a composite oxide containing a plurality of metal elements (cobalt, nickel, and the like). At least one of a plurality of positive electrode active material particles has a defect and the defect might change before and after charge and discharge. When used in a secondary battery, a positive electrode active material might undergo a phenomenon such as chemical or electrochemical erosion or degradation of a material due to environmental substances (e.g., electrolyte solution) surrounding the positive electrode active material. This degradation does not occur uniformly in the surface of the positive electrode active material but occurs locally in a concentrated manner, and a defect is formed deeply from the surface toward the inner portion, for example, by repeated charge and discharge of the secondary battery.

Progress of a defect in a positive electrode active material to form a hole can be referred to as pitting corrosion, and the hole generated by this phenomenon is also referred to as a pit in this specification.

In this specification, a crack and a pit are different from each other. Immediately after formation of a positive electrode active material, a crack can exist but a pit does not exist. A pit can also be regarded as a hole formed by extraction of some layers of cobalt and oxygen due to charge and discharge under conditions of a large charge depth in charging at, e.g., a high voltage of 4.5 V or higher or at a high temperature (45° C. or higher), i.e., a portion from which cobalt has been dissolved. A crack refers to a surface newly generated by application of physical pressure or a crevice generated owing to the crystal grain boundary 201. A crack might be caused by expansion and contraction of a positive electrode active material due to charge and discharge. Furthermore, a pit might be generated from a crack.

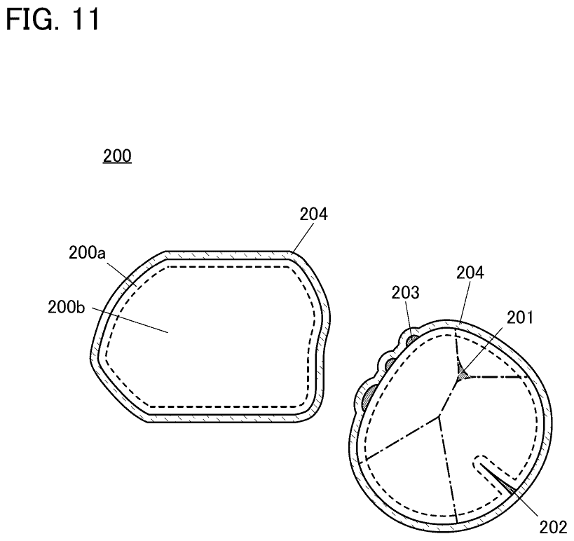

The positive electrode active material 200 may include a coating film in at least part of its surface. FIG. 11 illustrates an example of the positive electrode active material 200 including a coating film 204.

The coating film 204 is preferably formed by deposition of a decomposition product of an electrolyte solution due to charge and discharge, for example. A coating film originating from an electrolyte solution, which is formed on the surface of the positive electrode active material 200, is expected to improve charge-discharge cycle performance particularly when charge with a large charge depth is repeated. This is because an increase in impedance of the surface of the positive electrode active material is inhibited or dissolution of the transition metal M is inhibited, for example. The coating film 204 preferably contains carbon, oxygen, and fluorine, for example. The coating film can have high quality easily when part of the electrolyte solution includes LiBOB and/or suberonitrile (SUN), for example. Accordingly, the coating film 204 preferably contains at least one of boron, nitrogen, sulfur, and fluorine to possibly have high quality. The coating film 204 does not necessarily cover the positive electrode active material 200 entirely.

### [Relation Between Charge Condition and Positive Electrode Active Material]

Furthermore, charge and discharge of a secondary battery are performed repeatedly with the use of the power storage system of one embodiment of the present invention, in which case dissolution of the element X1 and the element X2 from the positive electrode active material due to the charge and discharge can be inhibited. Even when charge and discharge are performed repeatedly, the element X1 and the element X2 can remain in the positive electrode active material, and thus the power storage system of one embodiment of the present invention can have excellent cycle performance.

For example, when charge and discharge of the secondary battery including the positive electrode active material of one embodiment of the present invention are performed with the use of the power storage system of one embodiment of the present invention, the element X and the element X2 are preferably detected in the surface portion of the positive electrode active material after 30 to 100 charge-discharge cycles at higher than or equal to 40° C. and lower than or equal to 55° C. Moreover, after 30 to 100 charge-discharge cycles at higher than or equal to 40° C. and lower than or equal to 55° C., the concentrations of the element X1 and the element X2 in the surface portion of the positive electrode active material are preferably higher than those in the inner portion. In addition, after 30 to 100 charge-discharge cycles at higher than or equal to 40° C. and lower than or equal to 55° C., the atomic ratio of the additive element I to the transition metal M (I/M) in the surface portion is preferably greater than or equal to 0.03, further preferably greater than or equal to 0.05 and less than or equal to 1.00 in EDX line analysis or EDX area analysis of the positive electrode active material.

### [Structure 2 of Positive Electrode Active Material]

In the positive electrode active material having a layered rock-salt structure represented by the space group R-3m, an ion of the metal M (e.g., cobalt), the element X (e.g., magnesium), or the like sometimes occupies a site coordinated to six oxygen atoms in the case where the charge depth is 0.8 or more. This structure is thus referred to as the O3′ type crystal structure in this specification and the like. Note that in the O3′ type crystal structure, a light element such as lithium sometimes occupies a site coordinated to four oxygen atoms. The O3′ type crystal structure is a structure that can maintain high stability in spite of extraction of lithium or the like due to charge

The O3′ type crystal structure can be regarded as a crystal structure that contains Li between layers randomly and is similar to a CdCl₂ type crystal structure. The crystal structure similar to the CdCl₂ type crystal structure is close to a crystal structure of lithium nickel oxide that is charged to a charge depth of 94% (Li_{0.06}NiO₂).

Anions of a layered rock-salt crystal and anions of a rock-salt crystal form a cubic close-packed structure (face-centered cubic lattice structure). Anions of an O3′ crystal are presumed to form a cubic close-packed structure. When they are in contact with each other, there is a crystal plane at which orientations of cubic close-packed structures composed of anions are aligned. Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other.

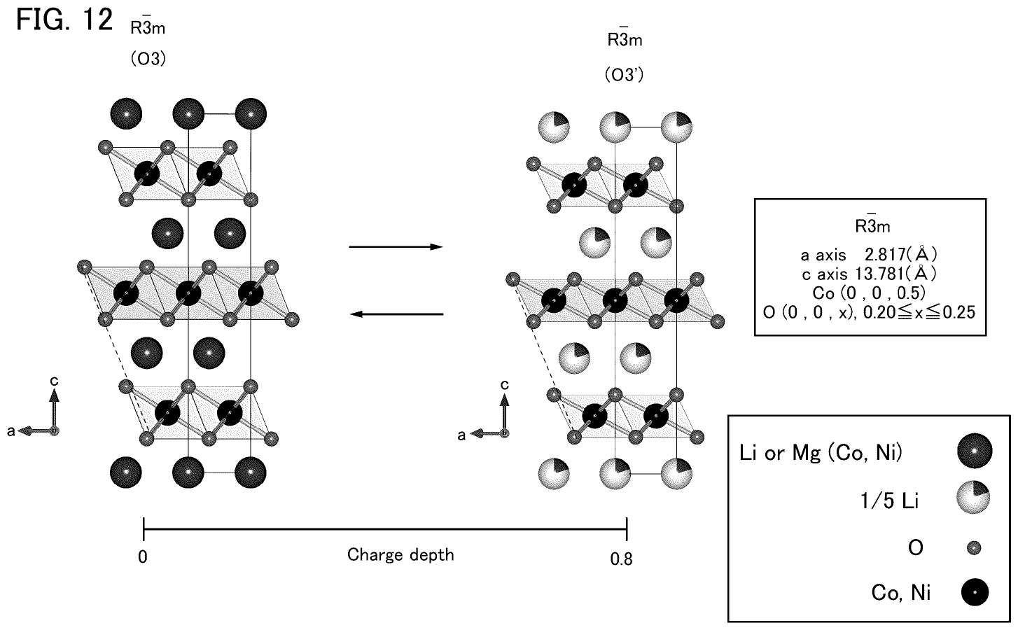

FIG. 12 illustrates an example of a crystal structure of lithium cobalt oxide containing magnesium. The crystal structure with a charge depth of 0 (in the discharged state) in FIG. 12 is R-3m (O3). In addition, the positive electrode active material illustrated in FIG. 12 with a charge depth in a sufficiently charged state includes O3′ type crystal structure. Note that although lithium is in any of lithium sites at an approximately 20% probability in the diagram of the O3′ type crystal structure illustrated in FIG. 12, the structure is not limited thereto. Lithium may be in only certain parts of the lithium sites. In both the O3 type crystal structure and the O3′ type crystal structure, a slight amount of the element X preferably exists between the CoO₂ layers, i.e., in lithium sites. In addition, a slight amount of halogen such as fluorine is preferably present at random in oxygen sites.

In the positive electrode active material illustrated in FIG. 12, a change in the crystal structure caused by extraction of a large amount of lithium during high-voltage charge is reduced. As denoted by the dotted lines in FIG. 12, for example, the CoO₂ layers hardly shift between the crystal structures.

More specifically, the structure of the positive electrode active material of one embodiment of the present invention is highly stable even when a charge voltage is high. For example, the positive electrode active material can maintain the crystal structure of R-3 m (O3) at a charge voltage of approximately 4.6 V with reference to the potential of lithium metal. Even at higher charge voltages, e.g., a voltage of approximately 4.65 V to 4.7 V with reference to the potential of a lithium metal, the positive electrode active material of one embodiment of the present invention can have the O3′ type crystal structure. At a charge voltage increased to be higher than 4.7 V, an H1-3 type crystal may be observed in the positive electrode active material of one embodiment of the present invention. In addition, the positive electrode active material of one embodiment of the present invention may have the O3′ type crystal structure even at a lower charge voltage (e.g., a charge voltage of greater than or equal to 4.5 V and less than 4.6 V with reference to the potential of a lithium metal) in some cases.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, even in a secondary battery which includes graphite as a negative electrode active material and which has a voltage of greater than or equal to 4.3 V and less than or equal to 4.5 V, for example, the positive electrode active material of one embodiment of the present invention can maintain the crystal structure belonging to R-3m (O3) and moreover, can have the O3′ type crystal structure at higher voltages, e.g., a voltage of the secondary battery of greater than 4.5 V and less than or equal to 4.6 V. In addition, the positive electrode active material of one embodiment of the present invention can have the O3′ type crystal structure at lower charge voltages, e.g., at a voltage of the secondary battery of greater than or equal to 4.2 V and less than 4.3 V, in some cases.

In the positive electrode active material of one embodiment of the present invention, a difference in the volume per unit cell between the O3 type crystal structure with a charge depth of 0 and the O3′ type crystal structure crystal structure with a charge depth of 80% is less than or equal to 2.5%, specifically, less than or equal to 2.2%. Note that in the unit cell of the O3′ type crystal structure, the coordinates of cobalt and oxygen can be represented by Co (0, 0, 0.5) and O (0, 0, x) within the range of 0.20×0.25.

In the unit cell, the lattice constant of the a-axis is preferably larger than 2.814×10⁻¹⁰ m and smaller than 2.817×10⁻¹⁰ m, and the lattice constant of the c-axis is preferably larger than 14.05×10⁻¹⁰ m and smaller than 14.07×10⁻¹⁰ m. In addition, the value obtained by dividing the lattice constant of the a-axis by the lattice constant of the c-axis (a-axis/c-axis) is preferably larger than 0.20000 and smaller than 0.20049.

The positive electrode active material whose crystal structure in a charged state is represented by the O3′ type crystal structure, has diffraction peaks at 2θ=19.35±0.10° and 20=45.55±0.20° in some cases when the positive electrode active material in the charge state is analyzed by powder X-ray analysis using CuKα1 radiation.

In the positive electrode active material shown in FIG. 12, the voltage lower than the voltage at which the H1-3 type crystal is observed is set to the upper limit voltage of charge, so that collapse of the crystal structure due to repeated charge and discharge can be inhibited. That is, the positive electrode active material preferably has the O3 type crystal structure or the O3′ type crystal structure at the time t2 in FIG. 5 or at the time t4 in FIG. 6.

The positive electrode active material of one embodiment of the present invention changes from the O3 type crystal structure into the O3′ type crystal structure described later. This change of the crystal structure is caused when the charge depth of the secondary battery is deep and is substantially reversible. The charging unit of one embodiment of the present invention has a function of detecting the change from the O3 type crystal structure into the O3′ type crystal structure and controlling charge. Furthermore, the change of the crystal structure is caused when the charge depth of the secondary battery is large and thus the charging unit of one embodiment of the present invention enables charge at a high capacity.

A slight amount of impurities such as magnesium randomly existing between the CoO₂ layers, i.e., in lithium sites can reduce a difference in the positions of the CoO₂ layers in high-voltage charging. Thus, magnesium between the CoO₂ layers makes it easier to obtain the O3′ type crystal structure.

Therefore, magnesium is preferably distributed throughout a particle of the positive electrode active material 200 of one embodiment of the present invention. To distribute magnesium throughout the particle, heat treatment is preferably performed in the formation process of the positive electrode active material 200 of one embodiment of the present invention.

However, heat treatment at an excessively high temperature may cause cation mixing, which increases the possibility of entry of an additive such as magnesium into the cobalt sites. Magnesium in the cobalt sites does not have the effect of maintaining the structure belonging to R-3m when the charge depth is large. Furthermore, heat treatment at an excessively high temperature might have an adverse effect; for example, cobalt might be reduced to have a valence of two or lithium might be evaporated.

In view of the above, a fluorine compound is preferably added to lithium cobalt oxide before the heat treatment for distributing magnesium throughout the particle. The addition of the fluorine compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 times and less than 0.04 times, still further preferably approximately 0.02 times the number of atoms of the transition metal M. Alternatively, it is preferably greater than or equal to 0.001 times and less than 0.04 times. Alternatively, the number of magnesium atoms is preferably greater than or equal to 0.01 times and less than or equal to 0.1 times. The magnesium concentration described here may be a value obtained by element analysis on the entire particles of the positive electrode active material by ICP-MS or the like, or may be a value based on the ratio of the raw materials mixed in the process of forming the positive electrode active material, for example.

Aluminum and the transition metal M typified by nickel are preferably present in cobalt sites, but part of them may be present in lithium sites. Magnesium is preferably present in lithium sites. Fluorine may be substituted for part of oxygen.

As the magnesium concentration in the positive electrode active material of one embodiment of the present invention increases, the charge-discharge capacity of the positive electrode active material decreases in some cases. As an example, one reason is that the amount of lithium that contributes to charge and discharge decreases when magnesium enters the lithium sites. Another possible reason is that excess magnesium generates a magnesium compound that does not contribute to charge and discharge. When the positive electrode active material of one embodiment of the present invention contains nickel in addition to magnesium, the charge-discharge capacity per weight and per volume can be increased in some cases. When the positive electrode active material of one embodiment of the present invention contains aluminum in addition to magnesium, the charge-discharge capacity per weight and per volume can be increased in some cases. When the positive electrode active material of one embodiment of the present invention contains nickel and aluminum in addition to magnesium, the charge-discharge capacity per weight and per volume can be increased in some cases.

The concentrations of the elements contained in the positive electrode active material of one embodiment of the present invention, such as magnesium, nickel, and aluminum are described below using the number of atoms.

The number of nickel atoms in the positive electrode active material 200 of one embodiment of the present invention is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The nickel concentration described here may be a value obtained by element analysis on the whole particles of the positive electrode active material by GD-MS, ICP-MS, or the like, or may be a value based on the ratio of the raw materials mixed in the process of forming the positive electrode active material, for example.

When divalent nickel exists in the inner portion 200b, a slight amount of the additive element having a valence of two and randomly existing in lithium sites, such as magnesium, might be able to exist more stably in the vicinity of the divalent nickel. Thus, even when charge and discharge with a large charge depth are performed, elution of magnesium might be inhibited. Accordingly, charge-discharge cycle performance might be improved. Such a combination of the effect of nickel in the inner portion 200b and the effect of magnesium, aluminum, titanium, fluorine, or the like in the surface portion 200a extremely effectively stabilizes the crystal structure when the charge depth is large.

The number of aluminum atoms in the positive electrode active material of one embodiment of the present invention is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The aluminum concentration described here may be a value obtained by element analysis on the whole particles of the positive electrode active material by GD-MS, ICP-MS, or the like, or may be a value based on the ratio of the raw materials mixed in the process of forming the positive electrode active material, for example.

It is preferable that the positive electrode active material of one embodiment of the present invention further contain phosphorus as the additive element. The positive electrode active material of one embodiment of the present invention further preferably includes a compound containing phosphorus and oxygen.

When the positive electrode active material of one embodiment of the present invention includes a compound containing phosphorus, a short circuit can be inhibited while a state with a large charge depth is maintained, in some cases.

When the positive electrode active material of one embodiment of the present invention contains phosphorus, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution can inhibit corrosion and/or peeling of the coating film 204 of a current collector in some cases. Furthermore, the decrease in hydrogen fluoride concentration in the electrolyte solution can inhibit a reduction in adhesion properties due to gelling and/or insolubilization of PVDF in some cases.

When containing phosphorus in addition to magnesium, the positive electrode active material of one embodiment of the present invention is extremely stable in a state with a large charge depth. When the positive electrode active material contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The phosphorus concentration and the magnesium concentration described here may each be a value obtained by element analysis on the whole particles of the positive electrode active material by ICP-MS or the like, or may be a value based on the ratio of the raw materials mixed in the process of forming the positive electrode active material, for example.

The positive electrode active material sometimes has a crack. When an inner portion of the positive electrode active material with a crack as a surface, e.g., the filling portion 202, includes phosphorus, more specifically, a compound containing phosphorus and oxygen or the like, crack development is inhibited in some cases.

### <<Surface Portion>>

It is preferable that magnesium be distributed throughout a particle of the positive electrode active material 200 of one embodiment of the present invention, and it is further preferable that the magnesium concentration in the surface portion 200a be higher than the average magnesium concentration in the whole particle. Alternatively, it is preferable that the magnesium concentration in the surface portion 200a be higher than that in the inner portion 200b.

In the case where the positive electrode active material 200 of one embodiment of the present invention contains the additive element, for example, one or more metals selected from aluminum, nickel, manganese, iron, and chromium, the concentration of the additive element in the surface portion 200a is preferably higher than the average concentration of the additive element in the whole particle. Alternatively, the concentration of the metal in the surface portion 200a is preferably higher than that in the inner portion 200b. It is preferable that some additive elements, in particular, magnesium, nickel, and aluminum have higher concentrations in the surface portion 200a than in the inner portion 200b and exist randomly also in the inner portion 200b to have low concentrations. When magnesium and aluminum exist in the lithium sites of the inner portion 200b at appropriate concentrations, an effect of facilitating maintenance of the layered rock-salt crystal structure can be obtained in a manner similar to the above. When nickel exists in the inner portion 200b at an appropriate concentration, a shift in the layered structure formed of octahedrons of the transition metal M and oxygen can be inhibited in a manner similar to the above. Also in the case where both magnesium and nickel are contained, a synergistic effect of suppressing dissolution of magnesium can be expected since divalent magnesium can be present more stably in the vicinity of divalent nickel.

The surface portion 200a is in a state where bonds are cut unlike the inner portion 200b whose crystal structure is maintained, and lithium is extracted from the surface in charging; thus, the lithium concentration in the surface portion 200a tends to be lower than that in the inner portion. Therefore, the surface portion 200a tends to be unstable and its crystal structure is likely to be broken. The higher the magnesium concentration in the surface portion 200a is, the more effectively the change in the crystal structure can be reduced. In addition, a high magnesium concentration in the surface portion 200a probably increases the corrosion resistance to hydrofluoric acid generated by the decomposition of the electrolyte solution.

The concentration of fluorine in the surface portion 200a of the positive electrode active material 200 of one embodiment of the present invention is preferably higher than the average concentration in the whole particle. Alternatively, the fluorine concentration in the surface portion 200a is preferably higher than that in the inner portion 200b. When fluorine is present in the surface portion 200a, which is in contact with the electrolyte solution, the corrosion resistance to hydrofluoric acid can be effectively increased.

As described above, the surface portion 200a of the positive electrode active material 200 of one embodiment of the present invention preferably has a composition different from that in the inner portion 200b, i.e., the concentrations of the additive elements such as magnesium and fluorine are preferably higher than those in the inner portion 200b. The surface portion 200a having such a composition preferably has a crystal structure stable at room temperature (25° C.). Accordingly, the surface portion 200a may have a crystal structure different from that of the inner portion 200b. For example, at least part of the surface portion 200a of the positive electrode active material 200 of one embodiment of the present invention may have a rock-salt crystal structure. When the surface portion 200a and the inner portion 200b have different crystal structures, the orientations of crystals in the surface portion 200a and the inner portion 200b are preferably substantially aligned with each other.

Anions of a layered rock-salt crystal and anions of a rock-salt crystal form a cubic close-packed structure (face-centered cubic lattice structure). Anions of an O3′ crystal are presumed to form a cubic close-packed structure.

The orientations of crystals in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, an electron diffraction pattern, and a FFT (Fast Fourier Transform) pattern of a TEM image, and the like. XRD (X-ray Diffraction), neutron diffraction, and the like can also be used for judging.

### <<Grain Boundary>>

It is further preferable that the additive element contained in the positive electrode active material 200 of one embodiment of the present invention have the above-described distribution and be partly unevenly distributed at the crystal grain boundary 201 and the vicinity thereof.

Specifically, the magnesium concentration at the crystal grain boundary 201 and the vicinity thereof in the positive electrode active material 200 is preferably higher than that in the other regions in the inner portion 200b. In addition, the fluorine concentration at the crystal grain boundary 201 and the vicinity thereof is preferably higher than that in the other regions in the inner portion 200b.

The crystal grain boundary 201 is a type of plane defect. Thus, the crystal grain boundary tends to be unstable and the crystal structure easily starts to change like the surface of the particle. Thus, the higher the magnesium concentration at the crystal grain boundary 201 and the vicinity thereof is, the more effectively the change in the crystal structure can be reduced.

When the magnesium concentration and the fluorine concentration are high at the crystal grain boundary and the vicinity thereof, the magnesium concentration and the fluorine concentration in the vicinity of a surface generated by a crack are also high even when the crack is generated along the crystal grain boundary 201 of a particle of the positive electrode active material 200 of one embodiment of the present invention. Thus, the positive electrode active material including a crack can also have an increased corrosion resistance to hydrofluoric acid.

Note that in this specification and the like, the vicinity of the crystal grain boundary 201 refers to a region of approximately 10 nm from the grain boundary. The crystal grain boundary refers to a plane where atomic arrangement is changed and which can be observed in an electron microscope image. Specifically, the crystal grain boundary refers to a portion where repetition of bright lines and dark lines is discontinuous in an electron microscope image, a portion containing a large number of crystal defects, a defect that can be observed in a cross-sectional STEM, or the like, i.e., a structure including another element between lattices, a cavity, or the like.

### <<Particle Diameter>>

When the particle diameter of the positive electrode active material 200 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, the median diameter (D₅₀) is preferably greater than or equal to 1 m and less than or equal to 100 m, further preferably greater than or equal to 2 m and less than or equal to 40 m, still further preferably greater than or equal to 5 m and less than or equal to 30 m. Alternatively, it is preferably greater than or equal to 1 m and less than or equal to 40 m. Alternatively, it is preferably greater than or equal to 1 m and less than or equal to 30 m. Alternatively, it is preferably greater than or equal to 2 m and less than or equal to 100 m. Alternatively, it is preferably greater than or equal to 2 m and less than or equal to 30 m. Alternatively, it is preferably greater than or equal to 5 m and less than or equal to 100 m. Alternatively, it is preferably greater than or equal to 5 m and less than or equal to 40 m.

### <Analysis Method>

Whether or not a given positive electrode active material is the positive electrode active material 200 of one embodiment of the present invention, which has the O3′ type crystal structure when the charge depth is large, can be determined by analyzing a positive electrode including the positive electrode active material with a large charge depth by XRD, electron diffraction, neutron diffraction, electron spin resonance (ESR), nuclear magnetic resonance (NMR), or the like. XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example.

As described above, the positive electrode active material 200 of one embodiment of the present invention features in a small change in the crystal structure between a state with a large charge depth and a discharged state. A material 50 wt % or more of which is occupied by the crystal structure with a large change between a state with a large charge depth and a discharged state is not preferable because the material cannot withstand charge and discharge with a large charge depth. It should be noted that the intended crystal structure is not obtained in some cases only by addition of the additive element. For example, in a state with a large charge depth, lithium cobalt oxide containing magnesium and fluorine has the O3′ type crystal structure in some cases, and has the H1-3 type structure at 50 wt % or more in other cases. In some cases, lithium cobalt oxide containing magnesium and fluorine may have the O3′ type crystal structure at almost 100 wt % at a predetermined voltage, and may have the H1-3 type structure generated at a voltage higher than the predetermined voltage. Thus, to determine whether or not a positive electrode active material is the positive electrode active material 200 of one embodiment of the present invention, the crystal structure should be analyzed by XRD or the like.

However, the crystal structure of a positive electrode active material in a state with a large charge depth or a discharged state may be changed with exposure to the air. For example, the O3′ type crystal structure changes into the H1-3 type structure in some cases. For that reason, all samples are preferably handled in an inert atmosphere such as an argon atmosphere.

### <<XRD>>

The apparatus and conditions adopted in the XRD measurement are not particularly limited. The measurement can be performed with the apparatus and conditions as described below, for example.
XRD apparatus: D8 ADVANCE produced by Bruker AXS
X-ray source: CuKα radiation
Output: 40 kV, 40 mA
Slit width: Div. Slit, 0.5°
Detector: LynxEye
Scanning method: 2θ/θ continuous scan
Measurement range (2θ): from 15° to 90°
Step width (2θ): 0.01°
Counting time: one second/step
Rotation of sample stage: 15 rpm

### <<XPS>>

A region that is approximately 2 nm to 8 nm (normally, less than or equal to 5 nm) in depth from a surface can be analyzed by X-ray photoelectron spectroscopy (XPS); thus, the concentrations of elements in approximately half the depth of the surface portion 200a can be quantitatively analyzed. The bonding states of the elements can be analyzed by narrow scanning. The bonding states of the elements can be analyzed by narrow scanning. The quantitative accuracy of XPS is about ±1 atomic % in many cases. The lower detection limit is approximately 1 atomic % but depends on the element.

When the positive electrode active material 200 of one embodiment of the present invention is subjected to XPS analysis, the number of atoms of the additive element is preferably greater than or equal to 1.6 times and less than or equal to 6.0 times, further preferably greater than or equal to 1.8 times and less than 4.0 times the number of atoms of the transition metal M. When the additive is magnesium and the transition metal M is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of halogen such as fluorine is preferably greater than or equal to 0.2 times and less than or equal to 6.0 times, further preferably greater than or equal to 1.2 times and less than or equal to 4.0 times the number of atoms of the transition metal M.

In the XPS analysis, monochromatic aluminum Kα radiation can be used as an X-ray source, for example. An extraction angle is, for example, 45°. For example, the measurement can be performed using the following apparatus and conditions.
Measurement device: Quantera II produced by PHI, Inc.
X-ray source: monochromatic Al Kα (1486.6 eV)
Detection area: 100 m φ
Detection depth: approximately 4 nm to 5 nm (extraction angle 45°)
Measurement spectrum: wide scan, narrow scan of each detected element

In addition, when the positive electrode active material 200 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 200 of one embodiment of the present invention containing fluorine is preferably in the bonding state other than lithium fluoride and magnesium fluoride.

Furthermore, when the positive electrode active material 200 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride (1305 eV) and is close to that of magnesium oxide. That is, the positive electrode active material 200 of one embodiment of the present invention containing magnesium is preferably in the bonding state other than magnesium fluoride.

The concentrations of the additive elements that preferably exist in the surface portion 200a in a large amount, such as magnesium and aluminum, measured by XPS or the like are preferably higher than the concentrations measured by ICP-MS (inductively coupled plasma mass spectrometry), GD-MS (glow discharge mass spectrometry), or the like.

When a cross section of the positive electrode active material 200 is exposed by processing and analyzed by TEM-EDX, the concentrations of magnesium and aluminum in the surface portion 200a are preferably higher than those in the inner portion 200b. For example, in the TEM-EDX analysis, the magnesium concentration preferably attenuates, at a depth of 1 nm from a point where the concentration reaches a peak, to less than or equal to 60% of the peak concentration. The magnesium concentration preferably attenuates, at a depth of 2 nm from the point where the concentration reaches the peak, to less than or equal to 30% of the peak concentration. A FIB (Focused Ion Beam) can be used for the processing, for example.

In the X-ray photoelectron spectroscopy (XPS) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals M, not be unevenly distributed in the surface portion 200a but be distributed throughout the particle of the positive electrode active material 200. Note that one embodiment of the present invention is not limited thereto in the case where the above-described region where the additive element is unevenly distributed exists.

### <<ESR>>

As described above, the positive electrode active material of one embodiment of the present invention preferably contains cobalt and nickel as the transition metal M and magnesium as the additive element. It is preferable that Ni³⁺ be substituted for part of Co³⁺ and Mg²⁺ be substituted for part of Li⁺ accordingly. Accompanying the substitution of Mg²⁺ for Li⁺, the Ni³⁺ might be reduced to be Ni²⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co₄₊.

Thus, the positive electrode active material of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably greater than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by an electron spin resonance (ESR) method, for example.

### <<EPMA>>

Quantitative analysis of elements can be conducted by electron probe microanalysis (EPMA). In area analysis, the distribution of each element can be analyzed.

In EPMA, a region from a surface to a depth of approximately 1 μm is analyzed. Thus, the concentration of each element is sometimes different from measurement results obtained by other analysis methods. For example, when surface analysis is performed on the positive electrode active material 200, the concentration of the additive existing in the surface portion might be lower than the concentration obtained in XPS. The concentration of the additive existing in the surface portion might be higher than the concentration obtained in ICP-MS or a value based on the ratio of the raw materials mixed in the process of forming the positive electrode active material.

EPMA area analysis of a cross section of the positive electrode active material 200 of one embodiment of the present invention preferably reveals a concentration gradient in which the concentration of the additive element increases from the inner portion toward the surface portion. Specifically, each of magnesium, fluorine, titanium, and silicon preferably has a concentration gradient in which the concentration increases from the inner portion toward the surface as shown in FIG. 8C1. The concentration of aluminum preferably has a peak in a region deeper than the region where the concentration of the above element has a peak, that is, in an inner region, as illustrated in FIG. 8C2. The aluminum concentration peak may be located in the surface portion or located deeper than the surface portion.

Note that the surface and the surface portion of the positive electrode active material of one embodiment of the present invention do not contain a carbonate, a hydroxy group, or the like which is chemically adsorbed after formation of the positive electrode active material. Furthermore, an electrolyte solution, a binder, a conductive material, and a compound originating from any of these that are attached to the surface of the positive electrode active material are not contained either. Thus, in quantitative analysis of the elements contained in the positive electrode active material, correction may be performed to exclude carbon, hydrogen, excess oxygen, excess fluorine, and the like that might be detected in surface analysis such as XPS and EPMA. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

### <<Surface Roughness and Specific Surface Area>>

The positive electrode active material 200 of one embodiment of the present invention preferably has a smooth surface with little unevenness. A smooth surface with little unevenness indicates favorable distribution of the additive element in the surface portion 200a.

A smooth surface with little unevenness can be recognized from, for example, a cross-sectional SEM image or a cross-sectional TEM image of the positive electrode active material 200 or the specific surface area of the positive electrode active material 200.

### [Forming Method of Positive Electrode Active Material]

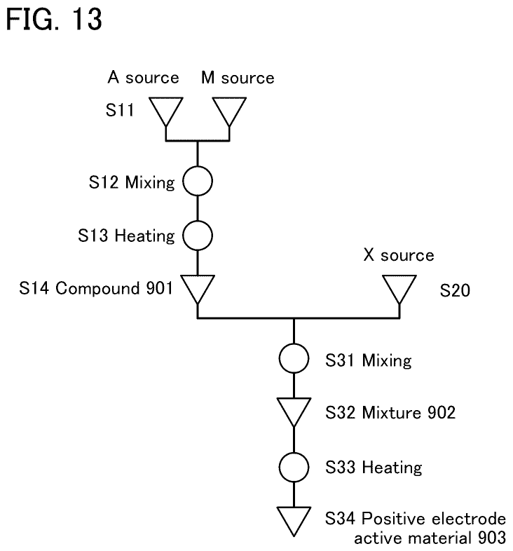

An example of a method for forming a compound including the element A, the metal M, and the element X, which is a positive electrode active material of one embodiment of the present invention, is described below. An example of the method for forming the compound will be described with reference to a flowchart in FIG. 13.

In Step S11 in FIG. 13, a material of the element A and a material of the metal M are prepared.

As an element A source (A source in FIG. 13), an oxide, a carbonate compound, a halogen compound, or the like containing the element A can be used. When the element A is lithium, lithium carbonate, lithium fluoride, or the like can be used.

As a metal M source (M source in FIG. 13), a compound or the like having the metal M can be used. In the case where the positive electrode active material is an oxide, an oxide, a hydroxide, or the like can be used as the M source, for example.

Next, in Step S12, the element A and the metal Mare mixed. Alternatively, grinding may be performed as well as mixing. The grinding and mixing can be performed by a dry method or a wet method.

Next, in Step S13, the materials mixed in the above step are heated.

Through the above steps, a compound 901 having the element A and the metal M can be formed (Step S14).

Here, lithium composite oxide represented by a chemical formula LiMO₂ can be obtained, in which lithium is used as the element A, an oxide or a hydroxide of the metal M is used as the metal M source, and the ratio of the lithium source to the metal M source is 1:1. The composite oxide may have a crystal structure of a lithium composite oxide represented by LiMO₂, but the composition is not strictly limited to Li:M:O=1:1:2.

Next, in Step S20, an element X source is prepared. As the element X source (X source in FIG. 13), a compound containing the element X can be used. Here, in the case where a plurality of elements are used as the element X, compounds containing the elements may be prepared. Alternatively, one compound containing the plurality of elements can be used. Note that when a halogen compound is used as the element X source, a positive electrode active material containing halogen can be obtained, for example.

The element X source may be ground. In the case where a plurality of compounds are used as the element X source, mixing is preferably performed.

Next, the compound 901 obtained in Step S14 and the element X source are mixed in Step S31.

Next, the materials mixed in the above step are collected, whereby a mixture 902 is obtained in Step S32.

Next, in Step S33, the mixture 902 is prepared. The heating temperature in Step S33 is preferably lower than the heating temperature in Step S13 in some cases.

Next, the heated material is collected, and a positive electrode active material 903 is obtained (Step S34).

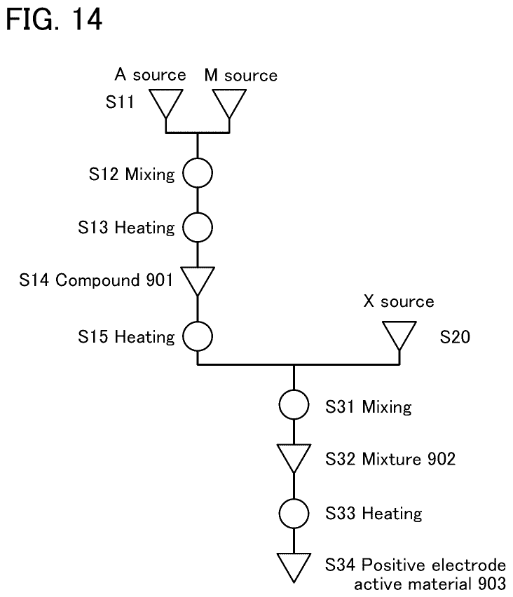

A flowchart in FIG. 14 is different from that in FIG. 13 in including Step S15 between Step S14 and Step S31.

In Step S15 in FIG. 14, the compound 901 that is obtained in Step S14 is heated. The heating in Step S15 is the first heating performed on the compound 901 and thus, the heating in Step S15 is sometimes referred to as the initial heating. Through the initial heating, the surface of the compound 901 becomes smooth. Having a smooth surface refers to a state where the compound 901 has little unevenness and is rounded as a whole and its corner portion is rounded. A smooth surface refers to a surface to which few foreign substances are attached. Foreign substances are deemed to cause unevenness and are preferably not attached to a surface.

The initial heating is heating performed after the compound 901 is obtained. The initial heating for making the surface smooth can reduce degradation after charge and discharge in some cases. The initial heating for making the surface smooth does not need a lithium compound source.

Alternatively, the initial heating for making the surface smooth does not need an additive element source.

Alternatively, the initial heating for making the surface smooth does not need a flux.

The initial heating is performed before Step S31 described below and is sometimes referred to as preheating or pretreatment.

At least one of the lithium source and the transition metal source prepared in Step S11 and the like might contain impurities. The initial heating can reduce impurities in the compound 901 obtained in Step 14.

The heating conditions in this step can be freely set as long as the heating makes the surface of the compound 901 smooth. For example, any of the heating conditions described for Step S13 can be selected. Additionally, the heating temperature in this step is preferably lower than that in Step S13 so that the crystal structure of the compound 901 is maintained. The heating time in this step is preferably shorter than that in Step S13 so that the crystal structure of the compound 901 is maintained. For example, the heating is preferably performed at a temperature of higher than or equal to 700° C. and lower than or equal to 1000° C. for longer than or equal to 2 hours.

The heating in Step S13 might cause a temperature difference between the surface and an inner portion of the compound 901. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the compound 901. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the compound 901 is relieved. This is probably why the surface of the compound 901 becomes smooth through Step S15. This is also rephrased as modification of the surface. In other words, it is deemed that Step S15 reduces the differential shrinkage caused in the compound 901 to make the surface of the compound 901 smooth.

Such differential shrinkage might cause a micro shift in the compound 901 such as a shift in a crystal. To reduce the shift, this step is preferably performed. Performing this step can distribute a shift uniformly in the compound 901. When the shift is distributed uniformly, the surface of the compound 901 might become smooth. This is also referred to as alignment of crystal grains. In other words, it is deemed that Step S15 reduces the shift in a crystal or the like which is caused in the compound 901 to make the surface of the compound 901 smooth.

In a secondary battery including the compound 901 with a smooth surface as a positive electrode active material, degradation by charge and discharge is suppressed and cracking in the positive electrode active material can be prevented.

It can be said that when surface unevenness information in one cross section of the compound 901 is quantified with measurement data, a smooth surface of the compound 901 has at least a surface roughness of less than or equal to 10 nm. The one cross section is, for example, a cross section obtained in observation using a scanning transmission electron microscope (STEM).

Note that a pre-synthesized compound 901 containing lithium, a transition metal, and oxygen may be used in Step S14. In this case, Steps S11 to S13 can be skipped. When Step S15 is performed on the pre-synthesized compound 901, the compound 901 with a smooth surface can be obtained.

The initial heating might decrease lithium in the compound 901. An additive element described for Step S20 or the like below can easily enter the compound 901 owing to the decrease in lithium.

### <Negative Electrode>

The negative electrode of one embodiment of the present invention contains a negative electrode active material.

As the negative electrode active material, it is preferable to use a material that can be reacted with a carrier ion of a secondary battery, a material into and from which a carrier ion can be inserted and extracted, a material capable of an alloying reaction with a metal that is to be a carrier ion, a material that can dissolve and precipitate a metal that is to be a carrier ion, or the like.

Carbon materials such as graphite, graphitizing carbon, non-graphitizing carbon, carbon nanotube, carbon black, and graphene can be used as the negative electrode active material, for example.

For example, a material containing one or more elements selected from silicon, tin, gallium, aluminum, germanium, lead, antimony, bismuth, silver, zinc, cadmium, indium, and the like can be used as the negative electrode active material.

An impurity element such as phosphorus, arsenic, boron, aluminum, or gallium may be added to silicon so that silicon is lowered in resistance.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain. The silicon oxide may be amorphous.

As a compound containing silicon, Li₂SiO₃ and Li₄SiO₄ can be used, for example. Each of Li₂SiO₃ and Li₄SiO₄ may have crystallinity or may be amorphous.

The analysis of the compound containing silicon can be performed by NMR, XRD, a Raman spectroscopy method, or the like.

Furthermore, an oxide containing one or more elements selected from titanium, niobium, tungsten, and molybdenum can be used as a material that can be used for the negative electrode active material, for example.

As the negative electrode active material, it is possible to use a combination of two or more of the aforementioned metals, materials, compounds, and the like.

The negative electrode active material of one embodiment of the present invention may contain fluorine in a surface portion. When the negative electrode active material contains halogen in its surface portion, a decrease in charge and discharge efficiency can be reduced. Moreover, it is considered that a reaction with an electrolyte at a surface of the active material is inhibited. In addition, at least part of the surface of the negative electrode active material of one embodiment of the present invention is covered with a region containing halogen in some cases. The region may have a film shape, for example. The halogen element is particularly preferably fluorine.

### <Electrolyte>

The electrolyte preferably contains a solvent and a metal salt serving as a carrier ion. As the solvent of the electrolyte, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are less likely to burn and volatize as the solvent of the electrolyte can prevent a secondary battery from exploding and igniting even when the secondary battery causes an internal short circuit or the temperature of the internal region increases owing to overcharging or the like. An ionic liquid contains a cation and an anion, specifically, an organic cation and an anion. Examples of the organic cation used for the electrolyte include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As a salt dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination at an appropriate ratio.

The electrolyte used for a secondary battery is preferably a highly purified electrolyte solution that contains few dust particles and elements other than the constituent elements of the electrolyte (hereinafter, also simply referred to as impurities). Specifically, the weight ratio of impurities to the electrolyte is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte. The concentration of the material to be added in the whole solvent is, for example, higher than or equal to 0.1 wt % and lower than or equal to 5 wt %. It is particularly preferable to use VC or LiBOB because it facilitates film formation.

A solution containing a solvent and a salt serving as a carrier ion is referred to as an electrolyte solution in some cases.

A polymer gel electrolyte obtained in a manner in which a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO), PVDF, polyacrylonitrile, and a copolymer containing any of them. For example, PVDF-HFP, which is a copolymer of PVDF and hexafluoropropylene (HFP), can be used. The formed polymer may be porous.

As the electrolyte, a solid electrolyte including an inorganic material can be used. For example, a sulfide-based solid electrolyte, an oxide-based solid electrolyte, a halide-based solid electrolyte, or the like can be used. Alternatively, a solid electrolyte containing a high-molecular material such as a PEO (polyethylene oxide)-based high-molecular material can be used. When the solid electrolyte is used, a separator and/or a spacer is/are not necessary. Furthermore, the battery can be entirely solidified; therefore, there is no possibility of liquid leakage and thus the safety of the battery is dramatically improved.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S™30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material having a perovskite crystal structure (e.g., La_{2/3-x}Li₃ₓTiO₃), a material having a NASICON crystal structure (e.g., Li₁₋ₓAlₓTi₂₋ₓ(PO₄)₃), a material having a garnet crystal structure (e.g., Li₇La₃Zr₂O₁₂), a material having a LISICON crystal structure (e.g., Li₁₄ZnGe₄O₁₆), LiZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can also be used as the solid electrolyte.

Alternatively, different solid electrolytes may be mixed and used.

In particular, Li₁₊ₓAlₓTi₂₋ₓ(PO₄)₃(0[x[1) having a NASICON crystal structure (hereinafter, LATP) is preferable because LATP contains aluminum and titanium, each of which is the element the positive electrode active material used in the secondary battery of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(AO₄)₃ (M: transition metal; A: S, P, As, Mo, W, or the like) and has a structure in which MO₆ octahedra and AO₄ tetrahedra that share common corners are arranged three-dimensionally.

### <Voltage of Secondary Battery>

When the secondary battery includes a compound represented by the chemical formula LiCoO₂ as a positive electrode active material, and graphite at 70 or higher percent by weight as a negative electrode active material, the upper limit voltage of charge of the secondary battery is preferably higher than 4.2 V, further preferably higher than 4.3 V. In addition, the upper limit voltage of charge of the secondary battery is 4.8 V or lower, 4.7 V or lower, or 4.65 V or lower, for example.

When the secondary battery includes a compound represented by the chemical formula LiMO₂ where 40 or higher mole percent of M is nickel, as a positive electrode active material, and graphite at 70 or higher percent by weight as a negative electrode active material, the upper limit voltage of the secondary battery is preferably 4.1 v or higher, further preferably 4.2 V or higher. In addition, the upper limit voltage of the secondary battery is 4.8 V or lower, 4.7 V or lower, or 4.65 V or lower, for example.

### <Capacity of Secondary Battery>

In charging with use of the charging unit of one embodiment of the present invention, the charge capacity is preferably higher than or equal to 200 mAh/g, further preferably higher than or equal to 210 mAh/g, still further preferably higher than or equal to 215 mAh/g (at 45° C., the charge rate of 0.5 C) per weight of the positive electrode active material.

Note that this embodiment can be combined with any of the other embodiments in this specification as appropriate.

### Embodiment 3

In this embodiment, a method for fabricating a secondary battery will be described.

### <Fabricating Method 1 of Laminated Secondary Battery>

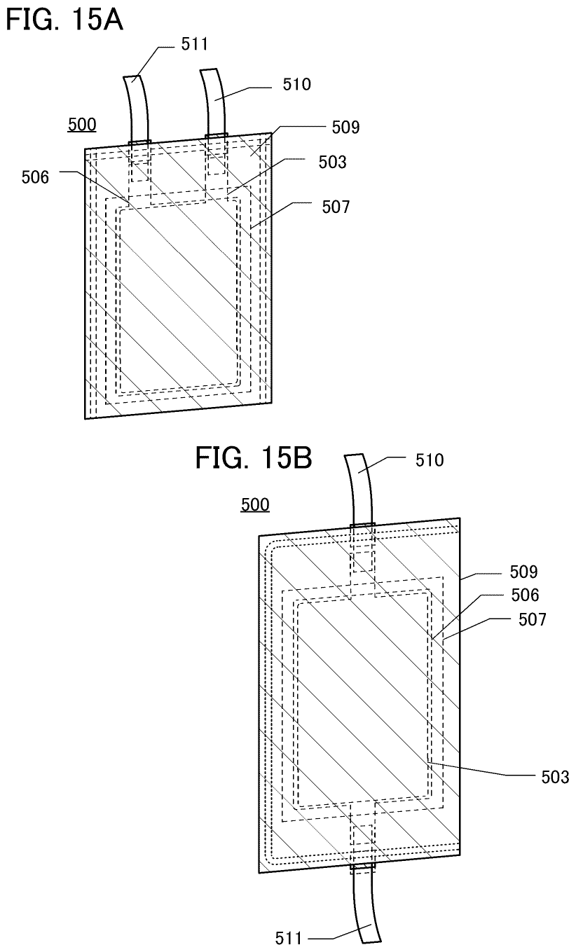

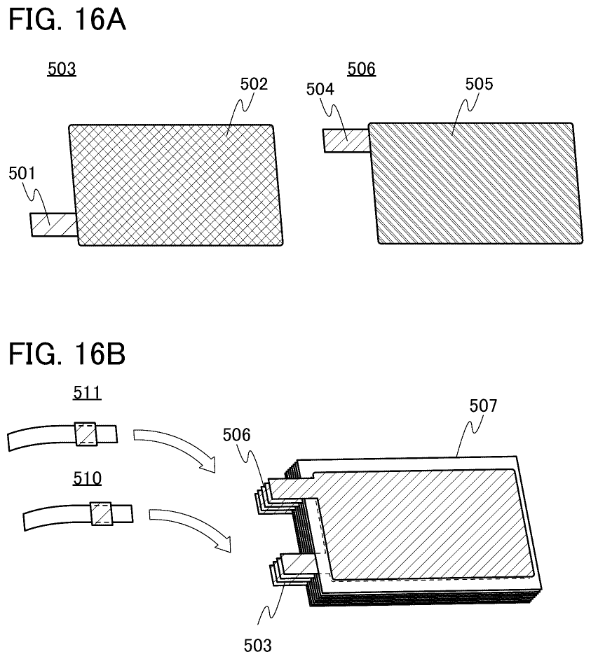

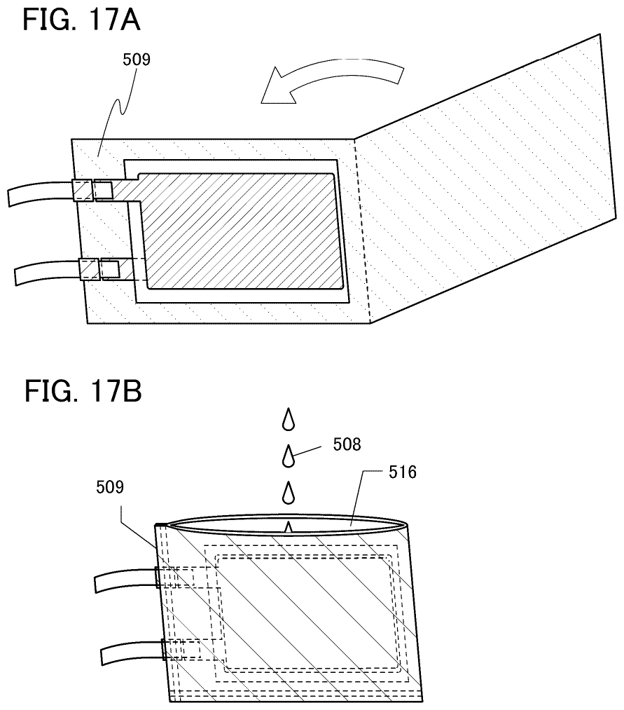

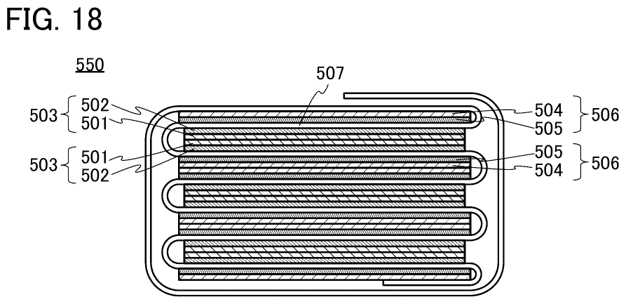

Here, an example of a method for fabricating laminated secondary batteries whose external views are shown in FIG. 15A and FIG. 15B will be described with reference to FIG. 16A and FIG. 16B and FIG. 17A and FIG. 17B. Secondary batteries 500 illustrated in FIG. 15A and FIG. 15B each include a positive electrode 503, a negative electrode 506, a separator 507, an exterior body 509, a positive electrode lead electrode 510, and a negative electrode lead electrode 511. Note that as a cross-sectional view of the laminated secondary battery illustrated in FIG. 15A or the like, for example, it is possible to employ a structure in which a stack including the positive electrodes, the separators, and the negative electrodes is surrounded by exterior bodies as illustrated in FIG. 18 described later.

First, the positive electrode 503, the negative electrode 506, and the separator 507 are prepared. FIG. 16A illustrated examples of the positive electrode 503 and the negative electrode 506. The positive electrode 503 includes a positive electrode active material layer 502 over a positive electrode current collector 501. The positive electrode 503 preferably includes a tab region where the positive electrode current collector 501 is exposed. The negative electrode 506 includes the negative electrode active material layer 505 over the negative electrode current collector 504. The negative electrode 506 preferably includes a tab region where the negative electrode current collector 504 is exposed.

Next, the negative electrode 506, the separator 507, and the positive electrode 503 are stacked. FIG. 16B illustrates the negative electrodes 506, the separators 507, and the positive electrodes 503 that are stacked. Here, an example in which five negative electrodes and four positive electrodes are used is shown. This can also be referred to as a stack including the negative electrodes, the separators, and the positive electrodes.

Then, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

Next, the negative electrodes 506, the separators 507, and the positive electrodes 503 are placed over the exterior body 509.

Subsequently, the exterior body 509 is folded along a portion shown by a dashed line as illustrated in FIG. 17A. Then, the outer edges of the exterior body 509 are bonded to each other. The bonding is performed by thermocompression bonding, for example. At this time, an unbonded region (hereinafter referred to as an inlet 516) is provided for part (or one side) of the exterior body 509 so that an electrolyte 508 can be introduced later.

Next, as illustrated in FIG. 17B, the electrolyte 508 is introduced into the exterior body 509 from the inlet 516 of the exterior body 509. The electrolyte 508 is preferably introduced in a reduced-pressure atmosphere or in an inert atmosphere. Lastly, the inlet 516 is bonded. In the above manner, the laminated secondary battery 500 can be fabricated.

In the above, the positive electrode lead electrode 510 and the negative electrode lead electrode 511 are drawn from the same side to the outside of the exterior body, so that the secondary battery 500 illustrated in FIG. 15A is fabricated. The secondary battery 500 illustrated in FIG. 15B can also be fabricated by drawing the positive electrode lead electrode 510 and the negative electrode lead electrode 511 from opposite sides to the outside of the exterior body.

### <Another Secondary Battery 1 and Fabricating Method Thereof>

FIG. 18 illustrates an example of a cross-sectional view of a stack of one embodiment of the present invention. A stack 550 illustrated in FIG. 18 is fabricated by placing one folded separator between the positive electrodes and the negative electrodes.

In the stack 550, one separator 507 is folded a plurality of times to be sandwiched between the positive electrode active material layers 502 and the negative electrode active material layers 505. Since six positive electrodes 503 and six negative electrodes 506 are stacked in FIG. 18, the separator 507 is folded at least five times. The separator 507 is provided to be sandwiched between the positive electrode active material layer 502 and the negative electrode active material layer 505 and to have an extending portion folded so that the plurality of positive electrodes 503 and the plurality of negative electrodes 506 can be bound together with a tape or the like.

After the positive electrode 503 is placed, an electrolyte can be dripped on the positive electrode 503 in the method for fabricating the secondary battery of one embodiment of the present invention. Similarly, after the negative electrode 506 is placed, an electrolyte can be dripped on the negative electrode 506. In the method for fabricating the secondary battery of one embodiment of the present invention, an electrolyte can be dripped on the separator 507 before the separator is folded or after the folded separator 507 overlaps with the negative electrode 506 or the positive electrode 503. When an electrolyte is dripped on at least one of the negative electrode 506, the separator 507, and the positive electrode 503, the negative electrode 506, the separator 507, or the positive electrode 503 can be impregnated with the electrolyte.

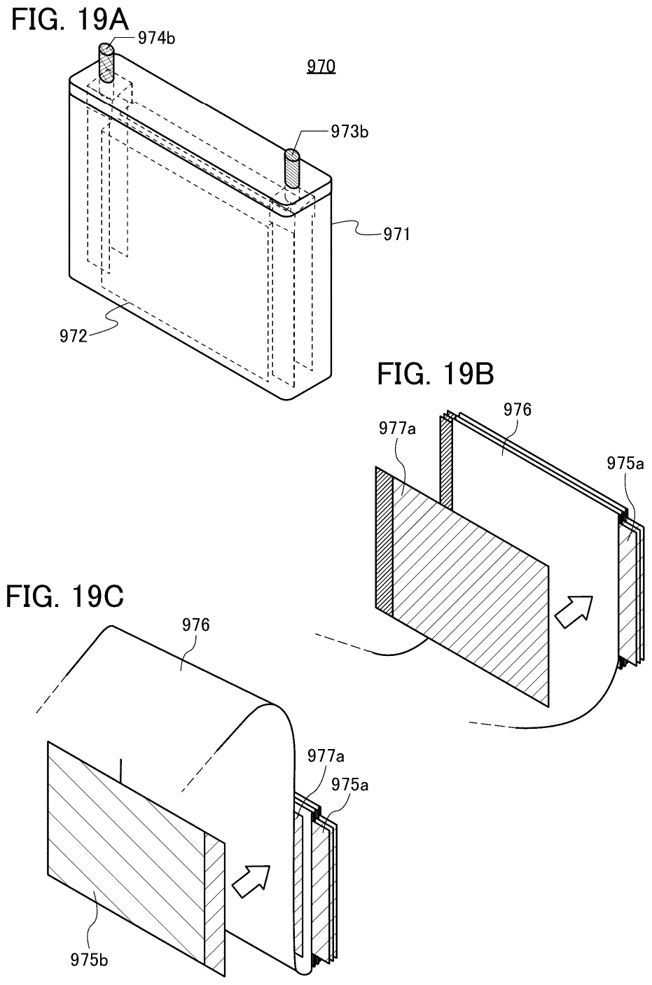

A secondary battery 970 illustrated in FIG. 19A includes a stack 972 inside a housing 971. A terminal 973b and a terminal 974b are electrically connected to the stack 972. At least part of the terminal 973b and at least part of the terminal 974b are exposed to the outside of the housing 971.

The stack 972 can have a stacked-layer structure of a positive electrode, a negative electrode, and a separator. Alternatively, the stack 972 can have a structure in which a positive electrode, a negative electrode, and a separator are wound, for example.

As the stack 972, the stack having the structure illustrated in FIG. 18 in which the separator is folded can be used, for example.

An example of a method for fabricating the stack 972 will be described with reference to FIG. 19B and FIG. 19C.

First, as illustrated in FIG. 19B, a belt-like separator 976 overlaps with a positive electrode 975a, and a negative electrode 977a overlaps with the positive electrode 975a with the separator 976 therebetween. After that, the separator 976 is folded to overlap with the negative electrode 977a. Next, as illustrated in FIG. 19C, a positive electrode 975b overlaps with the negative electrode 977a with the separator 976 therebetween. In this manner, the positive electrodes and the negative electrodes are sequentially placed with the folded separator therebetween, whereby the stack 972 can be fabricated. A structure including the stack fabricated in the above manner is sometimes referred to as a “zigzag structure”.

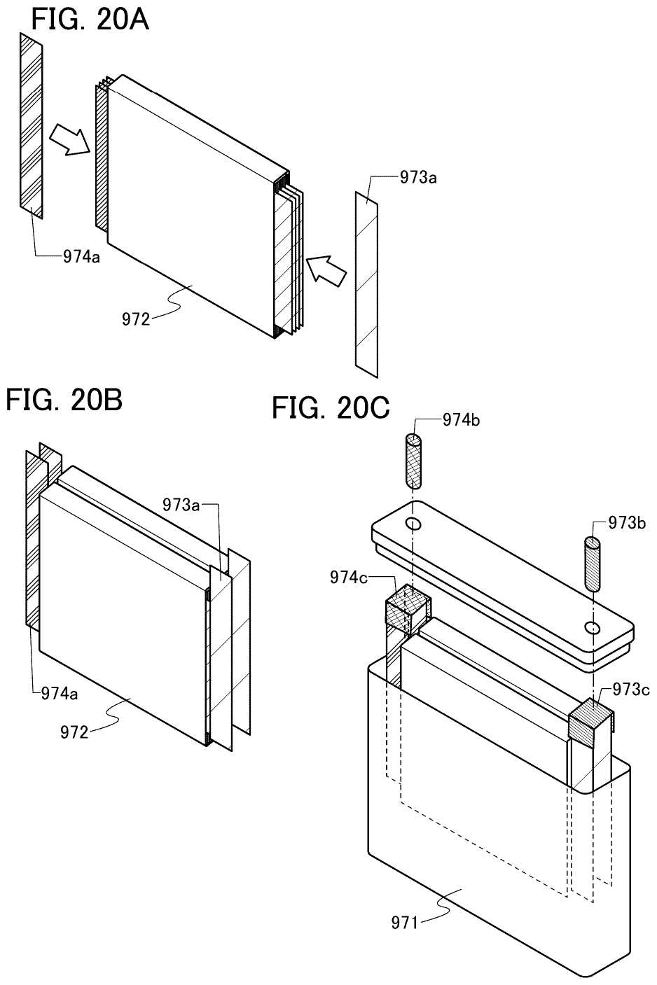

Next, an example of a method for fabricating the secondary battery 970 will be described with reference to FIG. 20A to FIG. 20C.

First, as illustrated in FIG. 20A, a positive electrode lead electrode 973a is electrically connected to the positive electrodes included in the stack 972. Specifically, for example, the positive electrodes included in the stack 972 are provided with tab regions, and the tab regions and the positive electrode lead electrode 973a can be electrically connected to each other by welding or the like. In addition, a negative electrode lead electrode 974a is electrically connected to the negative electrodes included in the stack 972.

One stack 972 may be placed inside the housing 971 or a plurality of stacks 972 may be placed inside the housing 971. FIG. 20B illustrates an example of preparing two stacks 972.

Next, as illustrated in FIG. 20C, the prepared stacks 972 are stored in the housing 971, the terminal 973b and the terminal 974b are inserted, and the housing 971 is sealed. It is preferable to electrically connect a conductor 973c to each of the positive electrode lead electrodes 973a included in the plurality of stacks 972. In addition, it is preferable to electrically connect a conductor 974c to each of the negative electrode lead electrodes 974a included in the plurality of stacks 972. The terminal 973b and the terminal 974b are electrically connected to the conductor 973c and the conductor 974c, respectively. Note that the conductor 973c may include a conductive region and an insulating region. In addition, the conductor 974c may include a conductive region and an insulating region.

For the housing 971, a metal material (e.g., aluminum) can be used. In the case where a metal material is used for the housing 971, the surface is preferably coated with a resin or the like. Alternatively, a resin material can be used for the housing 971.

The housing 971 is preferably provided with a safety valve, an overcurrent protection element, or the like. A safety valve is a valve for releasing a gas, in order to prevent the battery from exploding, when the pressure inside the housing 971 reaches a predetermined pressure.

### <Another Secondary Battery 2 and Fabricating Method Thereof>

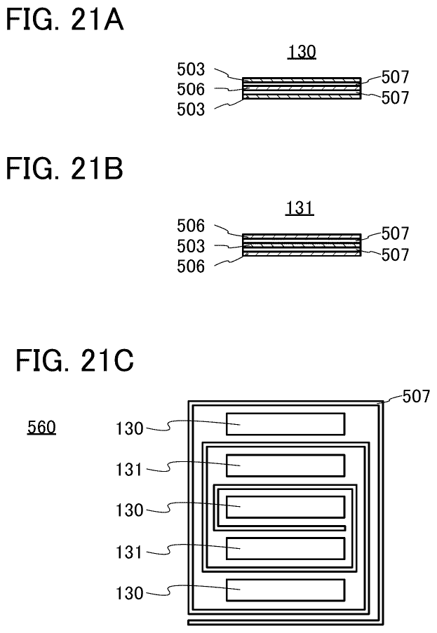

FIG. 21C illustrates an example of a cross-sectional view of a secondary battery of another embodiment of the present invention. A secondary battery 560 illustrated in FIG. 21C is fabricated using stacks 130 illustrated in FIG. 21A and stacks 131 illustrated in FIG. 21B. In FIG. 21C, the stacks 130, the stacks 131, and the separator 507 are selectively illustrated for the sake of clarity of the drawing.

As illustrated in FIG. 21A, in the stack 130, the positive electrode 503 including the positive electrode active material layers on both surfaces of the positive electrode current collector, the separator 507, the negative electrode 506 including the negative electrode active material layers on both surfaces of the negative electrode current collector, the separator 507, and the positive electrode 503 including the positive electrode active material layers on both surfaces of the positive electrode current collector are stacked in this order.

As illustrated in FIG. 21B, in the stack 131, the negative electrode 506 including the negative electrode active material layers on both surfaces of the negative electrode current collector, the separator 507, the positive electrode 503 including the positive electrode active material layers on both surfaces of the positive electrode current collector, the separator 507, and the negative electrode 506 including the negative electrode active material layers on both surfaces of the negative electrode current collector are stacked in this order.

The method for fabricating the secondary battery of one embodiment of the present invention can be utilized for fabricating the stacks. Specifically, in order to fabricate the stacks, an electrolyte is dripped on at least one of the negative electrode 506, the separator 507, and the positive electrode 503 at the time of stacking the negative electrode 506, the separator 507, and the positive electrode 503. Dripping a plurality of drops of the electrolyte enables the negative electrode 506, the separator 507, or the positive electrode 503 to be impregnated with the electrolyte.

As illustrated in FIG. 21C, the plurality of stacks 130 and the plurality of stacks 131 are covered with the wound separator 507.

After the stacks 130 are placed, an electrolyte can be dripped on the stacks 130 in the method for fabricating the secondary battery of one embodiment of the present invention. Similarly, after the stacks 131 are placed, an electrolyte can be dripped on the stacks 131. Moreover, an electrolyte can be dripped on the separator 507 before the separator 507 is folded or after the folded separator 507 overlaps with the stacks. Dripping a plurality of drops of the electrolyte enables the stacks 130, the stacks 131, or the separator 507 to be impregnated with the electrolyte.

### <Another Secondary Battery 3 and Fabricating Method Thereof>

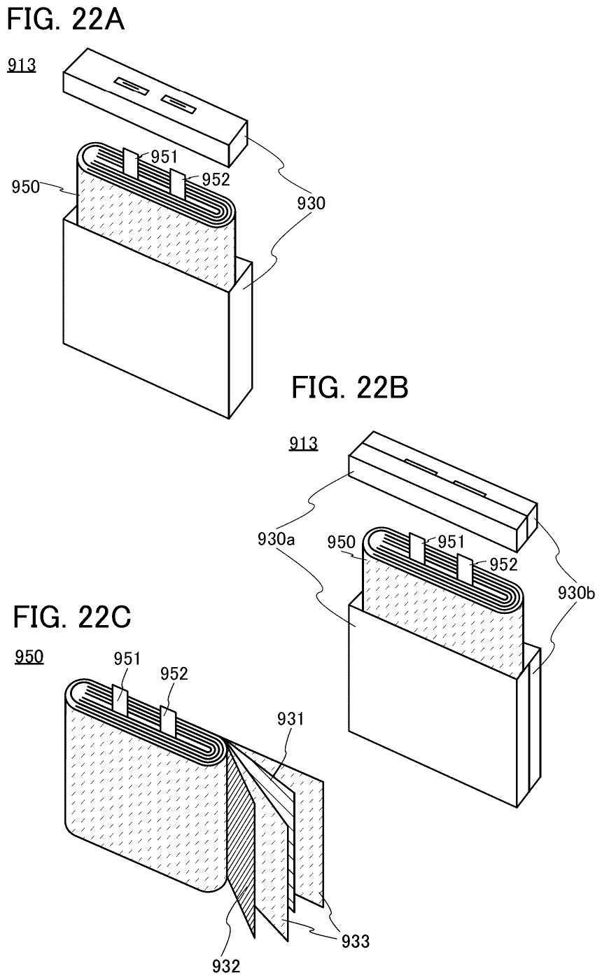

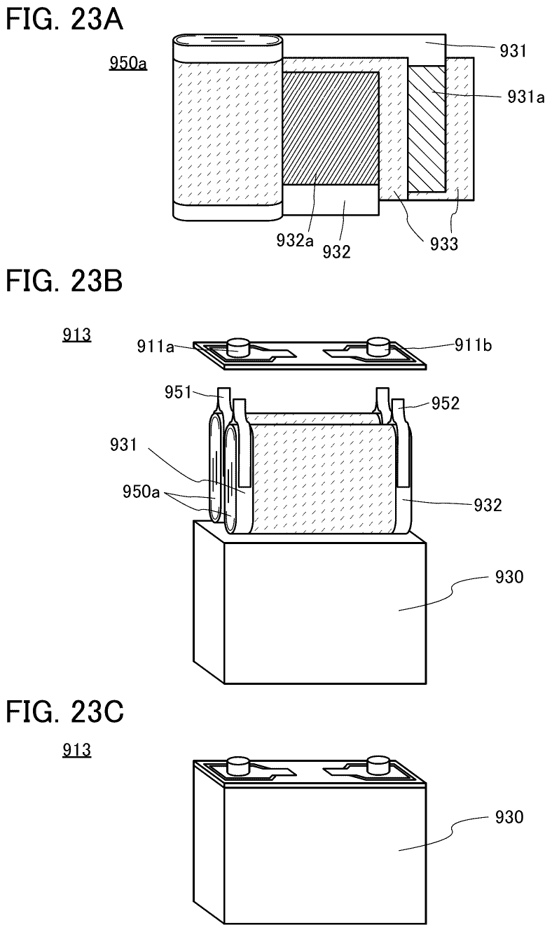

A secondary battery of another embodiment of the present invention will be described with reference to FIG. 22A to FIG. 22C and FIG. 23A to FIG. 23C. The secondary battery described here can be referred to as a wound secondary battery or the like.

A secondary battery 913 illustrated in FIG. 22A includes a wound body 950 provided with a terminal 951 and a terminal 952 inside a housing 930. The wound body 950 is immersed in an electrolyte inside the housing 930. The terminal 952 is in contact with the housing 930. The use of an insulator or the like inhibits contact between the terminal 951 and the housing 930. Note that in FIG. 22A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 22B, the housing 930 illustrated in FIG. 22A may be formed using a plurality of materials. For example, in the secondary battery 913 illustrated in FIG. 22B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

Furthermore, FIG. 22C illustrates the structure of the wound body 950. The wound body 950 includes a negative electrode 931, a positive electrode 932, and separators 933. The wound body 950 is a wound body obtained by winding a sheet of a stack in which the negative electrode 931 and the positive electrode 932 overlap with each other with the separator 933 therebetween. Note that a plurality of stacked layers each including the negative electrode 931, the positive electrode 932, and the separators 933 may be further stacked.

At the time of stacking the negative electrode 931, the separator 933, and the positive electrode 932 in the method for fabricating the secondary battery of one embodiment of the present invention, an electrolyte is dripped on at least one of the negative electrode 931, the separator 933, and the positive electrode 932. That is, an electrolyte is preferably dripped before the sheet of the stack is wound. Dripping a plurality of drops of the electrolyte enables the negative electrode 931, the separator 933, or the positive electrode 932 to be impregnated with the electrolyte.

As illustrated in FIG. 23A to FIG. 23C, the secondary battery 913 may include a wound body 950a. The wound body 950a illustrated in FIG. 23A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 23B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 23C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is temporarily released only when the internal pressure of the housing 930 exceeds a predetermined internal pressure.

As illustrated in FIG. 23B, the secondary battery 913 may include a plurality of wound bodies 950a. The use of the plurality of wound bodies 950a enables the secondary battery 913 to have higher charge-discharge capacity.

This embodiment can be combined with any of the other embodiments as appropriate.

### Embodiment 4

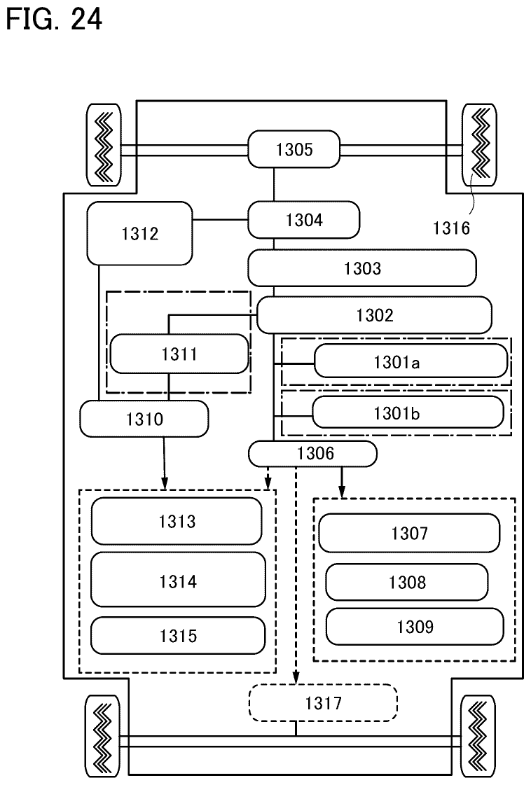

In this embodiment, application examples of the power storage system of one embodiment of the present invention will be described with reference to FIG. 24 to FIG. 33.

In an application example below, the power storage system preferably includes the charging unit of one embodiment of the present invention. The charging unit of one embodiment of the present invention preferably includes the components included in the charging unit described in the above embodiment. The charging unit of one embodiment of the present invention may include a circuit having a function of converting voltage, current, or the like of supplied electric power. Examples of the circuit having a function of converting voltage, current, or the like of electric power include a regulator, a step-down circuit, a boosting circuit, a circuit having a function of converting AC power into DC power, a modulation circuit, a demodulation circuit, an amplifier circuit, and the like.

### [Vehicle]

First, an example in which the power storage system of one embodiment of the present invention is used in an electric vehicle (EV) will be described.

FIG. 24 illustrates a block diagram of a vehicle including a motor. The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 preferably has high output but does not necessarily have high capacity, and the capacity of the second battery 1311 is lower than that of the first batteries 1301a and 1301b.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (for a high-voltage system) (such as an electric power steering 1307, a heater 1308, and a defogger 1309) through a DC-DC circuit 1306. In the case where a rear motor 1317 is provided for the rear wheels, the first battery 1301a is used to rotate the rear motor 1317.

The second battery 1311 supplies electric power to in-vehicle parts for 14 V (for a low-voltage system) (such as an audio 1313, power windows 1314, and lamps 1315) through a DC-DC circuit 1310.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is used for the second battery 1311 due to cost advantage in many cases.

In this embodiment, an example in which lithium-ion secondary batteries are used as both the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 through a motor controller 1303 or a battery controller 1302. Alternatively, the regenerative energy is stored in the first battery 1301a through the battery controller 1302. Alternatively, the regenerative energy is stored in the first battery 1301b through the battery controller 1302. For efficient charging with regenerative energy, the first batteries 1301a and 1301b are preferably capable of being rapidly charged.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

As the battery controller 1302, the charging unit of one embodiment of the present invention can be used. In addition, the circuit having a function of converting voltage, current, or the like of electric power may be provided between the motor 1304 and the battery controller 1302. By using the charging unit of one embodiment of the present invention as the battery controller 1302, the charge capacity of the first batteries 1301a and 1301b can be increased and the reliability of the first batteries 1301a and 1301b can be increased as well. Since the charge capacity of the first batteries 1301a and 1301b can be increased, the driving range of the electric vehicle can be increased. Furthermore, deterioration of the first batteries 1301a and 1301b can be inhibited, leading to a lower frequency of replacement of a battery in the electric vehicle. In addition, the reliability of the first batteries 1301a and 1301b can be increased, which can increase the safety of the electric vehicle.

Next, examples in which the power storage system of one embodiment of the present invention is mounted on a vehicle, typically a transportation vehicle, will be described.

The use of power storage system of one embodiment of the present invention in vehicles enables production of next-generation clean energy vehicles such as hybrid electric vehicles (HVs), electric vehicles (EVs), or plug-in hybrid electric vehicles (PHVs). The secondary battery can also be mounted on transportation vehicles such as agricultural machines like an electric tractor, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, or spacecraft. With the use of the method for fabricating the secondary battery of one embodiment of the present invention, a large secondary battery can be fabricated. The secondary battery of one embodiment of the present invention can preferably be used in transportation vehicles.

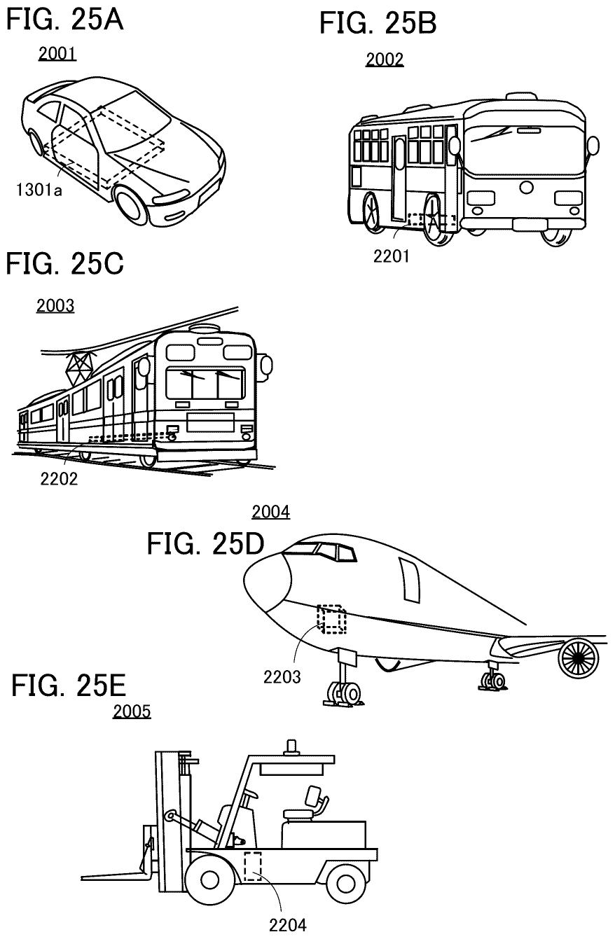

FIG. 25A to FIG. 25E illustrate transportation vehicles each using the power storage system of one embodiment of the present invention. An automobile 2001 illustrated in FIG. 25A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery is provided at one position or several positions. The automobile 2001 illustrated in FIG. 25A includes the power storage system of one embodiment of the present invention. The power storage system includes the charging unit of one embodiment of the present invention and the first battery 1301a illustrated in FIG. 24A. The power storage system may include a plurality of secondary batteries connected in series as an assembled battery. The assembled battery is electrically connected to the charging unit of one embodiment of the present invention.

The power storage system included in the automobile 2001 is supplied with electric power through external power supply equipment by a plug-in system, a contactless power feeding system, or the like. For supply of electric power, the standard of a connector and power supply system for a given method such as CHAdeMO (registered trademark) or Combined Charging System can be employed. Power may be supplied from a charging station provided in a commerce facility or a power source in a house.

In the charging unit of one embodiment of the present invention, when charge is determined to be stopped, a signal to convey the charge stop can be transmitted to the charging station through a control circuit included in the charging unit of one embodiment of the present invention. Alternatively, the charging station may include the charging unit of one embodiment of the present invention. For example, the charging station may include at least part of the components of the charging unit of one embodiment of the present invention, for example, may include a control circuit of the charging unit of one embodiment of the present invention.

The automobile 2001 preferably has a function of converting AC power into DC power through a conversion device such as an AC-DC converter. In such a case, DC power obtained by conversion is supplied to the power storage system, for example.

Although not illustrated, the vehicle may include a power receiving device so that it can be supplied with electric power from an above-ground power transmitting device in a contactless manner. In the case of the contactless power feeding system, by fitting a power transmitting device in a road or an exterior wall, power supply can be performed not only when the vehicle is stopped but also when driven. In addition, the contactless power feeding system may be utilized to perform transmission and reception of electric power between two vehicles. Furthermore, a solar cell may be provided in the exterior of the vehicle and supplied with power when the vehicle stops or moves. To supply electric power in such a contactless manner, an electromagnetic induction method or a magnetic resonance method can be used.

FIG. 25B illustrates a large transporter 2002 having a motor controlled by electricity as an example of a transportation vehicle. The secondary battery module of the transporter 2002 has a cell unit of four secondary batteries with 3.5 V or more and 4.7 V or lower, and 48 cells are connected in series to have 170 V as the maximum voltage. A power storage system 2201 includes the charging unit of one embodiment of the present invention and the secondary battery module. The power storage system 2201 has the same function as that in FIG. 25A except the number of secondary batteries configuring the secondary battery module, for example; thus, the description is omitted.

FIG. 25C illustrates a large transportation vehicle 2003 having a motor controlled by electricity as an example. The transportation vehicle 2003 includes a power storage system 2202. The power storage system 2202 includes the charging unit of one embodiment of the present invention and a secondary battery module. The secondary battery module has more than 100 secondary batteries with 3.5 V or more and 4.7 V or lower connected in series, and the maximum voltage is 600 V, for example. The power storage system 2202 has the same function as that in FIG. 25A except the number of secondary batteries configuring the secondary battery module, for example; thus, the description is omitted.

FIG. 25D illustrates an aircraft 2004 having a combustion engine as an example. The aircraft 2004 illustrated in FIG. 25D is regarded as one kind of transportation vehicles because it has wheels for takeoff and landing, and includes a power storage system 2203 that includes a charging unit of one embodiment of the present invention and a secondary battery module configured by connecting a plurality of secondary batteries.

The secondary battery module of the aircraft 2004 has eight 4 V secondary batteries connected in series, which has the maximum voltage of 32 V, for example. The power storage system 2203 has the same function as that in FIG. 25A except the number of secondary batteries configuring the secondary battery module, for example; thus, the description is omitted.

FIG. 25E illustrates a transportation vehicle 2005 that transports a load as an example. The transportation vehicle 2005 includes a power storage system 2204. The power storage system 2204 includes a charging unit of one embodiment of the present invention and a secondary battery module. The transportation vehicle 2005 includes a motor controlled by electricity and executes various operations with the use of electric power supplied from secondary batteries configuring a secondary battery module of a power storage system 2204. The transportation vehicle 2005 is not limited to operation by a human who rides thereon as a driver, and an unmanned operation is also possible by CAN communication or the like. Although FIG. 25E illustrates a forklift as an example, there is no particular limitation; a power storage system of one embodiment of the present invention can be mounted on an industrial machine capable of being operated by CAN communication, e.g., an automatic transport machine, a working robot, or small construction equipment.

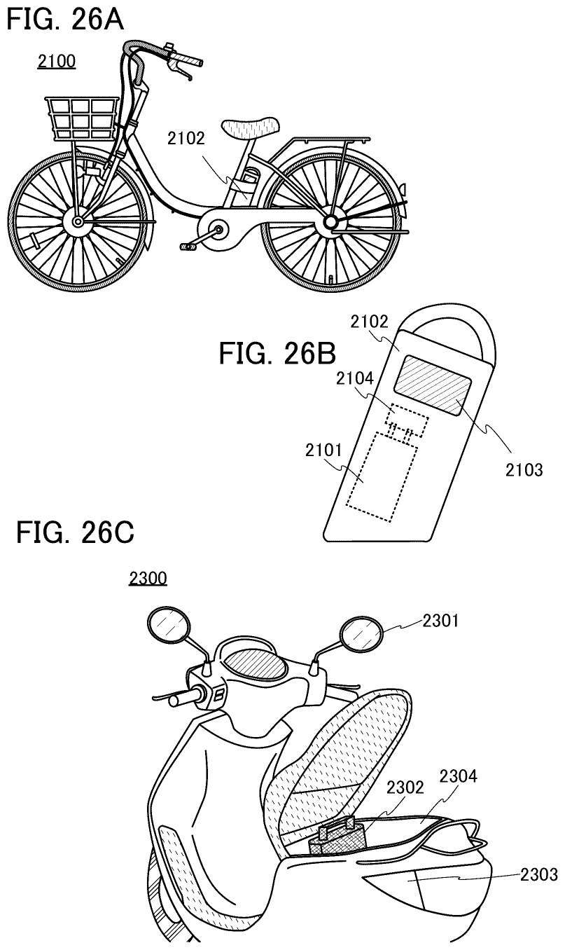

FIG. 26A is an example of an electric bicycle using the power storage system of one embodiment of the present invention. The power storage system of one embodiment of the present invention can be used for an electric bicycle 2100 in FIG. 26A. The power storage system 2102 in FIG. 26B includes a plurality of secondary batteries and a charging unit of one embodiment of the present invention, for example.

The electric bicycle 2100 includes the power storage system 2102. The power storage system 2102 can supply electric power to a motor that assists a rider. The power storage system 2102 is portable, and FIG. 26B illustrates the state where the power storage system 2102 is removed from the electric bicycle. A plurality of secondary batteries 2101 are incorporated in the power storage system 2102, and the remaining battery capacity and the like can be displayed on a display portion 2103. The power storage system 2102 includes a charging unit 2104. The charging unit 2104 is electrically connected to a positive electrode and a negative electrode of the secondary battery 2101. The charging unit 2104 may be provided with a small solid-state secondary battery. When the small solid-state secondary battery is provided in the charging unit 2104, electric power can be supplied to store data in a memory circuit included in the charging unit 2104 for along time. The charging unit 2104 can increase the safety of the secondary battery and can greatly contribute to elimination of accidents such as fires. Furthermore, with the charging unit 2104, the driving range of the bicycle can be increased.

FIG. 26C illustrates an example of a motorcycle using the power storage system of one embodiment of the present invention. A motor scooter 2300 illustrated in FIG. 26C includes a power storage system 2302, side mirrors 2301, and indicator lights 2303. The power storage system 2302 can supply electric power to the indicator lights 2303.

Furthermore, in the motor scooter 2300 illustrated in FIG. 26C, the power storage system 2302 can be held in a storage unit under seat 2304. The power storage system 2302 can be held in the storage unit under seat 2304 even with a small size.

### [Building]

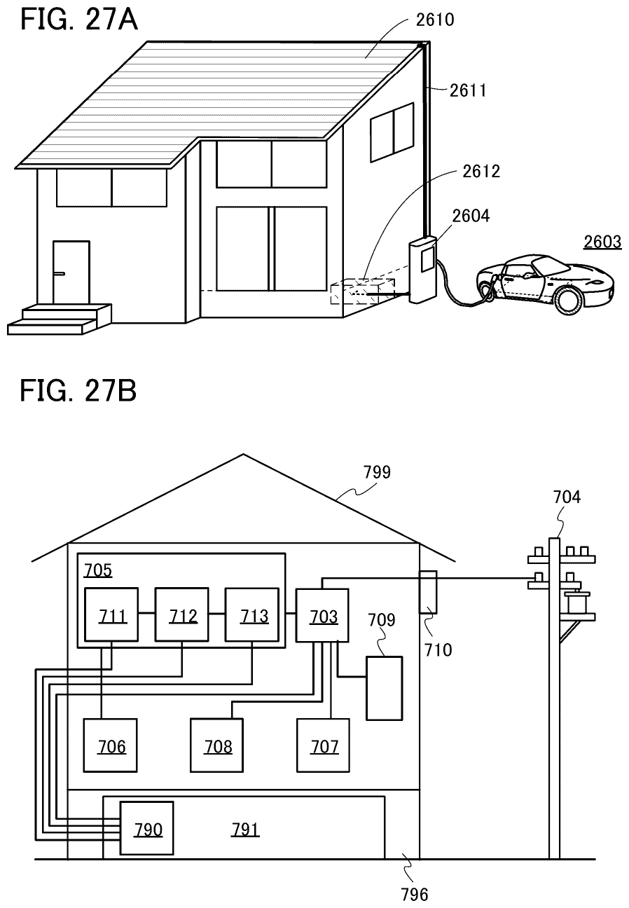

Next, examples in which the power storage system of one embodiment of the present invention is mounted on a building will be described with reference to FIG. 27.

A house illustrated in FIG. 27A includes a power storage system 2612 and a solar panel 2610. The power storage system 2612 includes, for example, an assembled battery including a plurality of secondary batteries. The power storage system 2612 is electrically connected to the solar panel 2610 through a wiring 2611 or the like.

The power storage system 2612 includes a charging unit of one embodiment of the present invention. Electric power generated by the solar panel 2610 can be stored in the power storage system 2612 through the charging unit.

The power storage system 2612 may be electrically connected to a ground-based charging device 2604. In the charging unit of the power storage system 2612, when charge is determined to be stopped, a signal to convey the charge stop can be transmitted to the charging device 2604 through a control circuit included in the charging unit. Alternatively, the charging device 2604 may include the charging unit of one embodiment of the present invention. For example, the charging device 2604 may include at least part of the components of the charging unit of one embodiment of the present invention, for example, a control circuit of the charging unit of one embodiment of the present invention.

A secondary battery included in a vehicle 2603 can be charged with the electric power stored in the power storage system 2612 through the charging device 2604. The power storage system 2612 is preferably provided in an underfloor space. The power storage system 2612 is preferably provided in the underfloor space, in which case the space on the floor can be effectively used. Alternatively, the power storage system 2612 may be provided on the floor.

The electric power stored in the power storage system 2612 can also be supplied to other electronic devices in the house. Thus, the electronic devices can be used with the power storage system 2612 as an uninterruptible power source even when electric power cannot be supplied from the commercial power supply due to power failure or the like.

FIG. 27B illustrates an example of a power storage system according to one embodiment of the present invention. As illustrated in FIG. 27B, a power storage system 791 including a large secondary battery and the charging unit of one embodiment of the present invention is provided in an underfloor space 796 of a building 799.

The power storage system 791 is provided with a control device 790, and the control device 790 is electrically connected to a distribution board 703, a power storage controller (also referred to as control device) 705, an indicator 706, and a router 709 through wirings.

Electric power is transmitted from a commercial power source 704 to the distribution board 703 through a service wire mounting portion 710. Moreover, electric power is transmitted to the distribution board 703 from the power storage system 791 and the commercial power source 704, and the distribution board 703 supplies the transmitted electric power to a general load 707 and a power storage load 708 through outlets (not illustrated).

The general load 707 is, for example, an electrical device such as a TV or a personal computer. The power storage load 708 is, for example, an electrical device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the power storage system 791 and the amount of electric power supplied from the commercial power source 704. The predicting portion 712 has a function of predicting, on the basis of the amount of electric power consumed by the general load 707 and the power storage load 708 during a day, the demand for electric power to be consumed by the general load 707 and the power storage load 708 during the next day. The planning portion 713 has a function of making a charge-discharge plan of the power storage system 791 on the basis of the demand for electric power predicted by the predicting portion 712.

The indicator 706 can show the amount of electric power consumed by the general load 707 and the power storage load 708 that is measured by the measuring portion 711. An electrical device such as a TV or a personal computer can also show it through the router 709. Furthermore, a portable electronic terminal such as a smartphone or a tablet can also show it through the router 709. The indicator 706, the electrical device, the portable electronic terminal, or the like can also show, for example, the demand for electric power depending on a time period (or per hour) that is predicted by the predicting portion 712.

### [Electronic Device]

The secondary battery of one embodiment of the present invention can be used for one or both of an electronic device and a lighting device, for example. Examples of the electronic device include portable information terminals such as mobile phones, smartphones, and laptop computers; portable game machines; portable music players; digital cameras; and digital video cameras.

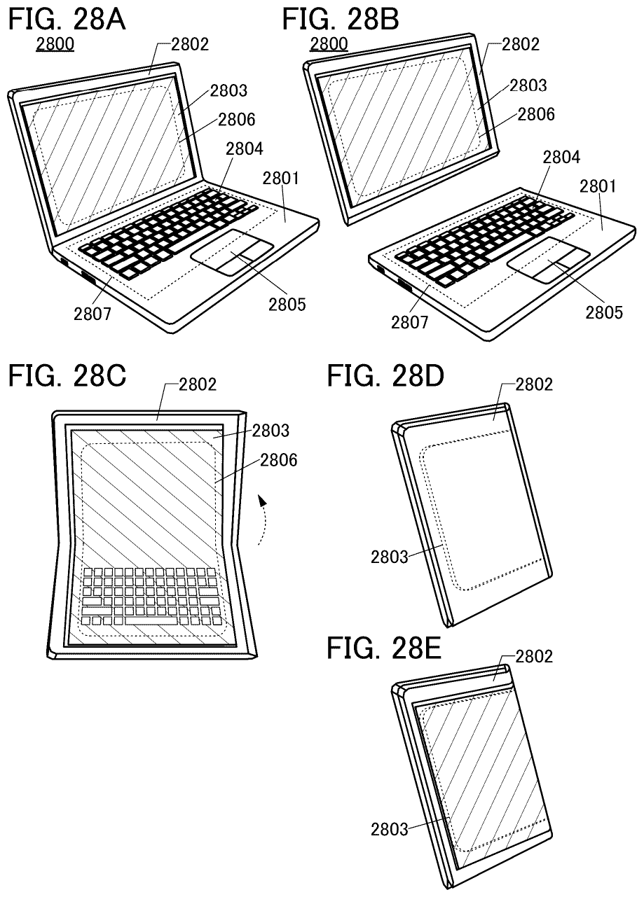

A personal computer 2800 illustrated in FIG. 28A includes a housing 2801, a housing 2802, a display portion 2803, a keyboard 2804, a pointing device 2805, and the like. A power storage system 2807 is provided inside the housing 2801 and a power storage system 2806 is provided inside the housing 2802. The power storage system 2806 includes a secondary battery and a charging unit that is electrically connected to the secondary battery. The power storage system 2807 includes a secondary battery and a charging unit that is electrically connected to the secondary battery. A touch panel is used for the display portion 2803. As illustrated in FIG. 28B, the housing 2801 and the housing 2802 of the personal computer 2800 can be detached from each other and the housing 2802 can be used alone as a tablet computer.

When a flexible film is used for an exterior of a secondary battery included in each of the power storage systems 2806 and 2807 and has a shape fitting with the shapes of the housings 2801 and 2802, for example, the secondary batteries can have high capacity and thus the operating time of the personal computer 2800 can be lengthened. Moreover, the weight of the personal computer 2800 can be reduced.

A flexible display panel is used for the display portion 2803 of the housing 2802. The power storage system 2806 includes a secondary battery and a charging unit which is electrically connected to the secondary battery. With use of a flexible film as an exterior body of the secondary battery in the power storage system 2806, the secondary battery 2806 can be bendable secondary battery. Thus, as illustrated in FIG. 28C, the housing 2802 can be used while being bent. At this time, part of the display portion 2803 can also be used as a keyboard as illustrated in FIG. 28C.

Furthermore, the housing 2802 can be folded so that the display portion 2803 is placed inward as illustrated in FIG. 28D, and the housing 2802 can be folded so that the display portion 2803 faces outward as illustrated in FIG. 28E.

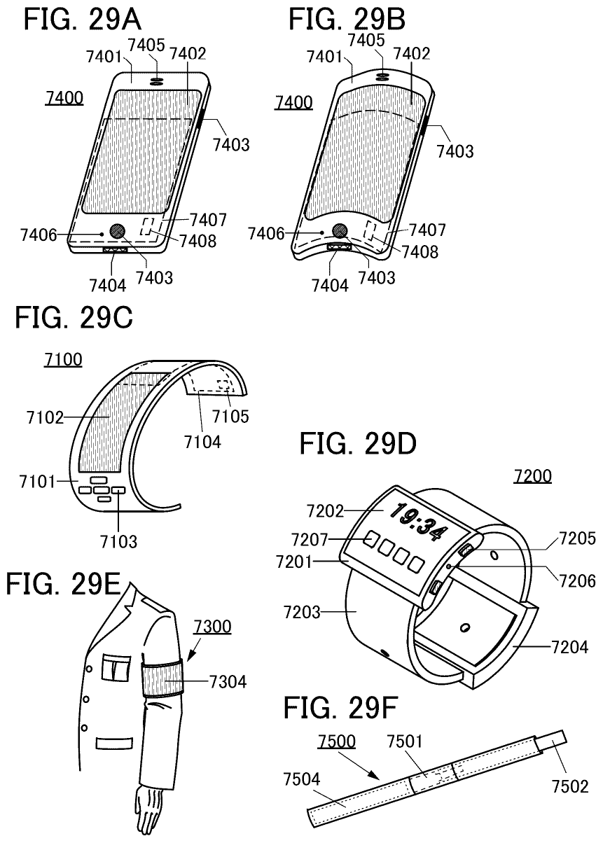

FIG. 29A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a power storage system. The power storage system includes a secondary battery 7407 and a charging unit 7408 electrically connected to the secondary battery 7407. The charging unit 7408 can receive power supply from an external power source through the external connection port 7404. For example, power from an AC adapter is supplied to the external connection port 7404. The AC adapter has a function of converting AC power into DC power and supplying the DC power to the external connection port 7404. Alternatively, the mobile phone 7400 may have a function of converting AC power into DC power through a conversion circuit such as an AC-DC converter. In addition, the charging unit 7408 may include a circuit of converting AC power into DC power.

Electric power may be supplied from an external power source to the mobile phone 7400 by wireless power feeding. As the wireless power feeding standard, the Qi standard or the like may be employed. A signal which is transmitted to the mobile phone 7400 by wireless power feeding is supplied to the charging unit 7408 via a demodulation circuit or the like, for example. Alternatively, the charging unit 7408 may include a circuit for wireless communication, for example, a modulation circuit or a demodulation circuit.

When the mobile phone 7400 includes a charging unit of one embodiment of the present invention as the charging unit 7408, the mobile phone 7400 can have higher safety. Furthermore, the discharge energy density of the secondary battery can be increased; therefore, the volume and weight of the secondary battery can be reduced, which enables the mobile phone 7400 to be reduced in size and weight. Furthermore, since the lifetime of the secondary battery can be increased, the mobile phone 7400 can be used over a long period without replacement of the secondary battery.

Since the charging unit of one embodiment of the present invention has functions of both a charge control circuit and a protection circuit, the area or the number of chips included in the mobile phone 7400 can be reduced. Thus, the size and weight of the mobile phone 7400 can be reduced, and the reliability of the mobile phone 7400 can be increased.

FIG. 29B illustrates the mobile phone 7400 that is curved. When the whole mobile phone 7400 is bent by the external force, the secondary battery 7407 included in the mobile phone 7400 is also bent.

FIG. 29C illustrates an example of a bangle display device. A portable display device 7100 includes a housing 7101, a display portion 7102, an operation button 7103, and a power storage system. The power storage system includes a secondary battery 7104 and a charging unit 7105 electrically connected to the secondary battery 7104. When the display device is worn on a user's arm while the secondary battery 7104 included in the power storage system is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery is changed with a radius of curvature in the range of 40 mm to 150 mm. When the radius of curvature of the main surface of the secondary battery ranges from 40 mm to 150 mm, both inclusive, the reliability can be kept high.

FIG. 29D illustrates an example of a wrist-watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. In that case, for example, by mutual communication with a headset capable of wireless communication, hands-free calling is possible.

Moreover, the portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

The display portion 7202 of the portable information terminal 7200 includes a power storage system. For example, the secondary battery 7104 and the charging unit 7105 illustrated in FIG. 29C can be provided the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 29E illustrates an example of an armband display device. The display device 7300 includes a display portion 7304 and a power storage system. The secondary battery 7104 and the charging unit 7105 illustrated in FIG. 29C can be incorporated in the display device 7300. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charging operation may be performed by wireless power feeding without using the input/output terminal.

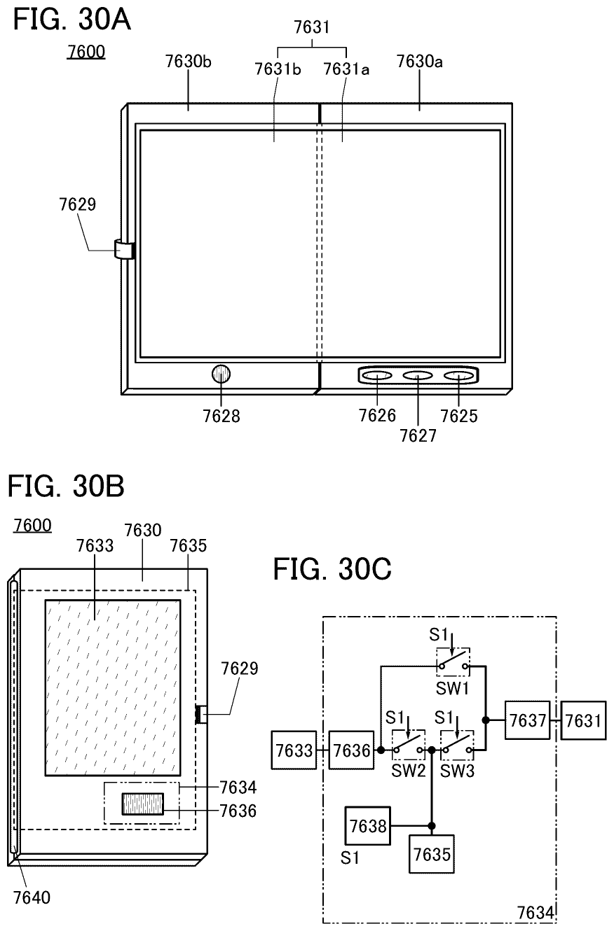

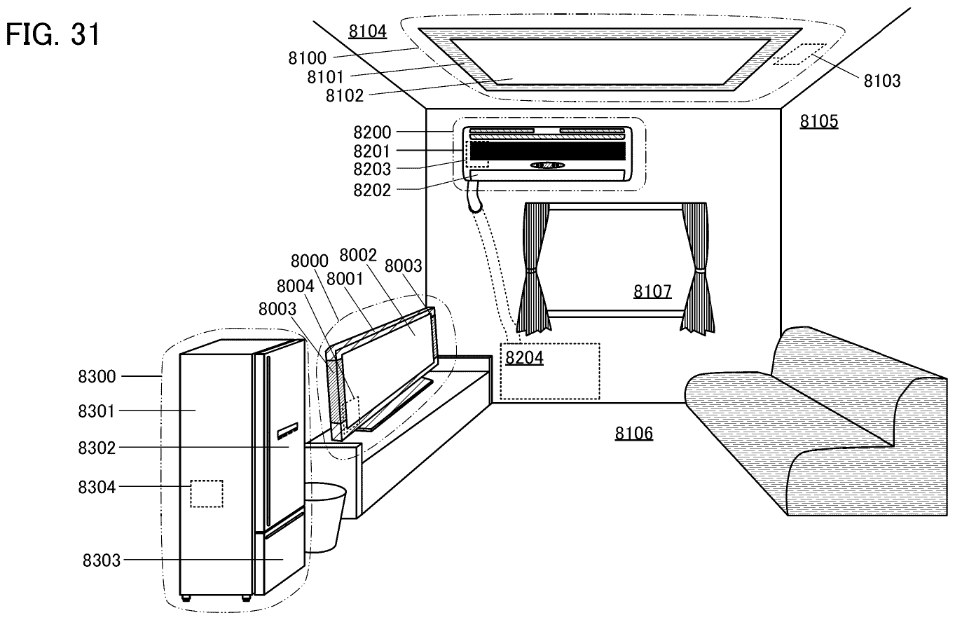

Examples of electronic devices each including the power storage system of one embodiment of the present invention are described with reference to FIG. 29F, FIG. 30, and FIG. 31.

FIG. 29F is a perspective view of a device called a vaporizer (electronic cigarette). In FIG. 29F, an electronic cigarette 7500 includes an atomizer 7501 including a heating element, a battery storage system 7504 that supplies power to the atomizer, and a cartridge 7502 including a liquid supply bottle, a sensor, or the like. The power storage system 7504 includes a secondary battery and a charging unit that is electrically connected to the secondary battery. The power storage system 7504 illustrated in FIG. 29F includes an external terminal for connection to an external power source for the electronic cigarette 7500. When the electronic cigarette 7500 is held, the power storage system 7504 is at the tip of the device; thus, it is preferred that the secondary battery included in the power storage system 7504 have a short total length and be lightweight.

Next, FIG. 30A and FIG. 30B illustrate an example of a tablet terminal that can be folded in half A tablet terminal 7600 illustrated in FIG. 30A and FIG. 30B includes a housing 7630a, a housing 7630b, a movable portion 7640 connecting the housing 7630a and the housing 7630b, a display portion 7631 including a display portion 7631a and a display portion 7631b, a switch 7625, a switch 7626, a switch 7627, a fastener 7629, and an operation switch 7628. The use of a flexible panel for the display portion 7631 achieves a tablet terminal with a larger display portion. FIG. 30A illustrates the tablet terminal 7600 that is opened, and FIG. 30B illustrates the tablet terminal 7600 that is closed.

The tablet terminal 7600 includes a secondary battery 7635 inside the housing 7630a and the housing 7630b. The secondary battery 7635 is provided across the housing 7630a and the housing 7630b, passing through the movable portion 7640.

Part of or the entire display portion 7631 can be a touch panel region, and data can be input by touching text, an input form, an image including an icon, and the like displayed on the region. For example, it is possible that keyboard buttons are displayed on the entire display portion 7631a on the housing 7630a side, and data such as text and an image is displayed on the display portion 7631b on the housing 7630b side.

It is also possible that a keyboard is displayed on the display portion 7631b on the housing 7630b side, and data such as text or an image is displayed on the display portion 7631a on the housing 7630a side. Furthermore, a switching button for showing/hiding a keyboard on a touch panel may be displayed on the display portion 7631 so that the keyboard is displayed on the display portion 7631 by touching the button with a finger, a stylus, or the like.

In addition, touch input can be performed concurrently in a touch panel region in the display portion 7631a on the housing 7630a side and a touch panel region in the display portion 7631b on the housing 7630b side.

The switch 7625 to the switch 7627 may function not only as an interface for operating the tablet terminal 7600 but also as an interface that can switch various functions. For example, at least one of the switches 7625 to 7627 may have a function of switching on/off of the tablet terminal 7600. For another example, at least one of the switch 7625 to the switch 7627 may have a function of switching display between a portrait mode and a landscape mode or a function of switching display between monochrome display and color display. For another example, at least one of the switches 7625 to 7627 may have a function of adjusting the luminance of the display portion 7631. The luminance of the display portion 7631 can be optimized in accordance with the amount of external light in use of the tablet terminal 7600, which is detected by an optical sensor incorporated in the tablet terminal 7600. Note that in addition to the optical sensor, the tablet terminal may incorporate another sensing device such as a sensor for measuring inclination, like a gyroscope sensor or an acceleration sensor.

The display portion 7631a on the housing 7630a side and the display portion 7631b on the housing 7630b side have substantially the same display area in FIG. 30A; however, there is no particular limitation on the display areas of the display portion 7631a and the display portion 7631b, and the display portions may have different areas or different display quality. For example, one of the display portions 7631a and 7631b may display higher-resolution images than the other.

FIG. 30B illustrates the tablet terminal 7600 which is folded in half. The tablet terminal 7600 includes the housing 7630, a solar cell 7633, and a power storage system 7634. The power storage system 7634 includes the charging unit described in the above embodiment. Furthermore, the power storage system 7634 includes a DC-DC converter 7636.

As described above, the tablet terminal 7600 can be folded in half such that the housing 7630a and the housing 7630b overlap with each other when not in use. Accordingly, the display portion 7631 can be protected, which increases the durability of the tablet terminal 7600.

The tablet terminal 7600 illustrated in FIG. 30A and FIG. 30B can also have a function of displaying various kinds of data (e.g., a still image, a moving image, and a text image), a function of displaying a calendar, a date, the time, or the like on the display portion, a touch input function of operating or editing data displayed on the display portion by touch input, a function of controlling processing by various kinds of software (programs), and the like.

The solar cell 7633, which is attached on the surface of the tablet terminal 7600, supplies electric power to the touch panel, the display portion, a video signal processing portion, and the like. Note that the solar cell 7633 can be provided on one or both surfaces of the housing 7630 and the secondary battery 7635 can be charged efficiently. The use of a lithium-ion battery as the secondary battery 7635 brings an advantage such as a reduction in size.

The structure and operation of the power storage system 7634 illustrated in FIG. 30B are described with reference to a block diagram of FIG. 30C. The solar cell 7633, the secondary battery 7635, the DC-DC converter 7636, a converter 7637, a charging unit 7638, a switch SW1 to a switch SW3, and the display portion 7631 are illustrated in FIG. 30C, and the secondary battery 7635, the DC-DC converter 7636, the converter 7637, and the switch SW1 to the switch SW3 correspond to parts of the power storage system 7634 in FIG. 30B. A charging unit of one embodiment of the present invention can be used as the charging unit 7638. The charging unit 7638 has a function of supplying a signal S1 to one or more of the switch SW1 to the switch SW3. The charging unit 7638 has a function of measuring, for example, current and voltage of the secondary battery 7635. The secondary battery 7635 has a function of determining a charge condition and controlling the switch SW2 in accordance with the determined charge condition.

An example of the operation in the case where power is generated by the solar cell 7633 using external light is described. The voltage of electric power generated by the solar cell is raised or lowered by the DC-DC converter 7636 to a voltage for charging the secondary battery 7635. When the display portion 7631 operates with the electric power from the solar cell 7633, the switch SW1 is turned on and the voltage of the electric power is raised or lowered by the converter 7637 to a voltage needed for the display portion 7631. In addition, when display on the display portion 7631 is not performed, the switch SW1 is turned off and the switch SW2 is turned on so that the secondary battery 7635 may be charged.

Note that the solar cell 7633 is described as an example of a power generation means; however, one embodiment of the present invention is not limited to this example. The secondary battery 7635 may be charged using another power generation means such as a piezoelectric element or a thermoelectric conversion element (Peltier element). For example, the secondary battery 7635 may be charged with a non-contact power transmission module that transmits and receives electric power wirelessly (without contact), or with a combination of another charging means.

FIG. 31 illustrates other examples of electronic devices. In FIG. 31, a display device 8000 is an example of an electronic device including a power storage system 8004 of one embodiment of the present invention. Specifically, the display device 8000 corresponds to a display device for TV broadcast reception and includes a housing 8001, a display portion 8002, speaker portions 8003, the power storage system 8004, and the like. The power storage system 8004 is provided in the housing 8001. The display device 8000 can receive electric power from a commercial power supply. Alternatively, the display device 8000 can use electric power stored in the power storage system 8004. Thus, the display device 8000 can be used with the power storage system 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all of information display devices for personal computers, advertisement displays, and the like besides TV broadcast reception.

In FIG. 31, an installation lighting device 8100 is an example of an electronic device including a power storage system 8103 of one embodiment of the present invention. Specifically, the lighting device 8100 includes a housing 8101, a light source 8102, the power storage system 8103, and the like. Although FIG. 31 illustrates the case where the power storage system 8103 is provided in a ceiling 8104 on which the housing 8101 and the light source 8102 are installed, the power storage system 8103 may be provided in the housing 8101. The lighting device 8100 can receive electric power from a commercial power supply. Alternatively, the lighting device 8100 can use electric power stored in the power storage system 8103. Thus, the lighting device 8100 can be used with the power storage system 8103 corresponding to the power storage system of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 31 as an example, the power storage system of one embodiment of the present invention can be used in an installation lighting device provided in, for example, a wall 8105, a floor 8106, a window 8107, or the like other than the ceiling 8104 or can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and/or an organic EL element are given as examples of the artificial light source.

In FIG. 31, an air conditioner including an indoor unit 8200 and an outdoor unit 8204 is an example of an electronic device including a power storage system 8203 of one embodiment of the present invention. Specifically, the indoor unit 8200 includes a housing 8201, an air outlet 8202, the power storage system 8203, and the like. Although FIG. 31 illustrates the case where the power storage system 8203 is provided in the indoor unit 8200, the power storage system 8203 may be provided in the outdoor unit 8204. Alternatively, the power storage system 8203 may be provided in both the indoor unit 8200 and the outdoor unit 8204. The air conditioner can receive electric power from a commercial power supply. Alternatively, the air conditioner can use electric power stored in the power storage system 8203. Particularly in the case where the power storage systems 8203 are provided in both the indoor unit 8200 and the outdoor unit 8204, the air conditioner can be used with the power storage system 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 31 as an example, the power storage system of one embodiment of the present invention can be used in an air conditioner in which the functions of an indoor unit and an outdoor unit are integrated in one housing.

In FIG. 31, an electric refrigerator-freezer 8300 is an example of an electronic device including a power storage system 8304 of one embodiment of the present invention. Specifically, the electric refrigerator-freezer 8300 includes a housing 8301, a door for a refrigerator 8302, a door for a freezer 8303, and the power storage system 8304. The power storage system 8304 is provided in the housing 8301 in FIG. 31. The electric refrigerator-freezer 8300 can receive electric power from a commercial power supply. The electric refrigerator-freezer 8300 can receive electric power from a commercial power source or use electric power stored in the power storage system 8304. Thus, the electric refrigerator-freezer 8300 can be used with the power storage system 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of an electronic device can be prevented by using the power storage system of one embodiment of the present invention as an auxiliary power supply for supplying electric power which cannot be supplied enough by a commercial power supply.

In addition, in a time period when electronic devices are not used, specifically when the proportion of the amount of electric power which is actually used to the total amount of electric power which can be supplied from a commercial power source (such a proportion is referred to as power usage rate) is low, electric power can be stored in the power storage system, whereby the power usage rate can be reduced in a time period when the electronic devices are used. For example, in the case of the electric refrigerator-freezer 8300, electric power can be stored in the power storage system 8304 in night time when the temperature is low and the door for a refrigerator 8302 and the door for a freezer 8303 are not opened or closed. On the other hand, in daytime when the temperature is high and the door for a refrigerator 8302 and the door for a freezer 8303 are opened and closed, the power storage system 8304 is used as an auxiliary power source; thus, the power usage rate in daytime can be reduced.

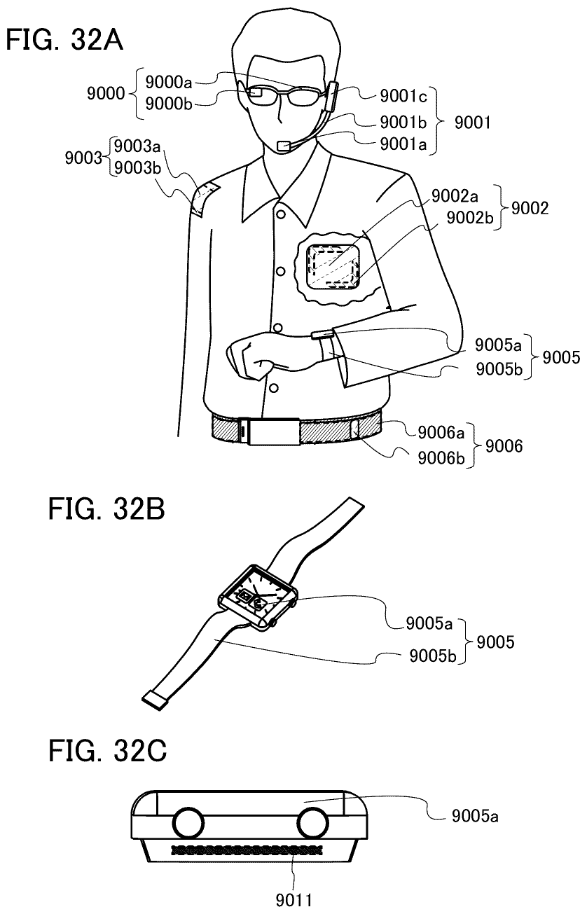

FIG. 32A illustrates examples of wearable devices. A power storage system is used as a power source of a wearable device. To have improved splash resistance, water resistance, or dust resistance in daily use or outdoor use by a user, a wearable device is desirably capable of being charged with and without a wire whose connector portion for connection is exposed.

For example, the power storage system of one embodiment of the present invention can be provided in a glasses-type device 9000 illustrated in FIG. 32A. The glasses-type device 9000 includes a frame 9000a and a display portion 9000b. The power storage system is provided in a temple of the frame 9000a having a curved shape, whereby the glasses-type device 9000 can be lightweight, can have a well-balanced weight, and can be used continuously for along time. With the use of the power storage system of one embodiment of the present invention, the energy density of the power storage system can be made high and space saving required with downsizing of a housing can be achieved.

The power storage system of one embodiment of the present invention can be provided in a headset-type device 9001. The headset-type device 9001 includes at least a microphone part 9001a, a flexible pipe 9001b, and an earphone portion 9001c. The power storage system can be provided in the flexible pipe 9001b or the earphone portion 9001c. By including the power storage system of one embodiment of the present invention, space saving required with downsizing of a housing can be achieved.

The power storage device of one embodiment of the present invention can be provided in a device 9002 that can be attached directly to a body. A power storage device 9002b can be provided in a thin housing 9002a of the device 9002. With the use of the power storage system of one embodiment of the present invention, space saving required with downsizing of a housing can be achieved.

The power storage system of one embodiment of the present invention can be provided in a device 9003 that can be attached to clothes. A power storage device 9003b can be provided in a thin housing 9003a of the device 9003. By including the power storage system of one embodiment of the present invention, space saving required with downsizing of a housing can be achieved.

The power storage device of one embodiment of the present invention can be provided in a belt-type device 9006. The belt-type device 9006 includes a belt portion 9006a and a wireless power feeding and receiving portion 9006b, and the power storage system can be provided in the inner region of the belt portion 9006a. By including the power storage system of one embodiment of the present invention, space saving required with downsizing of a housing can be achieved.

The power storage system of one embodiment of the present invention can be provided in a watch-type device 9005. The watch-type device 9005 includes a display portion 9005a and a belt portion 9005b, and the power storage system can be provided in the display portion 9005a or the belt portion 9005b. By including the power storage system of one embodiment of the present invention, space saving required with downsizing of a housing can be achieved.

The display portion 9005a can display various kinds of information such as time and reception information of an e-mail or an incoming call.

The watch-type device 9005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 32B is a perspective view of the watch-type device 9005 that is detached from an arm.

FIG. 32C is a side view. FIG. 32C illustrates a state where the power storage system 9011 of one embodiment of the present invention is incorporated in the watch-type device 9005. The power storage system 9011, which is small and lightweight, is provided at a position overlapping with the display portion 9005a.

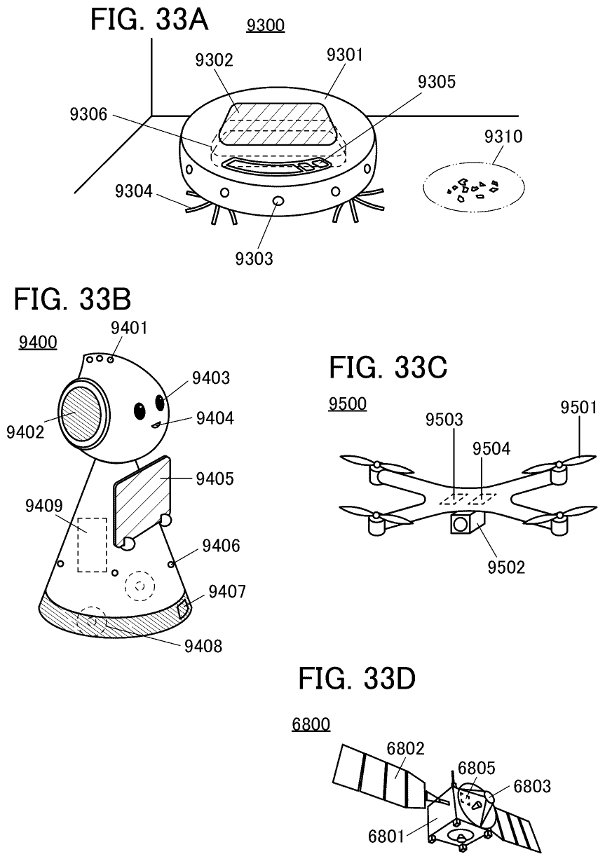

FIG. 33A illustrates an example of a cleaning robot. A cleaning robot 9300 includes a display portion 9302 placed on a top surface of a housing 9301, a plurality of cameras 9303 placed on a side surface of the housing 9301, a brush 9304, operation buttons 9305, a power storage system 9306, a variety of sensors, and the like. Although not illustrated, the cleaning robot 9300 is provided with a tire, an inlet, and the like. The cleaning robot 9300 is self-propelled, detects dust 9310, and sucks up the dust through the inlet provided on the bottom surface.

For example, the cleaning robot 9300 can determine whether there is an obstacle such as a wall, furniture, or a step by analyzing images taken by the cameras 9303. In the case where the cleaning robot 9300 detects an object that is likely to be caught in the brush 9304 (e.g., a wire) by image analysis, the rotation of the brush 9304 can be stopped. The cleaning robot 9300 further includes, in its inner region, the power storage system 9306 of one embodiment of the present invention and a semiconductor device or an electronic component. The cleaning robot 9300 including the power storage system 9306 of one embodiment of the present invention can be a highly reliable electronic device that can operate for a long time.

FIG. 33B illustrates an example of a robot. A robot 9400 illustrated in FIG. 33B includes a power storage system 9409, an illuminance sensor 9401, a microphone 9402, an upper camera 9403, a speaker 9404, a display portion 9405, a lower camera 9406, an obstacle sensor 9407, a moving mechanism 9408, an arithmetic device, and the like.

The microphone 9402 has a function of detecting a speaking voice of a user, an environmental sound, and the like. The speaker 9404 has a function of outputting sound. The robot 9400 can communicate with a user using the microphone 9402 and the speaker 9404.

The display portion 9405 has a function of displaying various kinds of information. The robot 9400 can display information desired by the user on the display portion 9405. The display portion 9405 may be provided with a touch panel. Moreover, the display portion 9405 may be a detachable information terminal, in which case charge and data communication can be performed when the display portion 9405 is set at the home position of the robot 9400.

The upper camera 9403 and the lower camera 9406 each have a function of taking an image of the surroundings of the robot 9400. The obstacle sensor 9407 can detect an obstacle in the direction where the robot 9400 advances with the moving mechanism 9408. The robot 9400 can move safely by recognizing the surroundings with the upper camera 9403, the lower camera 9406, and the obstacle sensor 9407.

The robot 9400 further includes, in its inner region, the power storage system 9409 of one embodiment of the present invention and a semiconductor device or an electronic component. The robot 9400 including the power storage system of one embodiment of the present invention can be a highly reliable electronic device that can operate for a long time.

FIG. 33C illustrates an example of a flying object. A flying object 9500 illustrated in FIG. 33C includes propellers 9501, a camera 9502, a power storage system 9503, and the like and has a function of flying autonomously.

For example, image data taken by the camera 9502 is stored in an electronic component 9504. The electronic component 9504 can analyze the image data to detect whether there is an obstacle in the way of the movement. Moreover, the electronic component 9504 can estimate the remaining battery level from a change in the power storage capacity of the power storage system 9503. The flying object 9500 further includes the power storage system 9503 of one embodiment of the present invention. The flying object 9500 including the power storage system of one embodiment of the present invention can be a highly reliable electronic device that can operate for a long time.

FIG. 33D illustrates an example of the artificial satellite 6800. The artificial satellite 6800 includes a body 6801, a solar panel 6802, an antenna 6803, and a secondary battery 6805.

When the solar panel 6802 is irradiated with sunlight, electric power required for operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for operation of the artificial satellite 6800 might not be generated. In order to drive the artificial satellite 6800 even with a small amount of generated electric power, the artificial satellite 6800 is preferably provided with the secondary battery 6805.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

This embodiment can be implemented in appropriate combination with any of the other embodiments.

### Example 1

In this example, a secondary battery was fabricated and its characteristics were evaluated.

### <Formation of Positive Electrode Active Material>

A positive electrode active material was formed.

A commercial lithium cobalt oxide (Cellseed C-TON produced by Nippon Chemical Industrial Co., Ltd.) was prepared as lithium cobalt oxide. Next, the prepared lithium cobalt oxide was heated at 850° C. in an oxygen atmosphere for two hours.

Lithium fluoride and magnesium fluoride were weighed at the molar ratio of 1:3 and mixed to obtain a magnesium source. The magnesium source was weighed so that magnesium in the magnesium source can be 1 at % of cobalt in the lithium cobalt oxide, and was mixed with the heated lithium cobalt oxide to give a mixture A1.

Then, the mixture A1 was heated at 900° C. in an oxygen atmosphere for 20 hours to give a composite oxide B1.

Next, nickel hydroxide was prepared as a nickel source, and aluminum hydroxide was prepared as an aluminum source. The nickel source and the aluminum source were weighed so that nickel in the nickel hydroxide and aluminum in the aluminum hydroxide can each be 0.5 at % of cobalt in the composite oxide B1, and were mixed with the composite oxide B1 to give a mixture C1.

Then, the mixture C1 was heated at 850° C. in an oxygen atmosphere for 10 hours, and Sample Sa1 was fabricated.

### <Fabrication of Positive Electrode>

Sample Sa1, acetylene black (AB), polyvinylidene fluoride (PVDF), and NMP (N-methyl-2-pyrrolidone) were mixed to form a slurry. The ratio of Sample Sa1, AB, and PVDF was 95:3:2 (weight ratio).

The obtained slurry was applied to one surface of an aluminum foil. After that, heat treatment was performed at 80° C., so that the NMP was volatilized. Pressing was performed after the heat treatment, so that a positive electrode was obtained.

### <Fabrication of Negative Electrode>

Graphite, VGCF (registered trademark), carboxymethyl cellulose sodium salt (CMC-Na), styrene butadiene rubber (SBR), and water were mixed to form a slurry. The ratio of graphite, VGCF, CMC-Na, and SBR was 96:1:1:2 (weight ratio).

The obtained slurry was applied to one surface of a copper foil. After that, heating was performed at 50° C., so that a negative electrode was obtained.

### <Fabrication of Secondary Battery>

A secondary battery was fabricated using the positive electrode and the negative electrode formed through the above steps. As a solvent of an electrolyte solution, a mixture of ethylene carbonate (EC) and diethyl carbonate (DEC) at EC:DEC=3:7 (volume ratio) was used. As a lithium salt, lithium hexafluorophosphate (LiPF₆) was used. The concentration of the lithium salt in the electrolyte solution was 1.00 mol/L. For the separator, polypropylene was used. As a film to be the exterior body, a film in which a polypropylene layer, an acid modified polypropylene layer, an aluminum layer, and a nylon layer were stacked in this order was used. First, one negative electrode having a negative electrode active material layer on one surface and one positive electrode having a positive electrode active material layer on one surface were prepared, and the negative electrode active material layer and the positive electrode active material layer were placed so as to face each other with a separator interposed therebetween.

Through the above steps, a secondary battery was fabricated.

<dQ/dV−V Curve>

A charge-discharge cycle test of the fabricated secondary battery was performed. The ambient temperature in the measurement was set to 45° C., the charge conditions were a constant current charge at 0.5 C and the upper limit voltage of 4.55 V. The discharge conditions were a constant current discharge at 0.5 C and the lower limit voltage of 3.0 V.

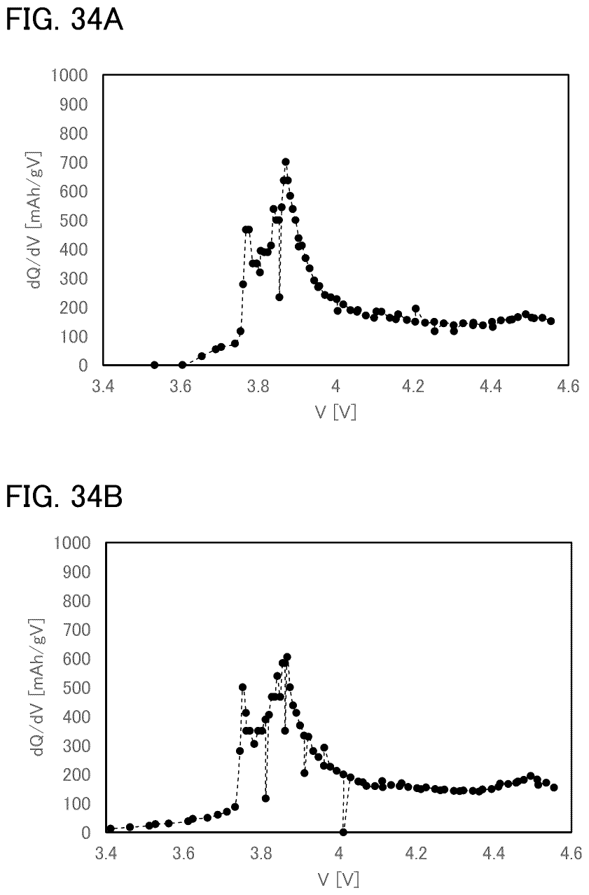

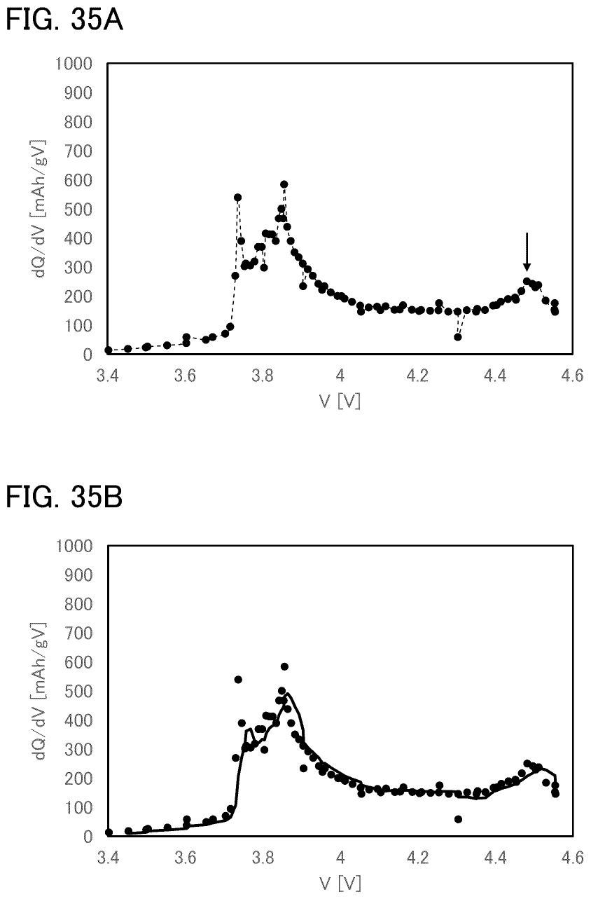

FIG. 34A shows a dQ/dV−V curve in the 1st cycle, FIG. 34B shows a dQ/dV−V curve in the 3rd cycle, and FIG. 35A shows a dQ/dV−V curve in the 40th cycle. In addition, FIG. 35B shows a curve of five-point moving average of data in FIG. 35A. Note that data acquisition interval was approximately two minutes in charging.

In the charging unit of one embodiment of the present invention, the point indicated by the arrow in FIG. 35A can be determined to the local maximum.

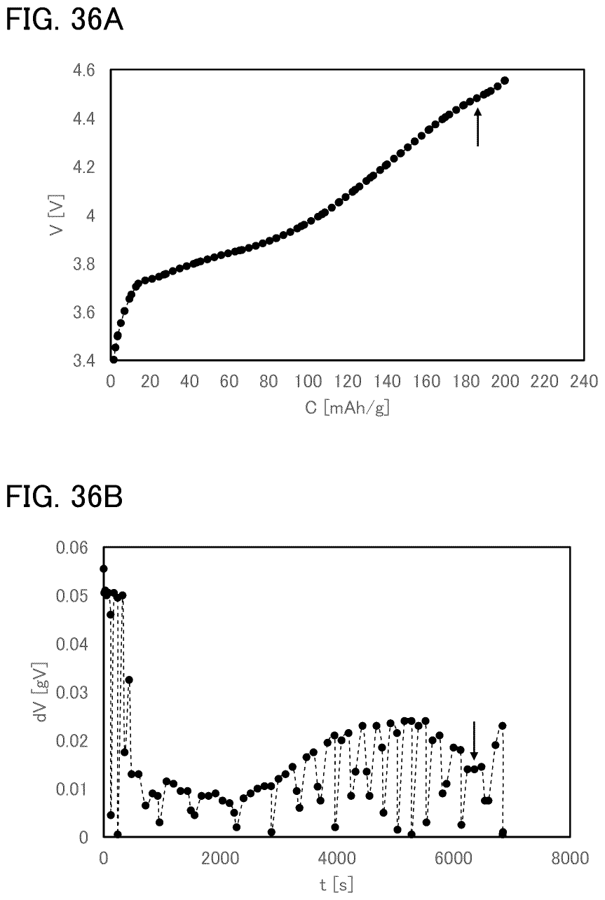

FIG. 36A shows a voltage V-capacitance C curve in charge of the 40th cycle and FIG. 36B shows a voltage change over time (ΔV−t curve) in the charge of the 40th cycle. The vertical axis represents ΔV and the horizontal axis represents a time from the start of charge. The ΔV was a difference from the previous voltage. The point corresponding to the point indicated by the arrow in FIG. 35A is indicated by arrows in FIG. 36A and FIG. 36B.

### Example 2

In this example, a secondary battery was fabricated and its characteristics were evaluated.

### <Fabrication of Secondary Battery>

A secondary battery was fabricated using the positive electrode and the negative electrode fabricated in Example 1. Note that in the negative electrode, a slurry was applied to not one surface but both surfaces of the current collector. As a solvent of an electrolyte solution, EMI-FSA (1-ethyl-3-methylimidazolium bis(fluorosulfonyl)amide) was used. As a lithium salt, LiFSA (lithium bis(fluorosulfonyl)amide) was used, and the concentration of the lithium salt in the electrolyte solution was 2.15 mol/L. As a separator, 50-μm-thick solvent-spun regenerated cellulosic fiber (TF40, produced by NIPPON KODOSHI CORPORATION) was used. As a film to be the exterior body, a film in which a polypropylene layer, an acid modified polypropylene layer, an aluminum layer, and a nylon layer are stacked in this order was used. First, one negative electrode having negative electrode active material layers on both surfaces and two positive electrodes each having a positive electrode active material layer on one surface were prepared, and the negative electrode and the positive electrode were placed so that each of the negative electrode active material layers that were formed on both surfaces of the negative electrode could face the positive electrode active material layer with a separator interposed therebetween.

Through the above steps, a secondary battery was fabricated.

<dQ/dV Characteristics>

A charge-discharge cycle test of the fabricated secondary battery was performed. The ambient temperature in the measurement was set to 45° C., the charge conditions were a constant current charge at 0.5 C and the upper limit voltage of 4.55 V. The discharge conditions were a constant current discharge at 0.5 C and the lower limit voltage of 3.0 V.

Next, dQ/dV characteristics were evaluated. In an area of the constant current charge, verification was performed. The dQ/dV can be calculated from (dQ/dt)×(dt/dV). In the constant current charge, dQ/dt is constant; thus, the dQ/dV is proportional to dt/dV. Therefore, for a simple evaluation, evaluation using the dt/dV characteristics was performed.

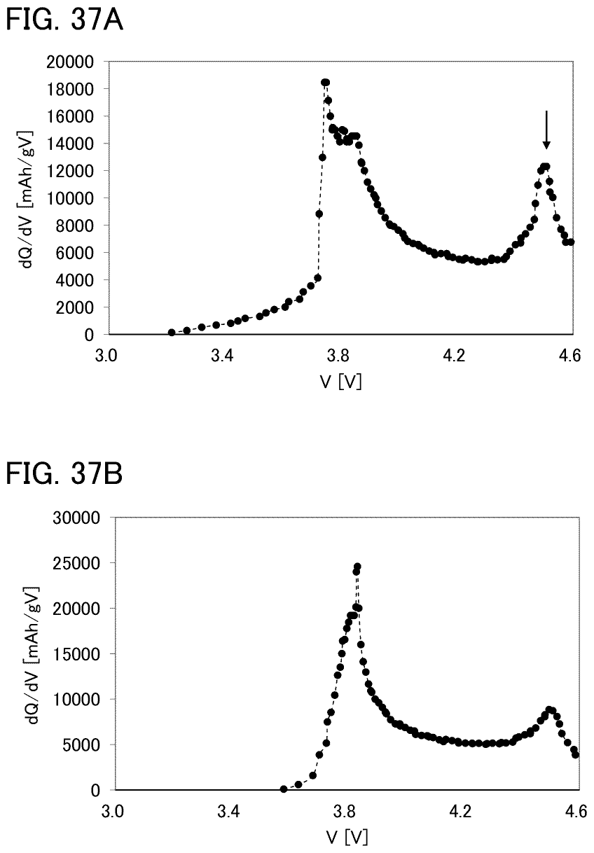

FIG. 37A shows a dt/dV−V curve in the 1st cycle. FIG. 37B shows a dt/dV−V curve in the 10th cycle. In FIG. 37A and FIG. 37B, data is plotted every time the voltage changes by a predetermined value, or every time the time changes by a predetermined value in the case where a change of the voltage is not observed.

In the charging unit of one embodiment of the present invention, the point indicated by the arrow in FIG. 37A can be determined to be the local maximum.

### Example 3

In this example, a secondary battery was fabricated and its characteristics were evaluated.

### <Formation of Positive Electrode Active Material>

A positive electrode active material was formed.

Lithium cobalt oxide was heated at 850° C. in an oxygen atmosphere for two hours.

Lithium fluoride and magnesium fluoride were weighed at the molar ratio of 1:3 and mixed to obtain a magnesium source. The magnesium source was weighed so that magnesium in the magnesium source can be 1 at % of cobalt in the lithium cobalt oxide, and was mixed with the heated lithium cobalt oxide to give a mixture A2.

Then, the mixture A2 was heated at 900° C. in an oxygen atmosphere for 20 hours to give a composite oxide B2.

Nickel hydroxide was prepared as a nickel source, and aluminum hydroxide was prepared as an aluminum source. The nickel source and the aluminum source were weighed so that nickel in the nickel hydroxide and aluminum in the aluminum hydroxide can each be 0.5 at % of cobalt in the composite oxide B2, and were mixed with the composite oxide B2 to give a mixture C2.

Then, the mixture C2 was heated at 850° C. in an oxygen atmosphere for 10 hours, and Sample Sa2 was fabricated.

### <Fabrication of Positive Electrode>

Sample Sa2, acetylene black (AB), polyvinylidene fluoride (PVDF), and NMP were mixed to form a slurry. The ratio of Sample Sa2, AB, and PVDF was 95:3:2 (weight ratio).

The obtained slurry was applied to one surface of an aluminum foil. After that, heat treatment was performed at 80° C., so that the NMP was volatilized. Pressing was performed at a pressure of 210 kN/m after the heat treatment, so that a positive electrode was obtained.

### <Fabrication of Secondary Battery>

A CR2032 coin-type battery cell (diameter: 20 mm, height: 3.2 mm) was fabricated with the use of the positive electrode formed above.

A lithium metal was used for a counter electrode.

As a solvent of the electrolyte solution, a mixture of ethylene carbonate (EC) and diethyl carbonate (DEC) at EC:DEC=3:7 (volume ratio) to which vinylene carbonate (VC) was added at 2 wt % was used. As a lithium salt, lithium hexafluorophosphate (LiPF₆) was used. The concentration of the lithium salt in the electrolyte solution was 1.00 mol/L.

As a separator, a polypropylene porous film was used.

A positive electrode can and a negative electrode can that were formed of stainless steel (SUS) were used.

### <Cycle Characteristics>

Next, the cycle characteristics of the fabricated secondary battery were measured. Charge was performed under three different conditions, and the secondary battery was prepared for each condition. The discharge conditions were the same. The measurement was performed at 45° C. Note that 200 mA/g was regarded as 1C rate in charge and discharge. The current values of charge and discharge were normalized by the weight of the positive electrode active material.

Note that a charge depth was calculated below on the assumption that the charge capacity corresponding to a capacity in the case of extraction of all lithium of lithium cobalt oxide is 100%. The charge capacity corresponding to a capacity in the case of extraction of all lithium of lithium cobalt oxide was calculated to be 274 mAh/g.

As first charge conditions, constant current charge was performed at a rate of 0.5 C up to the upper voltage limit of 4.7 V and then constant voltage charging was performed at 4.7 V until the rate became 0.05 C.

As second charge conditions, constant current charge was performed at a rate of 0.5 C up to the upper limit voltage 4.7 V, and then the charge was stopped.

As third charge conditions, charge was performed at a rate of 0.5 C up to 75% of the charge depth. That is, the charge was performed to a charge capacity of 205.5 mAh/g. A 10-minute break was taken after the charge.

In discharging, constant current discharge was performed at a rate of 0.5 C down to the lower voltage limit of 2.5 V. A 10-minute break was taken after the discharge.

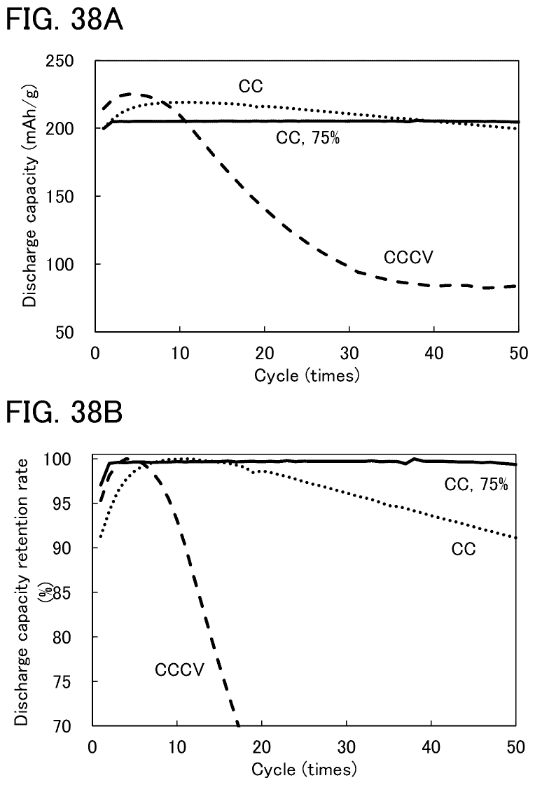

FIG. 38A and FIG. 38B show cycle performances of the secondary batteries. In FIG. 38A and FIG. 38B, the first, second, and third charge conditions are denoted as “CCCV” “CC”, and “CC,75%”, respectively. In FIG. 38A, the horizontal axis represents the number of charge-discharge cycles and the vertical axis represents discharge capacity. In FIG. 38B, the horizontal axis represents the number of charge-discharge cycles and the vertical axis represents the discharge capacity retention rate.

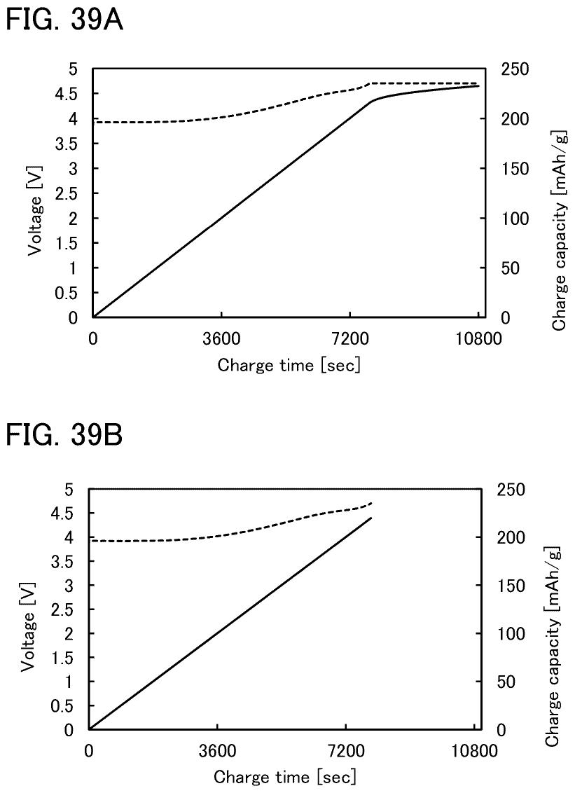

FIG. 39A shows the relations between the charge time and the voltage and between the charge time and the charge capacity under the first charge conditions. Note that the curve in FIG. 39A shows a result of charge in the fourth cycle. The charge depth when the constant current charge ended was 78.8%. That is, the charge was performed to a charge capacity of 215.9 mAh/g. The charge depth when the constant voltage charge ended was 82.1%.

FIG. 39B shows the relations between the charge time and the voltage and between the charge time and the charge capacity under the second charge conditions. Note that the curve in FIG. 39B shows a result of charge in the 11th cycle. The charge depth when the constant current charge ended was 80.2%.

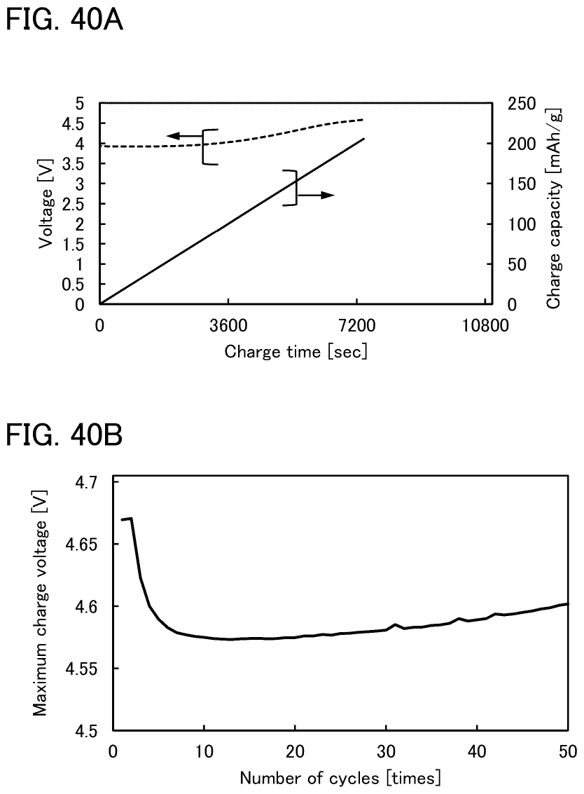

FIG. 40A shows the relations between the charge time and the voltage and between the charge time and the charge capacity under the third charge conditions. Note that the curve in FIG. 40A shows a result of charge in the 38th cycle. The charge depth when the charge ended was 75.0%.

FIG. 40B shows the relation between the number of cycles and the maximum charge voltage under the third charge conditions.

In the case where the constant voltage charge was performed, the discharge capacity decreased remarkably depending on the number of cycles.

### <SEM Observation>

Next, the secondary battery subjected to the charge-discharge cycle test was disassembled, and a cross-sectional SEM observation of the positive electrode was performed.

A cross-section of the positive electrode active material layer was exposed by ion milling processing and was observed with SEM. For the SEM observation, SU8030 manufactured by Hitachi High-Tech Corporation was used and an accelerating voltage was 1 kV.

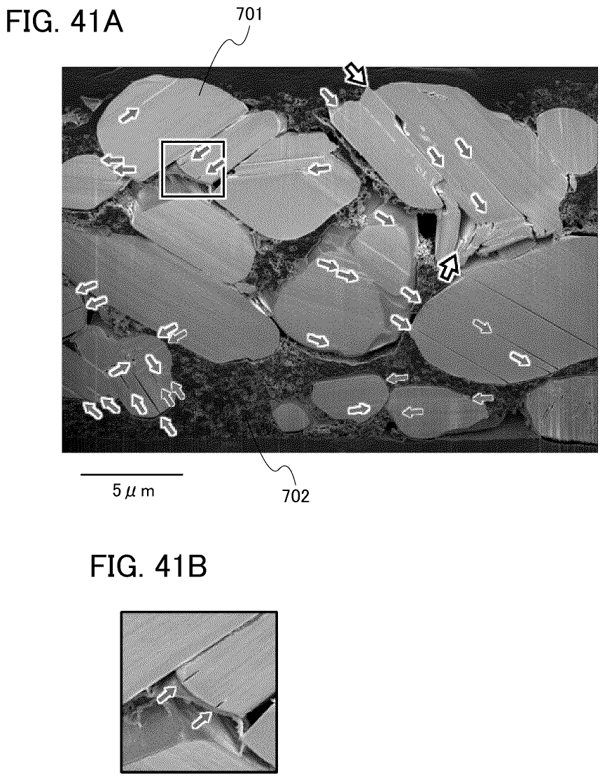

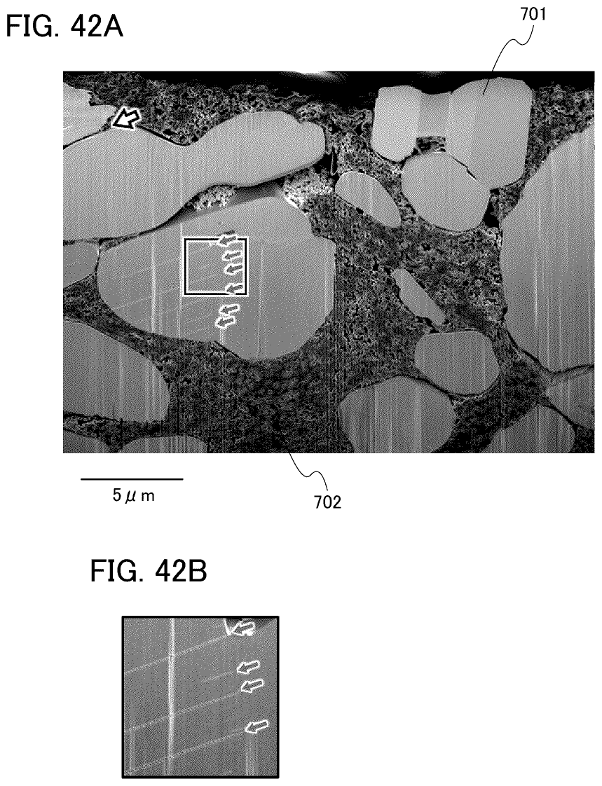

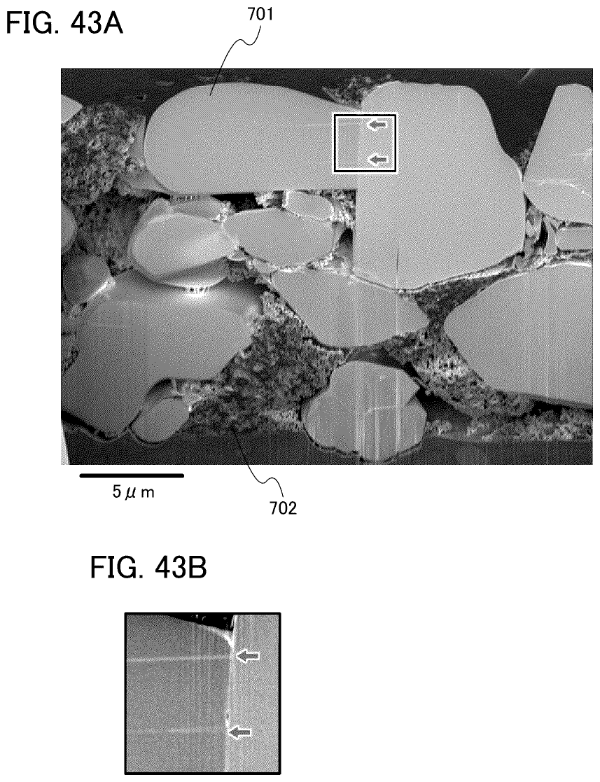

The SEM observation results are shown in FIG. 41A, FIG. 42A, and FIG. 43A. In each of the drawings, a positive electrode active material 701 and a conductive agent 702 were observed. In each of the drawings, arrows each show a portion indicating a pit in the positive electrode active material 701 and outline arrows each show a portion indicating a crack in the positive electrode active material 701.

FIG. 41A shows an observation result of the positive electrode after 50 charge-discharge cycles under the first charge conditions as the charging conditions. FIG. 41B is an enlarged view of a region indicated by a square in FIG. 41A.

FIG. 42A shows an observation result of the positive electrode after 50 charge-discharge cycles under the second charge conditions as the charging conditions. FIG. 42B is an enlarged view of a region indicated by a square in FIG. 42A.

FIG. 43A shows an observation result of the positive electrode after 50 charge-discharge cycles under the third charge conditions as the charging conditions. FIG. 43B is an enlarged view of a region indicated by a square in FIG. 43A.

In the condition where the constant voltage charge was performed, many pits were observed.

### <STEM Observation>

Next, a cross-section of the positive electrode of the secondary battery disassembled after the charge-discharge cycle test was observed with STEM. The cross-section was exposed by FIB processing. The STEM observation was performed at an acceleration voltage of 200 kV using HD-2700, manufactured by Hitachi High-Technologies Corporation.

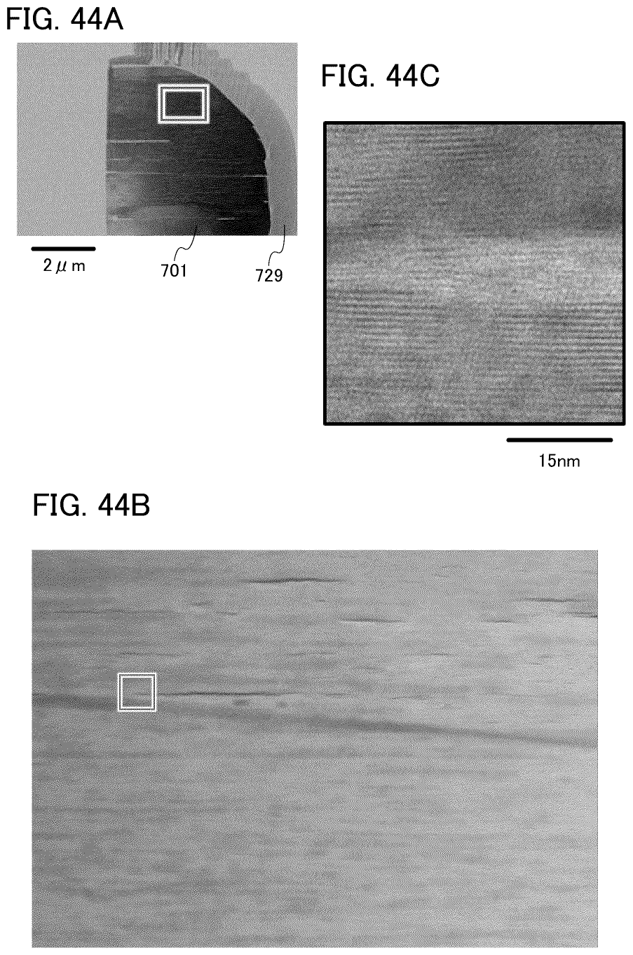

FIG. 44A shows a TE (transmission electron) image of cross-section STEM observation of the positive electrode after 50 charge-discharge cycles under the first charge conditions as the charging conditions. In FIG. 44A, the positive electrode active material 701 and a protective layer 729 which was formed for observation were observed. FIG. 44B is an enlarged image of a region indicated by a square in FIG. 44A. Note that the image in FIG. 44B is a ZC (Z contrast) image.

FIG. 44C is an enlarged image of a region indicated by a square in FIG. 44B. Note that the image in FIG. 44C is a TE image. Lattice fringes were observed in FIG. 44C. It is indicated that a region in which lattice fringes can be observed has crystallinity. Furthermore, a crack along the lattice fringe was also observed and the lattice fringes were unclear around the crack in some regions. In the regions where the lattice fringes were unclear, the crystallinity might be low.

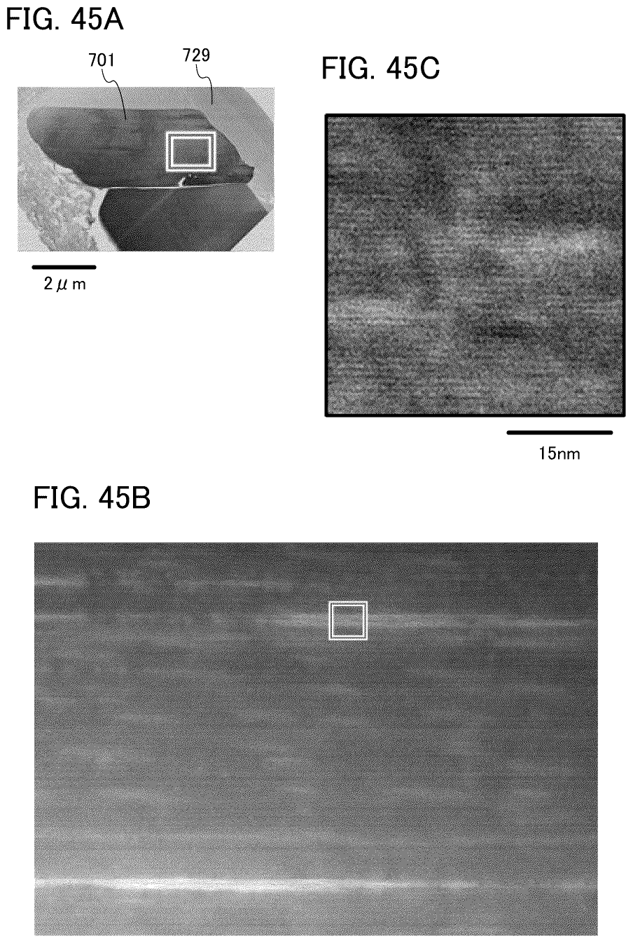

FIG. 45A shows a TE (transmission electron) image of cross-section STEM observation of the positive electrode after 50 charge-discharge cycles under the second charge conditions as the charging conditions. In FIG. 45A, the positive electrode active material 701 and a protective layer 729 which was formed for observation were observed. FIG. 45B shows a ZC image of the square region in FIG. 45A and FIG. 45C shows a TE image of the square region in FIG. 45B. The lattice fringes were observed in FIG. 45C. It is indicated that a region in which lattice fringes can be observed has crystallinity. Furthermore, a crack along the lattice fringe was also observed and the lattice fringes were unclear around the crack in some regions. In the regions where the lattice fringes were unclear, the crystallinity might be low.

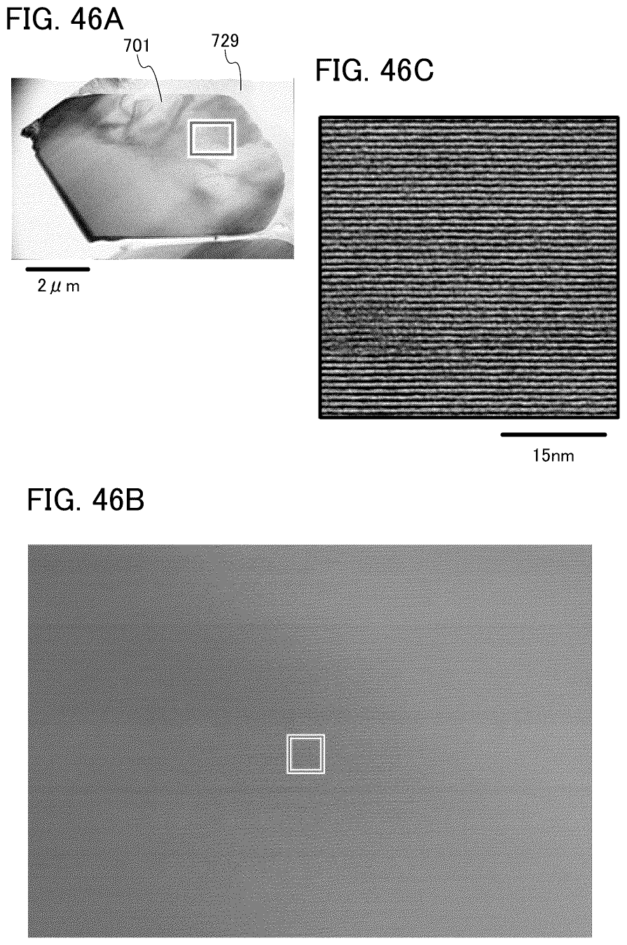

FIG. 46A shows a TE (transmission electron) image of cross-section STEM observation of the positive electrode after 50 charge-discharge cycles under the third charge conditions as the charging conditions. In FIG. 46A, the positive electrode active material 701 and a protective layer 729 which was formed for observation were observed. FIG. 46B shows a ZC image of the square region in FIG. 46A and FIG. 46C shows a TE image of the square region in FIG. 46B. The lattice fringes were observed in FIG. 46C. It is indicated that a region in which lattice fringes can be observed has crystallinity. In FIG. 46C, a crack was not observed clearly. This indicates that the charge and discharge under the third charge conditions can inhibit a reduction in crystallinity of the positive electrode active material.

### <EDX Analysis>

Next, STEM-EDX area analysis (element mapping) of the positive electrode of the secondary battery disassembled after the charge-discharge cycle test was considered. The thickness of the thinned sample was approximately 100 nm. The STEM-EDX was performed at an acceleration voltage of 200 kV using HD-2700, manufactured by Hitachi High-Technologies Corporation).

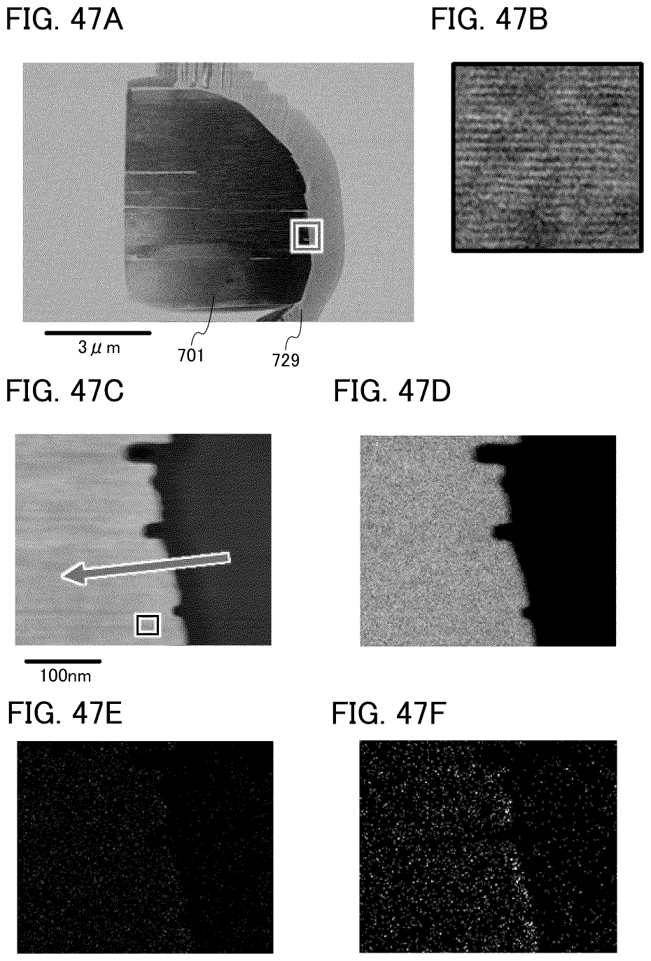

FIG. 47A shows a TE (transmission electron) image of cross-section STEM observation of the positive electrode after 50 charge-discharge cycles under the first charge conditions as the charging conditions. FIG. 47C shows a ZC image of the square region in FIG. 47A and FIG. 47B shows a TE image of the square region in FIG. 47C.

FIG. 47D, FIG. 47E, and FIG. 47F show results of EDX area analysis corresponding to the ZC image illustrated in FIG. 47C. FIG. 47D, FIG. 47E, and FIG. 47F show area analysis results of cobalt, magnesium, and aluminum, respectively.

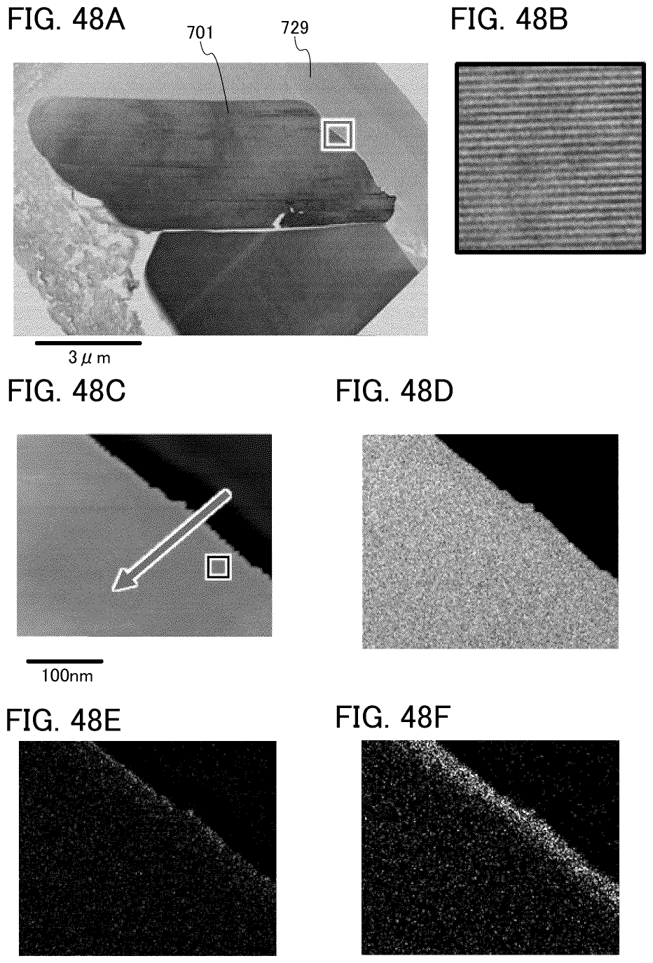

FIG. 48A shows a TE (transmission electron) image of cross-section STEM observation of the positive electrode after 50 charge-discharge cycles under the second charge conditions as the charging conditions. FIG. 48C shows a ZC image of the square region in FIG. 48A and FIG. 48B shows a TE image of the square region in FIG. 48C.

FIG. 48D, FIG. 48E, and FIG. 48F show results of EDX area analysis corresponding to the ZC image illustrated in FIG. 48C. FIG. 48D, FIG. 48E, and FIG. 48F show area analysis results of cobalt, magnesium, and aluminum, respectively.

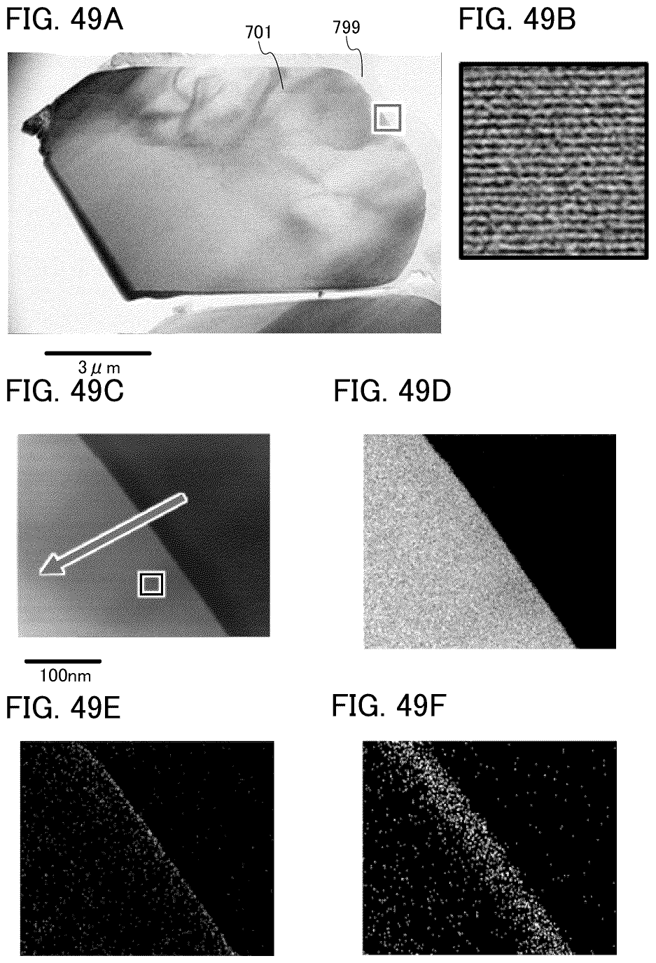

FIG. 49A shows a TE (transmission electron) image of cross-section STEM observation of the positive electrode after 50 charge-discharge cycles under the second charge conditions as the charging conditions. FIG. 49C shows a ZC image of the square region in FIG. 49A and FIG. 49B shows a TE image of the square region in FIG. 49C.

FIG. 49D, FIG. 49E, and FIG. 49F show results of EDX area analysis corresponding to the ZC image illustrated in FIG. 49C. FIG. 49D, FIG. 49E, and FIG. 49F show area analysis results of cobalt, magnesium, and aluminum, respectively.

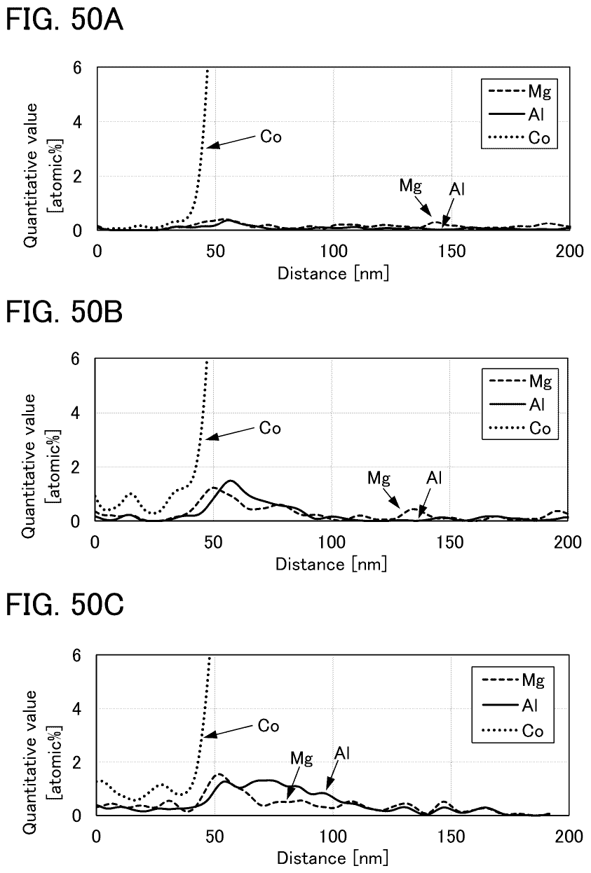

FIG. 50A shows an EDX line analysis result in the portion indicated by the arrow in FIG. 47C, FIG. 50B shows an EDX line analysis result in the portion indicated by the arrow in FIG. 48C, and FIG. 50C shows an EDX line analysis result in the portion indicated by the arrow in FIG. 49C. Note that the line analysis results in FIG. 50B and FIG. 50C are data of linear regions extracted from the EDX area analysis.

From the results of the EDX area analysis and the EDX line analysis, in the secondary battery subjected to charge-discharge cycles under the second charge conditions or the third charge conditions, magnesium and aluminum were observed in the surface portion of the positive electrode active material. In contrast, it is suggested that in the secondary battery subjected to charge-discharge cycles under the first charge conditions, magnesium and aluminum were little or detectable amounts of magnesium and aluminum were not observed in the surface portion of the positive electrode active material.

When constant voltage charge is performed, magnesium and aluminum in the surface portion of the positive electrode active material particle are probably dissolved into the electrolyte solution from the positive electrode active material. The dissolution is likely to result from a longer charge time at high voltage and a deeper charge depth. In addition, the dissolution is likely to make it difficult to inhibit the collapse of the crystal structure due to charge-discharge cycles, which may decrease the discharge capacity. The occurrence of pits in the positive electrode active material is likely to be caused by dissolution of magnesium and aluminum into the electrolyte solution.

### Example 4

In this example, the secondary battery was charged using the charging unit of one embodiment of the present invention, and the characteristics of the secondary battery were evaluated.

### <Formation of Positive Electrode Active Material>

A positive electrode active material was formed.

Lithium cobalt oxide was heated at 850° C. in an oxygen atmosphere for two hours.

Lithium fluoride and magnesium fluoride were weighed at the molar ratio of 1:3 and mixed to obtain a magnesium source. The magnesium source was weighed so that magnesium in the magnesium source can be 1 at % of cobalt in the lithium cobalt oxide, and was mixed with the heated lithium cobalt oxide to give a mixture A3.

Then, the mixture A3 was heated at 900° C. in an oxygen atmosphere for 20 hours to give a composite oxide B3.

Next, nickel hydroxide was prepared as a nickel source, and aluminum hydroxide was prepared as an aluminum source. The nickel source and the aluminum source were weighed so that nickel in the nickel hydroxide and aluminum in the aluminum hydroxide can be 0.5 at % of cobalt in the composite oxide A, and were mixed with the composite oxide B3 to give a mixture C3.

Then, the mixture C3 was heated at 850° C. in an oxygen atmosphere for 10 hours, and Sample Sa3 was fabricated.

### <Fabrication of Positive Electrode>

Sample Sa3, acetylene black (AB), polyvinylidene fluoride (PVDF), and NMP were mixed to form a slurry. The ratio of Sample Sa3, AB, and PVDF was 95:3:2 (weight ratio).

The obtained slurry was applied to one surface of an aluminum foil. After that, heat treatment was performed at 80° C., so that the solvent was volatilized. Pressing was performed after the heat treatment, so that a positive electrode was obtained.

### <Fabrication of Negative Electrode>

Graphite, VGCF (registered trademark), carboxymethyl cellulose sodium salt (CMC-Na), styrene butadiene rubber (SBR), and water were mixed to form a slurry. The ratio of graphite, VGCF, CMC-Na, and SBR was 96:1:1:2 (weight ratio).

The obtained slurry was applied to one surface of a copper foil. After that, heating was performed at 50° C., so that a negative electrode was obtained.

### <Fabrication of Secondary Battery>

A secondary battery was fabricated using the positive electrode and the negative electrode formed through the above steps. As a solvent of an electrolyte solution, a mixture of ethylene carbonate (EC) and diethyl carbonate (DEC) at EC:DEC=3:7 (volume ratio) was used. As a lithium salt, lithium hexafluorophosphate (LiPF₆) was used. The concentration of the lithium salt in the electrolyte solution was 1.00 mol/L. For the separator, polypropylene was used. As a film to be the exterior body, a film in which a polypropylene layer, an acid modified polypropylene layer, an aluminum layer, and a nylon layer are stacked in this order was used. First, one negative electrode having a negative electrode active material layer on one surface and one positive electrode having a positive electrode active material layer on one surface were prepared, and the negative electrode active material layer and the positive electrode active material layer are placed so as to face each other with a separator interposed therebetween.

The area of the positive electrode active material layer was 20.493 cm², and the weight of the positive electrode active material layer was 0.11995 g. The area of the negative electrode active material layer was 23.841 cm², and the positive electrode and the negative electrode were placed such that an area in which the positive electrode active material layer and the negative electrode active material layer did not overlap with each other was as little as possible. The loading amount of the positive electrode active material layer was approximately 10.6 mg/cm², and the thickness thereof was greater than or equal to 54 μm and less than or equal to 56 μm. The loading amount of the negative electrode active material layer is greater than or equal to 7.8 mg/cm² and less than or equal to 7.9 mg/cm², and the thickness thereof was greater than or equal to 83 μm and less than or equal to 85 μm.

Through the above steps, the secondary battery was fabricated. Note that four secondary batteries were fabricated through the above steps.

### <Charging Method of Secondary Battery>

Charge of the secondary battery was performed with the charging unit of one embodiment of the present invention in accordance with a flowchart in FIG. 51.

First, a process started in Step S000.

Next, in Step S001, constant current charge of the secondary battery was started. The current value of charge was 20 mA.

Next, in Step S002, a voltage of the secondary battery was measured by a voltage measurement circuit. The voltage value was measured with an interval of 100 [ms]. The measured voltage was converted into 16-bit digital values by an analog-digital conversion circuit and was supplied to a control circuit. An MCU (Micro Controller unit) was used as the control circuit.

Next, in Step S003, the control circuit compared the voltage measured by the voltage measurement circuit with a predetermined voltage (here, 4.4 V).

On the basis of the result of comparison in Step S003, when the measured voltage was lower than 4.4 V, the process returned to Step S002, or when the measured voltage was higher than or equal to 4.4 V, the process proceeded to the next step (Step S004).

A dt/dV value was obtained in Step S004. Here, the time required for a voltage change by 1 mV was calculated as the value corresponding to the dt/dV. The moving average of measured dt/dV and a value obtained by multiplying the maximum of dt/dV, which was measured from the start of charge in Step S001 until the current time, by a constant (here, 0.8) were calculated. The moving average was calculated from the total three points of a measurement point for the calculation, the previous measurement point, and the measurement point before the previous measurement point.

In Step S005, the moving average of dt/dV and the value obtained by multiplication of the maximum value of dt/dV and 0.8 were compared.

When the moving average of dt/dV was greater than or equal to 0.8 times the maximum value of dt/dV, Step S004 to Step S005 were repeated.

At a time when the moving average of dt/dV was smaller than 0.8 times the maximum value, the process proceeded to Step S006 and charge was stopped.

Next, the charge was stopped in Step S099.

The charge conditions described above are referred to as charge conditions Ch-1.

### <Cycle Performance>

Under the above-described charge conditions (charge conditions Ch-1) and constant current charge conditions with the upper limit voltage of 4.6 V (hereinafter referred to as charge conditions Ch-2), cycle performances were evaluated. In each of the charge conditions, the charge current was 20 mA. The discharge conditions were constant current discharge, the lower limit voltage of discharge was 3.0 V, and the discharge current was 20 mA. The number, n, of the secondary batteries evaluated under the charge conditions Ch-1 was 2 (two secondary batteries were evaluated under each of the charge conditions), which are shown by Ch-1(1) and Ch-1(2) in the graph. Furthermore, the number, n, of the secondary battery evaluated under the charge condition Ch-1 was 1.

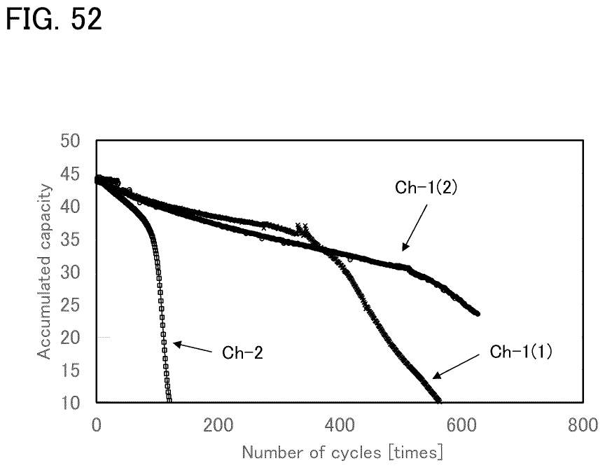

FIG. 52 shows the results of the cycle performance. The horizontal axis represents the number of charge-discharge cycles, and the vertical axis represents discharge capacity. From the results in FIG. 52, in the secondary batteries charged under the charge condition Ch-1 by using the charging unit of one embodiment of the present invention, a decrease in discharge capacity due to the cycle is reduced and the cycle performance is improved remarkably. In addition, in the secondary batteries charged under the charge condition Ch-1, the discharge capacity is decreased in 300 or more cycles and the decrease is gentle.

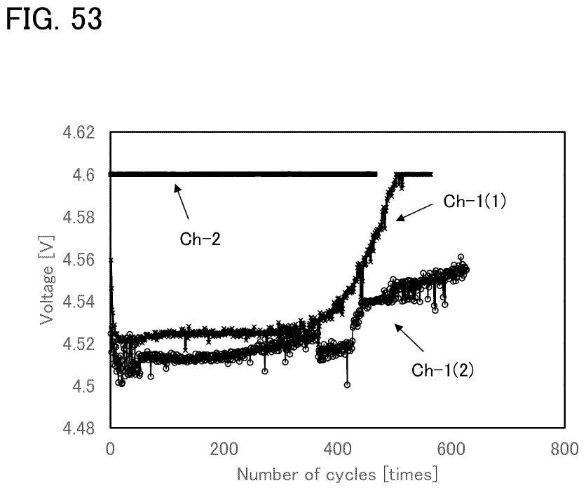

FIG. 53 shows a relation between the end voltage of charge and the charge-discharge cycle of the secondary battery. The horizontal axis represents the number of charge-discharge cycles and the vertical axis represents the end voltage of charge. The results in FIG. 53 suggest that the end voltage of charge of the secondary batteries charged under the charge conditions Ch-1 can be low, leading to the improvement of the cycle performance.

In addition, FIG. 53 shows a tendency that the end voltage of charge is high at the initial cycles and is gradually decreased in the secondary battery charged under the charge conditions Ch-1. When the end voltage of charge is changed, the internal resistance of the secondary battery is likely to be unstable. In the case where charge is performed using the charging unit of one embodiment of the present invention, the charge can be performed sufficiently in such an unstable state. In addition, since the charge can be performed without increasing the end voltage of charge than necessary, the secondary battery can have both a high capacity and a long lifetime.

In charging using the charging unit of one embodiment of the present invention, even when a variation occurs in internal resistance between a plurality of secondary batteries due to the fabricating process or the like of the secondary batteries, the reliability of the secondary batteries is not damaged and can have sufficient capacity.

In consideration of the results in FIG. 52 and FIG. 53 in combination, in the case of the charge conditions Ch-1, a correlation between the discharge capacity and the end voltage of charge is seen after the number of cycles, e.g., after 350 or more cycles, where the decrease of the discharge capacity due to the increased number of cycles is noticeable. This shows a possibility that the full discharge capacity of the secondary battery (the dischargeable capacity of the secondary battery) can be estimated with the end voltage of charge.

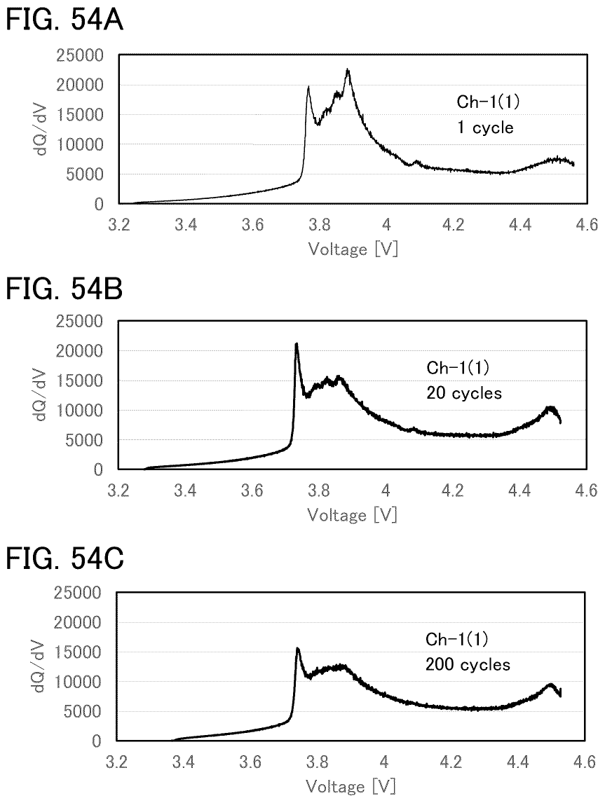

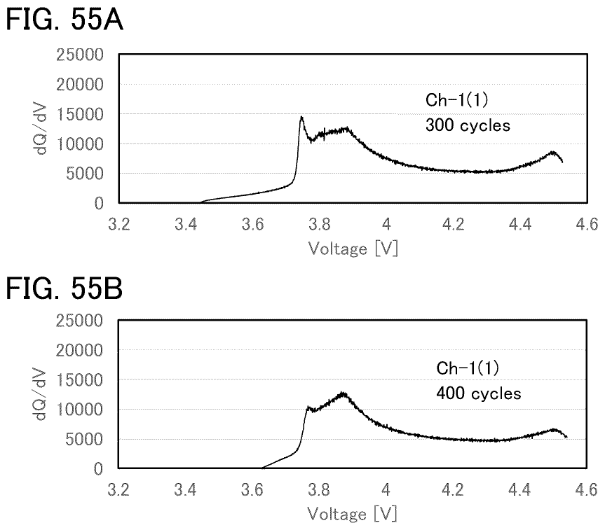

FIG. 54A to FIG. 55B show dQ/dV−V curves of the secondary battery charged under the first charge conditions. FIG. 54A shows data of the 1st cycle, FIG. 54B shows data of the 20th cycle, FIG. 54C shows data of the 200th cycle, FIG. 55A shows data of the 300th cycle, and FIG. 55B shows data of the 400th cycle. After 20 or more cycles, the height (level) of the local maximum value in the vicinity of 4.5 V is decreased as the cycle number is increased. In addition, the voltage of the local maximum value in the vicinity of 4.5 V is increased (becomes high).

The height of the local maximum value in the dQ/dV−V curve may decrease because a phase change corresponding to the local maximum value is unlikely to occur in the positive electrode active material. Detecting the height of the local maximum value can estimate the SOH of the secondary battery.

### REFERENCE NUMERALS

51: positive electrode active material, 52: depression portion, 53: region, 54: pit, 55: crystal plane, 56: region, 57: crack, 58: pit, 100: power storage system, 101: charging unit, 121: secondary battery, 122: resistor, 123: resistor, 124: terminal, 125: terminal, 130: stack, 131: stack, 140: transistor, 150: transistor, 151: voltage measurement circuit, 152: current measurement circuit, 152a: resistor, 152b: circuit, 153: control circuit, 157: DC-DC converter, 158: circuit, 159: diode, 185: detection circuit, 186: detection circuit, 200: positive electrode active material, 200a: surface portion, 200b: inner portion, 201: crystal grain boundary, 202: filling portion, 203: projection portion, 204: coating film, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte, 509: exterior body, 510: positive electrode lead electrode, 511: negative electrode lead electrode, 516: inlet, 550: stack, 560: secondary battery, 701: positive electrode active material, 702: conductive agent, 703: distribution board, 704: commercial power source, 705: power storage controller, 706: indicator, 707: general load, 708: power storage load, 709: router, 710: service wire mounting portion, 711: measuring portion, 712: predicting portion, 713: planning portion, 729: protective layer, 790: control device, 791: power storage system, 796: underfloor space, 799: building, 901: compound, 902: mixture, 903: positive electrode active material, 911a: terminal, 911b: terminal, 913: secondary battery, 930: housing, 930a: housing, 930b: housing, 931a: negative electrode active material layer, 931: negative electrode, 932a: positive electrode active material layer, 932: positive electrode, 933: separator, 950a: wound body, 950: wound body, 951: terminal, 952: terminal, 970: secondary battery, 971: housing, 972: stack, 973a: positive electrode lead electrode, 973b: terminal, 973c: conductor, 974a: negative electrode lead electrode, 974b: terminal, 974c: conductor, 975a: positive electrode, 975b: positive electrode, 976: separator, 977a: negative electrode, 1301a: first battery, 1301b: first battery, 1302: battery controller, 1303: motor controller, 1304: motor, 1305: gear, 1306: DC-DC circuit, 1307: electric power steering, 1308: heater, 1309: defogger, 1310: DC-DC circuit, 1311: second battery, 1312: inverter, 1313: audio, 1314: power window, 1315: lamps, 1316: tire, 1317: rear motor, 2001: automobile, 2002: transporter, 2003: transportation vehicle, 2004: aircraft, 2005: transportation vehicle, 2100: electric bicycle, 2101: secondary battery, 2102: power storage system, 2103: display portion, 2104: charging unit, 2201: power storage system, 2202: power storage system, 2203: power storage system, 2204: power storage system, 2300: motor scooter, 2301: side mirror, 2302: power storage system, 2303: indicator light, 2304: storage unit under seat, 2603: vehicle, 2604: charging device, 2610: solar panel, 2611: wiring, 2612: power storage system, 2800: personal computer, 2801: housing, 2802: housing, 2803: display portion, 2804: keyboard, 2805: pointing device, 2806: power storage system, 2807: power storage system, 6800: artificial satellite, 6801: body, 6802: solar panel, 6803: antenna, 6805: secondary battery, 7100: portable display device, 7101: housing, 7102: display portion, 7103: operation button, 7104: secondary battery, 7105: charging unit, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7408: charging unit, 7500: electronic cigarette, 7501: atomizer, 7502: cartridge, 7504: power storage system, 7600: tablet terminal, 7625: switch, 7626: switch, 7627: switch, 7628: operation switch, 7629: fastener, 7630: housing, 7630a: housing, 7630b: housing, 7631: display portion, 7631a: display portion, 7631b: display portion, 7633: solar cell, 7634: power storage system, 7635: secondary battery, 7636: DC-DC converter, 7637: converter, 7638: charging unit, 7640: movable portion, 8000: display device, 8001: housing, 8002: display portion, 8003: speaker portion, 8004: power storage system, 8100: lighting device, 8101: housing, 8102: light source, 8103: power storage system, 8104: ceiling, 8105: wall, 8106: floor, 8107: window, 8200: indoor unit, 8201: housing, 8202: air outlet, 8203: power storage system, 8204: outdoor unit, 8300: electric refrigerator-freezer, 8301: housing, 8302: door for refrigerator, 8303: door for freezer, 8304: power storage system, 9000: glasses-type device, 9000a: frame, 9000b: display portion, 9001: headset-type device, 9001a: microphone part, 9001b: flexible pipe, 9001c: earphone portion, 9002: device, 9002a: housing, 9002b: power storage system, 9003: device, 9003a: housing, 9003b: power storage system, 9005: watch-type device, 9005a: display portion, 9005b: belt portion, 9006: belt-type device, 9006a: belt portion, 9006b: wireless power feeding and receiving portion, 9011: power storage system, 9300: cleaning robot, 9301: housing, 9302: display portion, 9303: camera, 9304: brush, 9305: operation button, 9306: power storage system, 9310: dust, 9400: robot, 9401: illuminance sensor, 9402: microphone, 9403: upper camera, 9404: speaker, 9405: display portion, 9406: lower camera, 9407: obstacle sensor, 9408: moving mechanism, 9409: power storage system, 9500: flying object, 9501: propeller, 9502: camera, 9503: power storage system, 9504: electronic component,

1-2. (canceled)

3. A charging method of a secondary battery, using a charging unit comprising a control circuit and a voltage measurement circuit,
wherein the control circuit is configured to control start and stop of charge of the secondary battery and to control a charge current of the secondary battery,
wherein the control circuit is configured to calculate a voltage change over time of the secondary battery and to detect a local maximum of the voltage change over time,
wherein the voltage measurement circuit is configured to measure a charge voltage of the secondary battery,
wherein the control circuit starts charge of the secondary battery at a time t3,
wherein the voltage measurement circuit measures a voltage V(t) of the secondary battery at a time t and a voltage V(t−Δt1) of the secondary battery at a time (t−Δt1) obtained by subtracting a time Δt1 from the time t,
wherein the control circuit analyzes a second curve in which a horizontal axis is the time t and a vertical axis is the voltage change over time [voltage V(t)−voltage V(t−Δt1)] of the secondary battery to detect a time tq at which the second curve has a first local minimum,
wherein the control circuit stops the charge at a time t4 at which a predetermined time is elapsed from the time tq,
wherein a constant current charge is performed on the secondary battery from the time t3 until the time t4, and
wherein a voltage V(tq) of the secondary battery at the time tq is higher than or equal to 4.25 V.

4. The charging method of a secondary battery according to claim 3,
wherein the control circuit comprises an analog-digital conversion circuit,
wherein the analog-digital conversion circuit is configured to convert an analog value of the measured charge voltage to a digital value, and
wherein a resolution of the analog-digital conversion circuit is less than or equal to 12 bits.

5. The charging method of a secondary battery according to claim 3,
wherein the secondary battery comprises a positive electrode,
wherein the positive electrode comprises a positive electrode active material particle,
wherein the positive electrode active material particle comprises lithium and cobalt, and
wherein a crystal structure of the positive electrode active material particle determined by powder X-ray diffraction at the time tq is a crystal structure represented by a space group R-3m.

6. The charging method of a secondary battery according to claim 3,
wherein the charging unit comprises a memory circuit,
wherein data corresponding to an ambient temperature is stored in the memory circuit, and
wherein the time tq is detected with use of the data.

7. The charging method of a secondary battery according to claim 3,
wherein the charging unit comprises a memory circuit,
wherein data corresponding to the positive electrode active material particle of the secondary battery is stored in the memory circuit, and
wherein the time tq is detected with use of the data.

8. A charging method of a secondary battery, using a charging unit comprising a control circuit, a voltage measurement circuit, and a current measurement circuit,
wherein the control circuit is configured to control start and stop of charge of the secondary battery and to control a charge current of the secondary battery,
wherein the control circuit is configured to calculate a derivative of quantity of electricity with respect to voltage of the secondary battery and to detect a local maximum of the derivative of quantity of electricity with respect to voltage,
wherein the voltage measurement circuit is configured to measure a charge voltage of the secondary battery,
wherein the current measurement circuit is configured to measure a charge current of the secondary battery,
wherein charge of the secondary battery is started at a time t1,
wherein a quantity of electricity Q(t) is calculated with use of a current I(t) at a time t,
wherein a first curve in which a horizontal axis is a voltage V(t) and a vertical axis is the derivative of a quantity of electricity Q(t) with respect to voltage [dQ(t)/dV(t)] is analyzed to detect a time tp at which the first curve has a first local maximum,
wherein the charge is stopped at a time t2 at which a predetermined time is elapsed from the time tp, and
wherein a voltage V(tp) at the time tp is higher than or equal to 4.25 V.

9. The charging method of a secondary battery according to claim 8,
wherein the charge is constant current charge.

10. The charging method of a secondary battery according to claim 8,
wherein the secondary battery comprises a positive electrode,
wherein the positive electrode comprises a positive electrode active material particle,
wherein the positive electrode active material particle comprises lithium and cobalt, and
wherein a crystal structure of the positive electrode active material particle determined by powder X-ray diffraction at the time tp is a crystal structure represented by a space group R-3m.

11. The charging method of a secondary battery according to claim 8,
wherein the charging unit comprises a memory circuit,
wherein data corresponding to an ambient temperature is stored in the memory circuit, and
wherein the time tp is detected with use of the data.

12. The charging method of a secondary battery according to claim 8,
wherein the charging unit comprises a memory circuit,
wherein data corresponding to the positive electrode active material particle of the secondary battery is stored in the memory circuit, and
wherein the time tp is detected with use of the data.

13. The charging method of a secondary battery according to claim 3, further comprising a current measurement circuit,
wherein the current measurement circuit is configured to measure a charge current of the secondary battery.

14-16. (canceled)

17. A charging method of a secondary battery using a charging unit,
wherein the secondary battery comprises a positive electrode,
wherein the positive electrode comprises a positive electrode active material particle,
wherein the positive electrode active material particle comprises lithium and cobalt,
wherein the charging unit is configured to control start and stop of charge of the secondary battery and to control a charge current of the secondary battery,
wherein the charging method of a secondary battery comprises:
a first step of starting constant current charge of the secondary battery at a time t1; and
a second step of stopping the charge at a time t2, and
wherein a crystal structure of the positive elective material particle determined by powder X-ray diffraction time t2 is a crystal structure represented by a space group R-3m.

18. The charging method of a secondary battery according to claim 17,
wherein when the positive electrode is analyzed by powder X-ray diffraction using CuKα1 radiation at the time t2, the positive electrode has a diffraction peak at 20 being greater than or equal to 19.25° and less than or equal to 19.45° and a diffraction peak at 20 being greater than or equal to 45.35° and less than or equal to 45.75°.

19. The charging method of a secondary battery according to claim 17,
wherein the positive electrode active material particle comprises lithium cobalt oxide.

20. The charging method of a secondary battery according to claim 17,
wherein the positive electrode active material particle comprises a metal oxide represented by LiMO₂ (M is a metal), and
wherein the metal M comprises two or more metals including cobalt.

21. A charging method of a secondary battery, using a charging unit comprising a control circuit and a voltage measurement circuit,
wherein the control circuit is configured to control start and stop of charge of the secondary battery and to control a charge current of the secondary battery,
wherein the control circuit is configured to calculate a voltage change over time of the secondary battery and hd to detect a local maximum of the voltage change over time,
wherein the voltage measurement circuit is configured to measure a charge voltage of the secondary battery, and
wherein the charging method of a secondary battery comprises:
a first step of starting constant current charge of the secondary battery by the control circuit;
a second step of measuring a voltage V of the secondary battery by the voltage measurement circuit;
a third step in which a process proceeds to a fourth step when a voltage V is compared with a predetermined voltage V1 by the control circuit and the voltage V is higher than or equal to the voltage V1, and the process returns to the second step when the voltage V is lower than the voltage V1;
the fourth step in which the control circuit accumulates a set of data containing dt/dV and a time t, and calculates a moving average of the dt/dV, [dt/dV]mean and a maximum value of the accumulated dt/dV, [dt/dV]max;
a fifth step in which the control circuit compares the [dt/dV]mean with a value obtained by multiplying the [dt/dV]max by a constant Rt, and when the [dt/dV]mean is lower than the value obtained by multiplying the [dt/dV]max by the constant Rt, the process proceeds to a sixth step, and when the [dt/dV]mean is higher than or equal to the value obtained by multiplying the [dt/dV]max by the constant Rt, the process returns to the fourth step; and
the sixth step in which the control circuit stops the constant current charge of the secondary battery.

22. The charging method of a secondary battery according to claim 21,
wherein the voltage V1 is higher than or equal to 4.25 V, and
wherein the constant Rt is greater than or equal to 0.6 and less than or equal to 0.9.

23. The charging method of a secondary battery according to claim 17,
wherein the positive electrode active material particle is lithium cobalt oxide to which magnesium is added.
